(19) United States
(12) Patent Application Publication
(10) Pub. No.: US 2025/0390738 A1
(43) Pub. Date: Dec. 25, 2025

(54) GENERATING ENCODED VIDEO DATA AND DECODED VIDEO DATA

(71) Applicant: Telefonaktiebolaget LM Ericsson (publ), Stockholm (SE)

(72) Inventors: Per WENNERSTEN, Årsta (SE); Jacob STRÖM, Stockholm (SE); Du LIU, Solna (SE); Yun LI, Lund (SE); Mitra DAMGHANIAN, Upplands-Bro (SE)

(73) Assignee: Telefonaktiebolaget LM Ericsson (publ), Stockholm (SE)

(21) Appl. No.: 18/880,432

(22) PCT Filed: Jul. 5, 2023
(86) PCT No.: PCT/EP2023/068593

§ 371 Date: Dec. 31, 2024

Related U.S. Application Data
(60) Provisional application No. 63/358,252, filed on Jul. 5, 2022.
(60) Provisional application No. 63/371,084, filed on Aug. 11, 2022.

(51) Int. Cl. G06N 3/08; G06N 3/049; G06T 9/00

(52) U.S. Cl. CPC G06N 3/08; G06N 3/049; G06T 9/002

(57) ABSTRACT

There is provided a method of training a machine learning, ML, model used for generating encoded video data or decoded video data. The method comprises obtaining original video data. The method further comprises converting the original video data into ML input video data. The method further comprises providing the ML input video data into the ML model, thereby generating first ML output video data, and training the ML model based on a difference between the original video data and the ML input video data and a difference between the original video data and the first ML output video data.

### TECHNICAL FIELD

This disclosure relates to generating encoded video data and/or decoded video data.

### BACKGROUND

Video is the dominant form of data traffic in today's networks and is projected to continuously increase its share. One way to reduce the data traffic from video is compression. In the compression, the source video is encoded into a bitstream, which then can be stored and transmitted to end users. Using a decoder, the end user can extract the video data and display it on a screen.

However, since the encoder does not know what kind of device the encoded bitstream is going to be sent to, the encoder must compress the video into a standardized format. Then all devices that support the chosen standard can successfully decode the video.

Compression can be lossless, i.e., the decoded video will be identical to the source video that was given to the encoder, or lossy, where a certain degradation of content is accepted. Whether the compression is lossless or lossy has a significant impact on the bitrate, i.e., how high the compression ratio is, as factors such as noise can make lossless compression quite expensive.

A video sequence contains a sequence of pictures. A color space commonly used in video sequences is YCbCr, where Y is the luma (brightness) component, and Cb and Cr are the chroma components. Sometimes the Cb and Cr components are called U and V. Other color spaces are also used, such as ICtCp (a.k.a., IPT) (where I is the luma component, and Ct and Cp are the chroma components), constant-luminance YCbCr (where Y is the luma components, and Cb and Cr are the chroma components), RGB (where R, G, and B correspond to blue, green, and blue components respectively), YCoCg (where Y is the luma components, and Co and Cg are the chroma components), etc.

The order that the pictures are placed in the video sequence is called “display order.” Each picture is assigned with a Picture Order Count (POC) value to indicate its display order. In this disclosure, the terms “images,” “pictures” or “frames” are used interchangeably.

Video compression is used to compress video sequences into a sequence of coded pictures. In many existing video codecs, the picture is divided into blocks of different sizes. A block is a two-dimensional array of samples. The blocks serve as the basis for coding. A video decoder then decodes the coded pictures into pictures containing sample values. A picture can also be divided into one or more slices. The most common case is when there is only one slice in the picture.

Video standards are usually developed by international organizations as these represent different companies and research institutes with different areas of expertise and interests. The currently most applied video compression standard is H.264/AVC (Advanced Video Coding) which was jointly developed by ITU-T and ISO. The first version of H.264/AVC was finalized in 2003, with several updates in the following years. The successor of H.264/AVC, which was also developed by ITU-T (International Telecommunication Union-Telecommunication) and International Organization for Standardization (ISO), is known as H.265/HEVC (High Efficiency Video Coding) and was finalized in 2013. MPEG and ITU-T have created a successor to HEVC within the Joint Video Exploratory Team (JVET). The name of this video codec is Versatile Video Coding (VVC) and version 1 of the VVC specification has been published as Rec. ITU-T H.266| ISO/IEC (International Electrotechnical Commission) 23090-3, “Versatile Video Coding”, 2020.

The VVC video coding standard is a block-based video codec and utilizes both temporal and spatial prediction. Spatial prediction is achieved using intra (I) prediction from within the current picture. Temporal prediction is achieved using uni-directional (P) or bi-directional inter (B) prediction at the block level from previously decoded reference pictures. In the encoder, the difference between the original sample data and the predicted sample data, referred to as the residual, is transformed into the frequency domain, quantized, and then entropy coded before being transmitted together with necessary prediction parameters such as prediction mode and motion vectors (which may also be entropy coded). The decoder performs entropy decoding, inverse quantization, and inverse transformation to obtain the residual, and then adds the residual to the intra or inter prediction to reconstruct a picture.

The VVC video coding standard uses a block structure referred to as quadtree plus binary tree plus ternary tree block structure (QTBT+TT), where each picture is first partitioned into square blocks called coding tree units (CTU). All CTUs are of the same size and the partitioning of the picture into CTUs is done without any syntax controlling it.

Each CTU is further partitioned into coding units (CUs) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape. The depth of the quad tree and binary tree can be set by the encoder in the bitstream. The ternary tree (TT) part adds the possibility to divide a CU into three partitions instead of two equally sized partitions. This increases the possibilities to use a block structure that better fits the content structure of a picture, such as roughly following important edges in the picture.

A block that is intra coded is an I-block. A block that is uni-directional predicted is a P-block and a block that is bi-directional predicted a B-block. For some blocks, the encoder decides that encoding the residual is not necessary, perhaps because the prediction is sufficiently close to the original. The encoder then signals to the decoder that the transform coding of that block should be bypassed, i.e., skipped. Such a block is referred to as a skip-block.

At the 20th JVET meeting, it was decided to setup an exploration experiment (EE) on neural network-based (NN-based) video coding. The exploration experiment continued at the 21^{st} and 22^{nd} JVET meetings with two EE tests: NN-based filtering and NN-based super resolution. In the 23^{rd} JVET meeting, the test was decided to be continued in three categories: enhancement filters, super-resolution methods, and intra prediction. In the category of enhancement filters, two configurations were considered: (i) the proposed filter used as in-loop filter and (ii) the proposed filter used as a post-processing filter.

In-loop filtering in VVC includes deblocking filtering, sample adaptive offsets (SAO) operation, and adaptive loop filter (ALF) operation. The deblocking filter is used to remove block artifacts by smoothening discontinuities in horizontal and vertical directions across block boundaries. The deblocking filter uses a block boundary strength (BS) parameter to determine the filtering strength. The BS parameter can have values of 0, 1, and 2, where a larger value indicates a stronger filtering. The output of deblocking filter is further processed by SAO operation, and the output of the SAO operation is then processed by ALF operation. The output of the ALF can then be put into the display picture buffer (DPB), which is used for prediction of subsequently encoded (or decoded) pictures. Since the deblocking filter, the SAO filter, and the ALF influence the pictures in the DPB used for prediction, they are classified as in-loop filters, also known as loopfilters. It is possible for a decoder to further filter the image, but not send the filtered output to the DPB, but only to the display. In contrast to loopfilters, such a filter is not influencing future predictions and is therefore classified as a post-processing filter, also known as a postfilter.

The contributions JVET-X0066 described in EE1-1.6: Combined Test of EE1-1.2 and EE1-1.4, Y. Li, K. Zhang, L. Zhang, H. Wang, J. Chen, K. Reuze, A. M. Kotra, M. Karczewicz, JVET-X0066, October 2021 and JVET-Y0143 described in EE1-1.2: Test on Deep In-Loop Filter with Adaptive Parameter Selection and Residual Scaling, Y. Li, K. Zhang, L. Zhang, H. Wang, K. Reuze, A. M. Kotra, M. Karczewicz, JVET-Y0143, January 2022 are two successive contributions that describe NN-based in-loop filtering.

Both contributions use the same NN models for filtering. The NN-based in-loop filter is placed before SAO and ALF and the deblocking filter is turned off. The purpose of using the NN-based filter is to improve the quality of the reconstructed samples. The NN model may be non-linear. While all of deblocking filter, SAO, and ALF contain non-linear elements such as conditions, and thus are not strictly linear, all three of them are based on linear filters. A sufficiently big NN model in contrast can in principle learn any non-linear mapping and is therefore capable of representing a wider class of functions compared to deblocking, SAO and ALF.

In JVET-X0066 and JVET-Y0143, there are four NN models, i.e., four NN-based in-loop filters-one for luma intra samples, one for chroma intra samples, one for luma inter samples, and one for chroma inter samples. The use of NN filtering can be controlled on a block (CTU) level or a picture level. The encoder can determine whether to use NN filtering for each block or each picture.

This NN-based in-loop filter increases the compression efficiency of the codec substantially, i.e., it lowers the bit rate substantially without lowering the objective quality as measured by MSE (mean-square error)-based PSNR (peak signal-to-noise ratio). Increases in compression efficiency, or simply “gain”, is often measured as the Bjontegaard-delta rate (BDR) against an anchor. An example, a BDR of −1% means that the same PSNR can be reached with 1% fewer bits. As reported in JVET-Y0143, for the random access (RA) configuration, the BDR gain for the luma component (Y) is −9.80%, and for the all-intra (AI) configuration, the BDR gain for the luma component is −7.39%. The complexity of NN models used for compression is often measured by the number of Multiply-Accumulate (MAC) operations per pixel. The high gain of NN model is directly related to the high complexity of the NN model. The luma intra model described in JVET-Y0143 has a complexity of 430 kMAC/sample, i.e., 430000 multiply-accumulate operations per sample.

5 Together with the multiply-accumulate operations needed for the chroma model (110 kMAC), the overall complexity becomes 540 kMAC/pixel. There are also other measures of complexity, such as total model size in terms of stored parameters.

### SUMMARY

However, the structure of the NN model described in JVET-Y0143 is not optimal. For example, the high complexity of the NN model can be a major challenge for practical hardware implementations. Therefore, reducing the complexity of the NN model while preserving or improving the performance of the NN model is therefore highly desirable.

Accordingly, in one aspect of the embodiments of this disclosure, there is provided a method for generating an encoded video or a decoded video. The method comprises obtaining values of reconstructed samples; obtaining input information comprising any one or a combination of: i) information about filtered samples, ii) information about predicted samples, or iii) information about skipped samples; providing the values of reconstructed samples and the input information to a machine learning, ML, model, thereby generating at least one ML output data; and based at least on said at least one ML output data, generating the encoded video or the decoded video.

In another aspect, there is provided a method for generating an encoded video or a decoded video. The method comprises obtaining machine learning, ML, input data, wherein the ML input data comprises: i) values of reconstructed samples; ii) values of predicted samples; iii) block boundary strength, BBS, information indicating strength of a filtering applied to a boundary of samples; and iv) quantization parameters, QP. The method further comprises providing the ML input data to a ML model, thereby generating ML output data; and based at least on the ML output data, generating the encoded video or the decoded video. The ML input data does not include partition information indicating how a luma picture is partitioned into coding tree units, CTUs, and how luma CTUs are partitioned into coding units, CUs.

In a different aspect, there is provided a method for generating an encoded video or a decoded video. The method comprises obtaining machine learning, ML, input data, wherein the ML input data comprises: i) values of reconstructed samples; ii) values of predicted samples; iii) quantization parameters, QP. The method further comprises providing the ML input data to a ML model, thereby generating ML output data; and based at least on the ML output data, generating the encoded video or the decoded video. The ML input data does not include block boundary strength, BBS, information indicating strength of a filtering applied to a boundary of samples.

In a different aspect, there is provided a method for generating an encoded video or a decoded video. The method comprises obtaining values of reconstructed samples; obtaining quantization parameters, QPs; providing the reconstructed sample values and the quantization parameters to a machine learning, ML, model, thereby generating ML output data; based at least on the ML output data, generating first output sample values; and providing the first output sample values to a group of two or more attention residual blocks connected in series. The group of attention residual blocks comprises a first attention residual block disposed at one end of the series of attention residual blocks, and the first attention residual block is configured to receive first input data consisting of the first output sample values, and generate second output sample values based on the first output sample values.

In a different aspect, there is provided a method for generating an encoded video or a decoded video. The method comprises obtaining machine learning, ML, input data. The ML input data comprises: i) values of luma components of reconstructed samples; ii) values of chroma components of reconstructed samples; iii) values of luma components of predicted samples; iv) values of chroma components of predicted samples; v) first block boundary strength, BBS, information indicating strength of a filtering applied to a boundary of luma components of samples; vi) second BBS information indicating strength of a filtering applied to a boundary of chroma components of samples; and iv) quantization parameters, QP. The method further comprises providing the ML input data to a ML model, thereby generating ML output data; and based at least on the ML output data, generating the encoded video or the decoded video.

In a different aspect, there is provided a method for generating an encoded video or a decoded video. The method comprises obtaining values of reconstructed samples; obtaining quantization parameters, QPs; providing the reconstructed sample values and the quantization parameters to a machine learning, ML, model, thereby generating ML output data; based at least on the ML output data, generating first output sample values; providing the first output sample values to a group of two or more attention residual blocks connected in series, thereby generating second output sample values; and generating the encoded video or the decoded video based on the second output sample values. The group of attention residual blocks comprises a first attention residual block disposed at one end of the series of attention residual blocks, and the first attention residual block is configured to receive input data consisting of the first output sample values and the QPs.

In a different aspect, there is provided a computer program comprising instructions (1244) which when executed by processing circuitry cause the processing circuitry to perform the method of any one of the embodiments described above.

In a different aspect, there is provided an apparatus for generating an encoded video or a decoded video. The apparatus is configured to obtain values of reconstructed samples; obtaining input information comprising any one or a combination of: i) information about filtered samples, ii) information about predicted samples, or iii) information about skipped samples; provide the values of reconstructed samples and the input information to a machine learning, ML, model, thereby generating at least one ML output data; and based at least on said at least one ML output data, generate the encoded video or the decoded video.

In a different aspect, there is provided an apparatus for generating an encoded video or a decoded video. The apparatus is configured to obtain machine learning, ML, input data, wherein the ML input data comprises: i) values of reconstructed samples; ii) values of predicted samples; iii) block boundary strength, BBS, information indicating strength of a filtering applied to a boundary of samples; and iv) quantization parameters, QP. The apparatus is configured to provide the ML input data to a ML model, thereby generating ML output data; and based at least on the ML output data, generate the encoded video or the decoded video. The ML input data does not include partition information indicating how a luma picture is partitioned into coding tree units, CTUs, and how luma CTUs are partitioned into coding units, CUs.

In a different aspect, there is provided an apparatus for generating an encoded video or a decoded video. The apparatus is configured to obtain machine learning, ML, input data, wherein the ML input data comprises: i) values of reconstructed samples; ii) values of predicted samples; iii) quantization parameters, QP. The apparatus is configured to provide the ML input data to a ML model, thereby generating ML output data; and based at least on the ML output data, generate the encoded video or the decoded video. The ML input data does not include block boundary strength, BBS, information indicating strength of a filtering applied to a boundary of samples.

In a different aspect, there is provided an apparatus for generating an encoded video or a decoded video. The apparatus is configured to obtain values of reconstructed samples; obtain quantization parameters, QPs; provide the reconstructed sample values and the quantization parameters to a machine learning, ML, model, thereby generating ML output data; based at least on the ML output data, generate first output sample values; and providing the first output sample values to a group of two or more attention residual blocks connected in series. The group of attention residual blocks comprises a first attention residual block disposed at one end of the series of attention residual blocks, and the first attention residual block is configured to receive first input data consisting of the first output sample values, and generate second output sample values based on the first output sample values.

In a different aspect, there is provided an apparatus for generating an encoded video or a decoded video. The apparatus is configured to obtain machine learning, ML, input data. The ML input data comprises: i) values of luma components of reconstructed samples; ii) values of chroma components of reconstructed samples; iii) values of luma components of predicted samples; iv) values of chroma components of predicted samples; v) first block boundary strength, BBS, information indicating strength of a filtering applied to a boundary of luma components of samples; vi) second BBS information indicating strength of a filtering applied to a boundary of chroma components of samples; and iv) quantization parameters, QP. The apparatus is configured to provide the ML input data to a ML model, thereby generating ML output data; and based at least on the ML output data, generate the encoded video or the decoded video.

In a different aspect, there is provided an apparatus for generating an encoded video or a decoded video. The apparatus is configured to obtain values of reconstructed samples; obtain quantization parameters, QPs; provide the reconstructed sample values and the quantization parameters to a machine learning, ML, model, thereby generating ML output data; based at least on the ML output data, generate first output sample values; provide the first output sample values to a group of two or more attention residual blocks connected in series, thereby generating second output sample values; and generate the encoded video or the decoded video based on the second output sample values. The group of attention residual blocks comprises a first attention residual block disposed at one end of the series of attention residual blocks, and the first attention residual block is configured to receive input data consisting of the first output sample values and the QPs.

In a different aspect, there is provided a method of training a machine learning, ML, model used for generating encoded video data or decoded video data. The method comprises obtaining original video data and converting the original video data into ML input video data. The method further comprises providing the ML input video data into the ML model, thereby generating first ML output video data; and training the ML model based on a difference between the original video data and the ML input video data and a difference between the original video data and the first ML output video data.

In a different aspect, there is provided a method of training a machine learning, ML, model used for generating encoded video data or decoded video data. The method comprises obtaining ML input video data and providing the ML input video data and a first quantization parameter value into the ML model, thereby generating first ML output video data. The method further comprises providing the ML input video data and a second quantization parameter value into the ML model, thereby generating second ML output video data; and training the ML model based on the ML input video data, the first ML output video data, and the second ML output video data.

In a different aspect, there is provided a method of training a machine learning, ML, model used for generating encoded video data or decoded video data. The method comprises obtaining first ML input video data corresponding to a first frame; and obtaining second ML input video data corresponding to a second frame, wherein the second frame is different from the first frame. The method further comprises providing the first ML input video data into the ML model, thereby generating first ML output video data; providing the second ML input video data, thereby generating second ML output video data; and training the ML model based on the ML input video data, the first ML output video data, the second ML output video data, a first weight value associated with the first ML output video data, and a second weight value associated with the second ML output video data.

In a different aspect, there is provided a method of training a machine learning, ML, model used for generating encoded video data or decoded video data. The method comprises obtaining original video data; obtaining ML input video data; providing the ML input video data into the ML model, thereby generating ML output video data; and training the ML model based on a first difference between the original video data and the ML input video data, a second difference between the ML output video data and the ML output video data, and an adjustment value for the second difference.

In a different aspect, there is provided a method of generating encoded video data or decoded video data. The method comprises obtaining original video data; and converting the original video data into machine learning, ML, input video data using one or more components in a video encoder or a video decoder. The method further comprises providing the ML input video data into a trained ML model, thereby generating ML output video data; and generating the encoded video data or the decoded video data based on the generated ML output video data. The trained ML model is trained using original training video data, a difference between the original training video data and ML input training video data, and a difference between the original training video data and ML output training video data, the ML input training video data is obtained by providing the original training video data to said one or more components of the video encoder or the video decoder, and the ML output training video data is obtained by providing the ML input training video data to a ML model.

In a different aspect, there is provided a method of selecting from a picture a patch for training a machine learning, ML, model used for encoding or decoding video data. The method comprises randomly selecting one or more coordinates of the patch, converting said one or more coordinates of the patch into converted one or more coordinates of the patch, and training the ML model based on the converted one or more coordinates of the patch, wherein each of said one or more converted coordinates of the patch is an integer multiple of 2\hat{ }p, where p is an integer.

In a different aspect, there is provided a method of selecting from a picture a patch for training a machine learning, ML, model used for encoding or decoding video data. The method comprises selecting a first position of the patch such that the first position of the patch is outside of a defined area; and training the ML model using sample data which is obtained based on the selected first position.

In a different aspect, there is provided a method of training a machine learning, ML, model for encoding or decoding video data. The method comprises retrieving from a storage (e.g., a hard disk, a solid state drive, etc.) a first file containing first segment data of a first segment included in a picture, wherein the first segment is smaller than the picture, based at least on the first segment data, obtaining patch data of a patch which is a part of the first segment, and using the patch data, training (the ML model.

In a different aspect, there is provided a computer program comprising instructions which when executed by processing circuitry cause the processing circuitry to perform the method of at least one of the embodiments described above.

In a different aspect, there is provided an apparatus for training a machine learning, ML, model used for generating encoded video data or decoded video data, the apparatus being configured to: obtain original video data; convert the original video data into ML input video data; provide the ML input video data into the ML model, thereby generating first ML output video data; and train the ML model based on a difference between the original video data and the ML input video data and a difference between the original video data and the first ML output video data.

In a different aspect, there is provided an apparatus for training a machine learning, ML, model used for generating encoded video data or decoded video data, the apparatus being configured to: obtain ML input video data; provide the ML input video data and a first quantization parameter value into the ML model, thereby generating first ML output video data; provide the ML input video data and a second quantization parameter value into the ML model, thereby generating second ML output video data; and train the ML model based on the ML input video data, the first ML output video data, and the second ML output video data.

In a different aspect, there is provided an apparatus for training a machine learning, ML, model used for generating encoded video data or decoded video data, the method comprising: obtain first ML input video data corresponding to a first frame; obtain second ML input video data corresponding to a second frame, wherein the second frame is different from the first frame; provide the first ML input video data into the ML model, thereby generating first ML output video data; provide the second ML input video data, thereby generating second ML output video data; and train the ML model based on the ML input video data, the first ML output video data, the second ML output video data, a first weight value associated with the first ML output video data, and a second weight value associated with the second ML output video data.

In a different aspect, there is provided an apparatus for training a machine learning, ML, model used for generating encoded video data or decoded video data, the apparatus being configured to: obtain original video data; obtain ML input video data; provide the ML input video data into the ML model, thereby generating ML output video data; and train the ML model based on a first difference between the original video data and the ML input video data, a second difference between the ML output video data and the ML output video data, and an adjustment value for the second difference.

In a different aspect, there is provided an apparatus for generating encoded video data or decoded video data, the apparatus being configured to: obtain original video data; convert the original video data into machine learning, ML, input video data using one or more components in a video encoder or a video decoder; provide the ML input video data into a trained ML model, thereby generating ML output video data; and generate the encoded video data or the decoded video data based on the generated ML output video data, wherein the trained ML model is trained using original training video data, a difference between the original training video data and ML input training video data, and a difference between the original training video data and ML output training video data, the ML input training video data is obtained by providing the original training video data to said one or more components of the video encoder or the video decoder, and the ML output training video data is obtained by providing the ML input training video data to a ML model.

In a different aspect, there is provided an apparatus for selecting from a picture a patch for training a machine learning, ML, model used for encoding or decoding video data. The apparatus is configured to randomly select one or more coordinates of the patch; convert said one or more coordinates of the patch into converted one or more coordinates of the patch; and train the ML model based on the converted one or more coordinates of the patch, wherein each of said one or more converted coordinates of the patch is an integer multiple of 2\hat{ }p, where p is an integer.

In a different aspect, there is provided an apparatus for selecting from a picture a patch for training a machine learning, ML, model used for encoding or decoding video data. The apparatus is configured to select a first position of the patch such that the first position of the patch is outside of a defined area; and train the ML model using sample data which is obtained based on the selected first position.

In a different aspect, there is provided an apparatus for training a machine learning, ML, model for encoding or decoding video data. The apparatus is configured to retrieve from a storage (e.g., a hard disk, a solid state drive, etc.) a first file containing first segment data of a first segment included in a picture, wherein the first segment is smaller than the picture, based at least on the first segment data, obtain patch data of a patch which is a part of the first segment, and using the patch data, train the ML model.

In a different aspect, there is provided an apparatus comprising a processing circuitry; and a memory, said memory containing instructions executable by said processing circuitry, whereby the apparatus is operative to perform the method of at least one of the embodiments described above.

Embodiments of this disclosure provide a way to reduce the complexity of the NN model while substantially maintaining or improving the performance of the NN model.

### BRIEF DESCRIPTION OF THE DRAWINGS

The accompanying drawings, which are incorporated herein and form part of the specification, illustrate various embodiments.

FIG. 1A shows a system according to some embodiments.

FIG. 1B shows a system according to some embodiments.

FIG. 1C shows a system according to some embodiments.

FIG. 2 shows a schematic block diagram of an encoder according to some embodiments.

FIG. 3 shows a schematic block diagram of a decoder according to some embodiments.

FIG. 4 shows a schematic block diagram of a portion of an NN filter according to some embodiments.

FIG. 5 shows a schematic block diagram of a portion of an NN filter according to some embodiments.

FIG. 6A shows a schematic block diagram of an attention block according to some embodiments.

FIG. 6B shows an example of an attention block according to some embodiments.

FIG. 6C shows a schematic block diagram of a residual block according to some embodiments.

FIG. 6D shows a schematic block diagram of a attention block according to some embodiments.

FIG. 7 shows a process according to some embodiments.

FIG. 8 shows a process according to some embodiments.

FIG. 9 shows a process according to some embodiments.

FIG. 10 shows a process according to some embodiments.

FIG. 11 shows a process according to some embodiments.

FIG. 12 shows an apparatus according to some embodiments.

FIG. 13 shows a process according to some embodiments.

FIG. 14A shows a simplified conceptual block diagram of a neural network.

FIG. 14B shows a simplified block diagram of a neural network filter.

FIG. 15A shows a block diagram for generating the adjusted output of the NN filter 230 according to some embodiments.

FIG. 15B shows a method of calculating a correct residual.

FIG. 16 shows a method of calculating a correct residual.

FIG. 17 shows a process according to some embodiments.

FIG. 18 shows a process according to some embodiments.

FIG. 19 shows a process according to some embodiments.

FIG. 20 shows a process according to some embodiments.

FIG. 21 shows a process according to some embodiments.

FIG. 22 shows a method of training a neural network filter using input data that is generated based on different quantization parameter values.

FIG. 23 shows different temporal layers.

FIGS. 24-35 illustrate different methods of obtaining training data.

FIG. 36 shows a process according to some embodiments.

FIG. 37 shows a process according to some embodiments.

FIG. 38 shows a process according to some embodiments.

### DETAILED DESCRIPTION

The following terminologies are used in the description of the embodiments below:

Neural network: a generic term for an entity with one or more layers of simple processing units called neurons or nodes having activation functions and interacting with each other via weighted connections and biases, which collectively create a tool in the context of non-linear transforms.

Neural network architecture, network architecture, or architecture in short: the layout of a neural network describing the placement of the nodes and their connections, usually in the form of several interconnected layers, and may also specify the dimensionality of the input(s) and output(s) as well as the activation functions for the nodes.

Neural network weights, or weights in short: The weight values assigned to the connections between the nodes in a neural network.

Neural network model, or model in short: a transform in the form of a trained neural network. A neural network model may be specified as the neural network architecture, activation functions, biases, and weights.

Filter: A transform. A neural network model is one realization of a filter. The term NN filter may be used as a short form of neural-network-based filter or neural network filter.

Neural network training, or training in short: The process of finding the values for the weights and biases for a neural network. Usually, a training data set is used to train the neural network and the goal of the training is to minimize a defined error. The amount of training data needs to be sufficiently large to avoid overtraining. Training a neural network is normally a time-consuming task and typically comprises a number of iterations over the training data, where each iteration is referred to as an epoch.

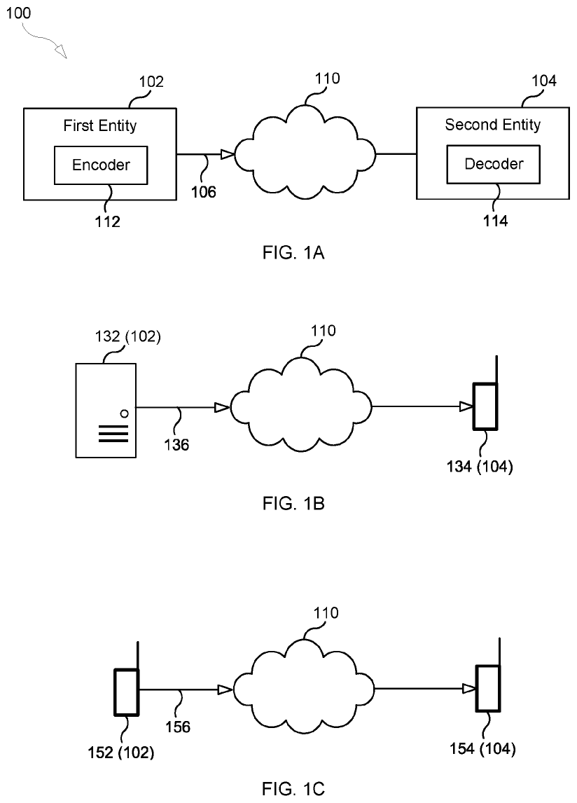

FIG. 1A shows a system 100 according to some embodiments. The system 100 comprises a first entity 102, a second entity 104, and a network 110. The first entity 102 is configured to transmit towards the second entity 104 a video stream (a.k.a., “a video bitstream,” “a bitstream,” “an encoded video”) 106.

The first entity 102 may be any computing device (e.g., a network node such as a server) capable of encoding a video using an encoder 112 and transmitting the encoded video towards the second entity 104 via the network 110. The second entity 104 may be any computing device (e.g., a network node) capable of receiving the encoded video and decoding the encoded video using a decoder 114. Each of the first entity 102 and the second entity 104 may be a single physical entity or a combination of multiple physical entities. The multiple physical entities may be located in the same location or may be distributed in a cloud.

In some embodiments, as shown in FIG. 1B, the first entity 102 is a video streaming server 132 and the second entity 104 is a user equipment (UE) 134. The UE 134 may be any of a desktop, a laptop, a tablet, a mobile phone, or any other computing device. The video streaming server 132 is capable of transmitting a video bitstream 136 (e.g., YouTube™ video streaming) towards the video streaming client 134. Upon receiving the video bitstream 136, the UE 134 may decode the received video bitstream 136, thereby generating and displaying a video for the video streaming.

In other embodiments, as shown in FIG. 1C, the first entity 102 and the second entity 104 are first and second UEs 152 and 154. For example, the first UE 152 may be an offeror of a video conferencing session or a caller of a video chat, and the second UE 154 may be an answerer of the video conference session or the answerer of the video chat. In the embodiments shown in FIG. 1C, the first UE 152 is capable of transmitting a video bitstream 156 for a video conference (e.g., Zoom™, Skype™, MS Teams™, etc.) or a video chat (e.g., Facetime™) towards the second UE 154. Upon receiving the video bitstream 156, the UE 154 may decode the received video bitstream 156, thereby generating and displaying a video for the video conferencing session or the video chat.

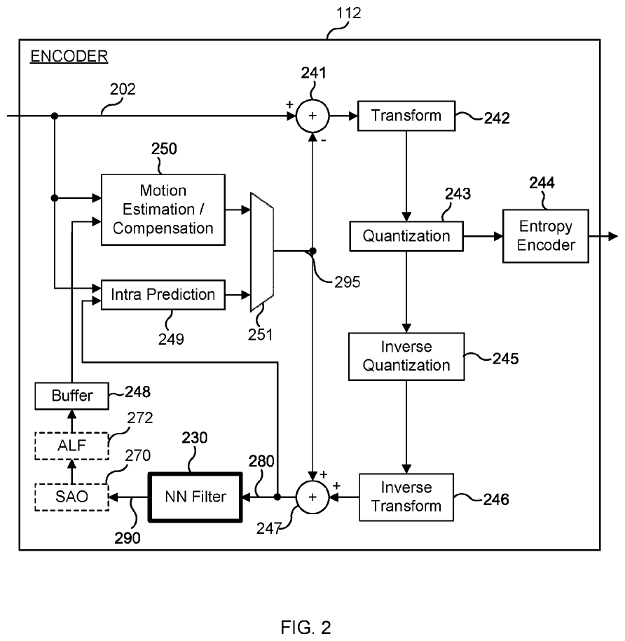

FIG. 2 shows a schematic block diagram of the encoder 112 according to some embodiments. The encoder 112 is configured to encode a block of sample values (hereafter “block”) in a video frame of a source video 202. In the encoder 112, a current block (e.g., a block included in a video frame of the source video 202) is predicted by performing a motion estimation by a motion estimator 250 from an already provided block in the same frame or in a previous frame. The result of the motion estimation is a motion or displacement vector associated with the reference block, in the case of inter prediction. The motion vector is utilized by the motion compensator 250 for outputting an inter prediction of the block.

An intra predictor 249 computes an intra prediction of the current block. The outputs from the motion estimator/compensator 250 and the intra predictor 249 are inputted to a selector 251 that either selects intra prediction or inter prediction for the current block. The output from the selector 251 is input to an error calculator in the form of an adder 241 that also receives the sample values of the current block. The adder 241 calculates and outputs a residual error as the difference in sample values between the block and its prediction. The error is transformed in a transformer 242, such as by a discrete cosine transform, and quantized by a quantizer 243 followed by coding in an encoder 244, such as by entropy encoder. In inter coding, the estimated motion vector is brought to the encoder 244 for generating the coded representation of the current block.

The transformed and quantized residual error for the current block is also provided to an inverse quantizer 245 and inverse transformer 246 to retrieve the original residual error. This error is added by an adder 247 to the block prediction output from the motion compensator 250 or the intra predictor 249 to create a reconstructed sample block 280 that can be used in the prediction and coding of a next block. The reconstructed sample block 280 is processed by a NN filter 230 according to the embodiments in order to perform filtering to combat any blocking artifact. The output from the NN filter 230, i.e., the output data 290, is then temporarily stored in a frame buffer 248, where it is available to the intra predictor 249 and the motion estimator/compensator 250.

In some embodiments, the encoder 112 may include SAO unit 270 and/or ALF 272. The SAO unit 270 and the ALF 272 may be configured to receive the output data 290 from the NN filter 230, perform additional filtering on the output data 290, and provide the filtered output data to the buffer 248.

Even though, in the embodiments shown in FIG. 2, the NN filter 230 is disposed between the SAO unit 270 and the adder 247, in other embodiments, the NN filter 230 may replace the SAO unit 270 and/or the ALF 272. Alternatively, in other embodiments, the NN filter 230 may be disposed between the buffer 248 and the motion compensator 250. Furthermore, in some embodiments, a deblocking filter (not shown) may be disposed between the NN filter 230 and the adder 247 such that the reconstructed sample block 280 goes through the deblocking process and then is provided to the NN filter 230.

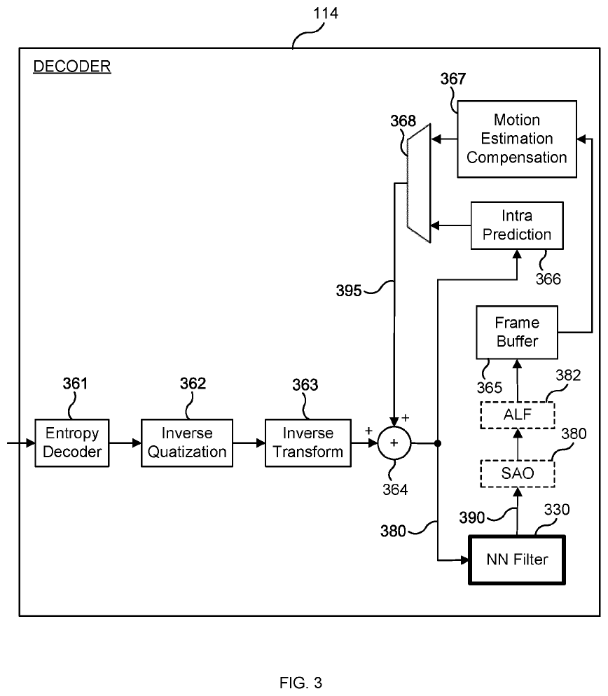

FIG. 3 is a schematic block diagram of the decoder 114 according to some embodiments. The decoder 114 comprises a decoder 361, such as entropy decoder, for decoding an encoded representation of a block to get a set of quantized and transformed residual errors. These residual errors are dequantized in an inverse quantizer 362 and inverse transformed by an inverse transformer 363 to get a set of residual errors. These residual errors are added in an adder 364 to the sample values of a reference block. The reference block is determined by a motion estimator/compensator 367 or intra predictor 366, depending on whether inter or intra prediction is performed.

A selector 368 is thereby interconnected to the adder 364 and the motion estimator/compensator 367 and the intra predictor 366. The resulting decoded block 380 output form the adder 364 is input to a NN filter unit 330 according to the embodiments in order to filter any blocking artifacts. The filtered block 390 is output form the NN filter 330 and is furthermore preferably temporarily provided to a frame buffer 365 and can be used as a reference block for a subsequent block to be decoded.

The frame buffer (e.g., decoded picture buffer (DPB)) 365 is thereby connected to the motion estimator/compensator 367 to make the stored blocks of samples available to the motion estimator/compensator 367. The output from the adder 364 is preferably also input to the intra predictor 366 to be used as an unfiltered reference block.

In some embodiments, the decoder 114 may include SAO unit 380 and/or ALF 372. The SAO unit 380 and the ALF 382 may be configured to receive the output data 390 from the NN filter 330, perform additional filtering on the output data 390, and provide the filtered output data to the buffer 365.

Even though, in the embodiments shown in FIG. 3, the NN filter 330 is disposed between the SAO unit 380 and the adder 364, in other embodiments, the NN filter 330 may replace the SAO unit 380 and/or the ALF 382. Alternatively, in other embodiments, the NN filter 330 may be disposed between the buffer 365 and the motion compensator 367. Furthermore, in some embodiments, a deblocking filter (not shown) may be disposed between the NN filter 330 and the adder 364 such that the reconstructed sample block 380 goes through the deblocking process and then is provided to the NN filter 330.

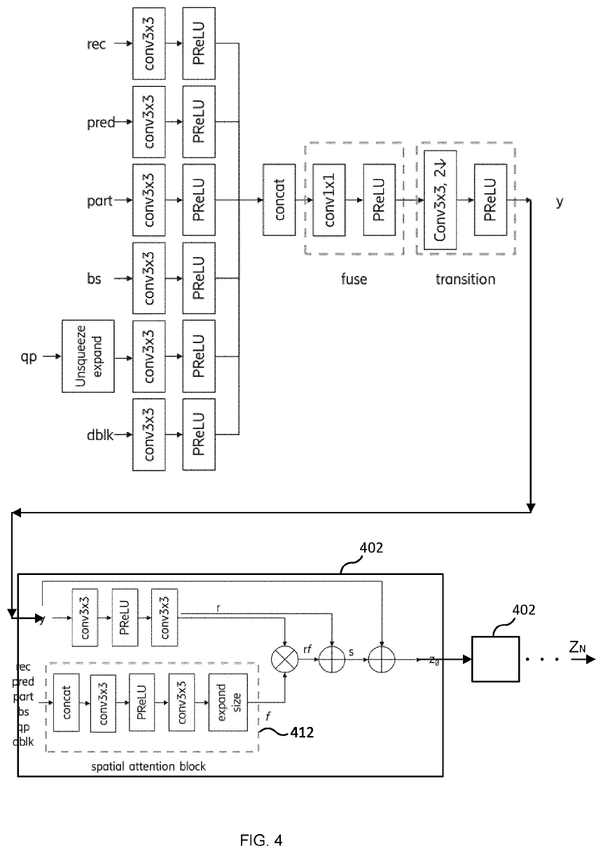

FIG. 4 is a schematic block diagram of a portion the NN filter 230/330 for filtering intra luma samples according to some embodiments. In this disclosure, luma (or chroma) intra samples are luma (or chroma) components of samples that are intra-predicted. Similarly, luma (or chroma) inter samples are luma (or chroma) components of samples that are inter-predicted.

As shown in FIG. 4, the NN filter 230/330 may have six inputs: (1) values of luma components of reconstructed samples (“rec”) 280/380; (2) values of luma components of predicted samples (“pred”) 295/395; (3) partition information indicating how luma components of samples are partitioned (“part”) (more specifically indicating how a luma picture is partitioned into coding tree units, CTUs, and how luma CTUs are partitioned into coding units,); (4) block boundary strength, BBS, information indicating strength of a filtering applied to a boundary of luma components of samples (“bs”); (5) quantization parameters (“qp”); and (6) additional input information. In some embodiments, the additional input information comprises values of luma components of deblocked samples.

Each of the six inputs may go through a convolution layer (labelled as “conv3×3” in FIG. 4) and a parametric rectified linear unit (PRELU) layer (labelled as “PRELU”) separately. The six outputs from the six PRELU layers may then be concatenated via a concatenating unit (labelled as “concat” in FIG. 4) and fused together to generate data (a.k.a., “signal”) “y.” The convolution layer “conv3×3” is a convolutional layer with kernel size 3×3 and the convolution layer “conv1×1” is a convolutional layer with kernel size 1×1. The PReLUs may make up the activation layer.

In some embodiments, qp may be a scalar value. In such embodiments, the NN filter 230/330 may also include a dimension manipulation unit (labelled as “Unsqueeze expand” in FIG. 4) that may be configured to expand qp such that the expanded qp has the same size as other inputs (i.e., rec, pred, part, bs, and dblk). However, in other embodiments, qp may be a matrix of which the size may be same as the size of other inputs (e.g., rec, pred, part, and/or bs). For example, different samples inside a CTU may be associated with a different qp value. In such embodiments, the dimension manipulation unit is not needed.

In some embodiments, the NN filter 230/330 may also include a downsampler (labelled as “2\” in FIG. 4) which is configured to perform a downsampling with a factor of 2.

As shown in FIG. 4, the data “y” may be provided to a group of N sequential attention residual (herein after, “AR”) blocks 402. In some embodiments, the N sequential AR blocks 402 may have the same structure while, in other embodiments, they may have different structures. N may be any integer that is greater than or equal to 2. For example, N may be equal to 8.

As shown in FIG. 4, the first AR block 402 included in the group may be configured to receive the data “y” and generate first output data “z₀.” The second AR block 402 which is disposed right after the first AR block 402 may be configured to receive the first output data “z₀” and generate second output data “z₁.”

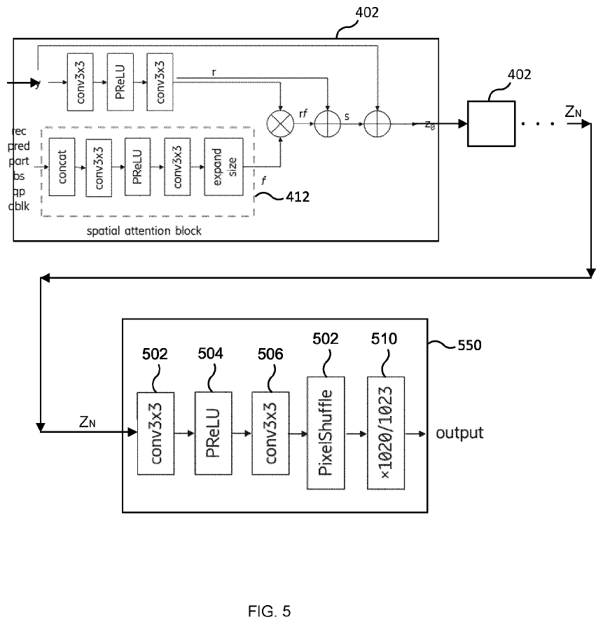

In case the group includes only two AR blocks 402 (i.e., the aforementioned first and second AR blocks), the second output data “z₁” may be provided to a final processing unit 550 (shown in FIG. 5) of the NN filter 230/330.

On the other hand, in case the group includes more than two AR blocks, each AR block 402 included in the group except for the first and the last AR blocks may be configured to receive the output data from the previous AR block 402 and provide its output data to the next AR block. The last AR block 402 may be configured to receive the output data from the previous AR block and provide its output data to the final processing unit 550 of the NN filter 230/330.

Referring back to FIG. 4, some or all of the AR blocks 402 may include a spatial attention block 412 which is configured to generate attention mask ƒ. The attention mask ƒ may have one channel and its size may be the same as the data “y.” Taking the first AR block 402 as an example, the spatial attention block 412 included in the first AR block 402 may be configured to multiply the attention mask ƒ with the residual data “r” to obtain data “rf.” The data “rf” may be combined with the residual data “r” and then combined with the data “y”, thereby generating first output data “z₀.”

As shown in FIG. 5, the output ZN of the group of the AR blocks 402 may be processed by a convolution layer 502, a PReLU 504, another convolution layer 506, pixel shuffling (or really sample shuffling) 508, and a final scaling 510, thereby generating the filtered output data 290/390.

Compared to the luma intra network architecture used in JVET-X0066, the NN filter 230/330 shown in FIGS. 4 and 5 improves the gain to −7/63% while maintaining the complexity of the NN filter at 430 kMAC/sample (e.g., by removing the “part” from the input while adding the “dblk” to the input).

In some embodiments, the NN filter 230/330 shown in FIGS. 4 and 5 may be used for filtering inter luma samples, intra chroma samples, and/or inter chroma samples according to some embodiments.

In case the NN filter 230/330 shown in FIGS. 4 and 5 is used for filtering inter luma samples, the partition information (“part”) may be excluded from the inputs of the NN filter 230/330 and from the inputs of the spatial attention block 412.

In case the NN filter 230/330 shown in FIGS. 4 and 5 is used for filtering intra chroma samples, the NN filter 230/330 may have the following seven inputs (instead of the six inputs shown in FIG. 4): (1) values of luma components of reconstructed samples (“rec”) 280/380; (2) values of chroma components of reconstructed samples (“recUV”) 280/380; (3) values of chroma components (e.g., Cb and Cr) of predicted samples (“predUV”) 295/395; (4) partition information indicating how chroma components of samples are partitioned (“partUV”) (more specifically indicating how a luma picture is partitioned into coding tree units, CTUs, and how luma CTUs are partitioned into coding units); (5) block boundary strength, BBS, information indicating strength of a filtering applied to a boundary of chroma components of samples (“bsUV”); (6) quantization parameters (“qp”); and (7) additional input information. In some embodiments, the additional input information comprises values of chroma components of deblocked samples. Similarly, the above seven inputs may be used as the inputs of the spatial attention block 412.

In case the NN filter 230/330 shown in FIGS. 4 and 5 is used for filtering inter chroma samples, the partition information (“partUV”) may be excluded from the above seven inputs of the NN filter 230/330 and from the seven inputs of the spatial attention block 412.

As discussed above, in some embodiments, the additional input information comprises values of luma or chroma components of deblocked samples. However, in other embodiments, the additional input information may comprise information about predicted samples (a.k.a., “prediction mode information” or “I/P/B prediction mode information”).

For example, the prediction mode information may indicate whether a sample block that is subject to the filtering is an intra-predicted block, an inter-predicted block that is uni-predicted, or an inter-predicted block that is bi-predicted. More specifically, the prediction mode information may be set to have a value 0 if the sample belongs to an intra-predicted block, a value of 0.5 if the sample belongs to an inter-predicted block that is uni-predicted, or a value of 1 if the sample belongs to an inter-predicted block that is bi-predicted. Each of the values indicating the prediction modes can be any real number. For example, in an integer implementation where it is not possible to use 0.5, other values such as 0, 1, and 2 may be used.

Since I-frames only contain I-blocks, the prediction mode information may be constant (e.g., 0) if this architecture is used for luma intra network. On the other hand if this architecture is used for luma inter network, the prediction mode information may be set to different values for different samples and can provide Bjontegaard-delta rate (BDR) gain over the architecture which does not utilize this prediction mode information.

Instead of using the values of luma or chroma components of deblocked samples or the prediction mode information as the additional input information, in some embodiments, motion vector (MV) information may be used as the additional input information. The MV information may indicate the number of MVs (e.g., 0, 1, or 2) used in the prediction. For example, 0 MV may mean that the current block is an I block, 1 MV may mean a P block, 2 MVs may mean a B block.

In some embodiments, in addition to the prediction mode information or the MV information, prediction direction information indicating a direction of prediction for the samples that are subject to the filtering may be included in the additional input information.

Instead of using i) the values of luma or chroma components of deblocked samples, ii) the prediction mode information, or iii) the MV information as the additional input information, in some embodiments, coefficient information may be used as the additional input information.

One example of the coefficient information is skipped block information indicating whether a block of samples that are subject to the NN filtering is a block that is skipped (i.e., the block that did not go through the processes performed by transform unit 242, quantization unit 243, inverse quantization unit 245, and inverse transform unit 246 or the processes performed by the entropy decoder 361, inverse quantization unit 362, and inverse transform unit 363). In one example, the skipped block information may be set to have a value of 0 if the block of samples subject to the NN filtering is a block that is not skipped and 1 if the block is a skipped block.

With respect to the encoder 112 shown in FIG. 2, a skipped block may correspond to reconstructed samples 280 that are obtained based solely on the predicted samples 295 (instead of a sum of the predicted samples 295 and the output from the inverse transform unit 246). Similarly, with respect to the decoder 114 shown in FIG. 3, a skipped block may correspond to the reconstructed samples 380 that are obtained based solely on the predicted samples 395 (instead of a sum of the predicted samples 395 and the output from the inverse transform unit 363).

Since I-frames only contain I-blocks, and these blocks cannot be skipped, the skipped block information would be constant (e.g., 0) if this architecture is used for luma intra network. On the other hand, if this architecture is used for luma inter network, the skipped block information may have different values for different samples, and can provide a BDR gain over other alternative architectures which do not utilize the skipped block information.

Referring back to FIG. 4, as shown in FIG. 4, in some embodiments, the NN filter 230/330 for filtering intra luma samples have six inputs. However, in other embodiments, the partition information may be removed from the inputs, making the total number of inputs of the NN filter 230/330 five: i.e., (1) values of luma components of reconstructed samples (“rec”) 280/380; (2) values of luma components of predicted samples (“pred”) 295/395; (3) block boundary strength, BBS, information indicating strength of a filtering applied to a boundary of luma components of samples (“bs”); (4) quantization parameters (“qp”); and (5) additional input information. In some embodiments, the additional input information comprises values of luma components of deblocked samples. As discussed above, in case the NN filter 230/330 shown in FIG. 4 is used for filtering inter luma samples, the inputs of the NN filter 230/330 have the five inputs (excluding the partition information) instead of the six inputs. Similarly, the inputs of the spatial attention block 412 would be the five inputs instead of the six inputs. Thus, in these embodiments, the inputs of the NN filter 230/330 used for filtering intra luma samples and the inputs of the NN filter 230/330 used for filter inter luma samples would be the same.

Instead of removing the partition information from the inputs, in some embodiments, the BBS information may be removed from the inputs. Thus, in these embodiments, the inputs of the NN filter 230/330 for filtering intra luma samples are: (1) values of luma components of reconstructed samples (“rec”) 280/380; (2) values of luma components of predicted samples (“pred”) 295/395; (3) partition information indicating how luma components of samples are partitioned (“part”); (4) quantization parameters (“qp”); and (5) additional input information. In case the NN filter 230/330 is used for filtering inter luma samples, inter chroma samples, or intra chroma samples, the BBS information may be removed from the inputs of the NN filter 230/330 and the inputs of the special attention block 412.

As discussed above, in some embodiments, different inputs are provided to the NN filter 230/330 for its filtering operation. For example, in some embodiments, “rec,” “pred,” “part,” “bs,” “qp,” and “dblk” are provided as the inputs of the NN filter 230/330 for luma components of intra-predicted samples while “rec,” “pred,” “bs,” “qp,” and “dblk” are provided as the inputs of the NN filter 230/330 for luma components of inter-predicted samples. Similarly, in some embodiments, “rec,” “recUV,” “predUV,” “partUV,” “bsUV,” “qp,” and “dblk” are provided as the inputs of the NN filter 230/330 for chroma components of intra-predicted samples while “rec,” “recUV,” “predUV,” “bsUV,” “qp,” and “dblk” are provided as the inputs of the NN filter 230/330 for luma components of inter-predicted samples. In other words, four different NN filters 230/330 may be used for four different types of samples-inter luma samples, intra luma samples, inter chroma samples, and intra chroma samples.

However, in other embodiments, the same NN filter 230/330 may be used for luma components of samples (regardless of whether they are inter-predicted or intra-predicted) and the same NN filter 230/330 may be used for chroma components of samples (regardless of whether they are inter-predicted or intra-predicted). In such embodiments, instead of using two different filters, “IPB-info” may be used to differentiate inter blocks and intra blocks from each other. Thus, in one example, “rec,” “pred,” “part,” “bs,” “qp,” and “IPB-info” are provided as the inputs of the NN filter 230/330 for luma components of samples (whether they are inter-predicted or intra-predicted) while “rec,” “recUV,” “predUV,” “partUV,” “bsUV,” “qp,” and “IPB-info” are provided as the inputs of the NN filter 230/330 for chroma components of samples (whether they are inter-predicted or intra-predicted).

Alternatively, in some embodiments, the same NN filter 230/330 may be used for any component of samples that are intra-predicted and the same NN filter 230/330 may be used for any component of samples that are inter-predicted. In these embodiments, the same inputs are used for luma components of samples and chroma components of samples. Thus, in one example, “rec,” “pred,” “part,” “bs,” “recUV,” “predUV,” “partUV,” “bsUV,” “qp,” are provided as the inputs of the NN filter 230/330 for intra-predicted samples while “rec,” “pred,” “bs,” “recUV,” “predUV,” “bsUV,” “qp” are provided as the inputs of the NN filter 230/330 for inter-predicted samples. In these embodiments, the outputs of the NN filters 230/330 are NN-filtered luma samples and NN-filtered chroma samples.

Instead of using two different NN filters 230/330, in some embodiments, the same NN filter 230/330 may be used for the four different types of samples-inter luma samples, intra luma samples, inter chroma samples, and intra chroma samples. In these embodiments, the inter or intra information may be given by “IPB-info” and the cross component benefits may be given by taking in both luma and chroma related inputs. Thus, in one example, “rec,” “pred,” “part,” “bs,” “recUV,” “predUV,” “partUV,” “bsUV,” “qp,” and “IPB-info” are provided as the inputs of the NN filter 230/330 for the four different types of samples.

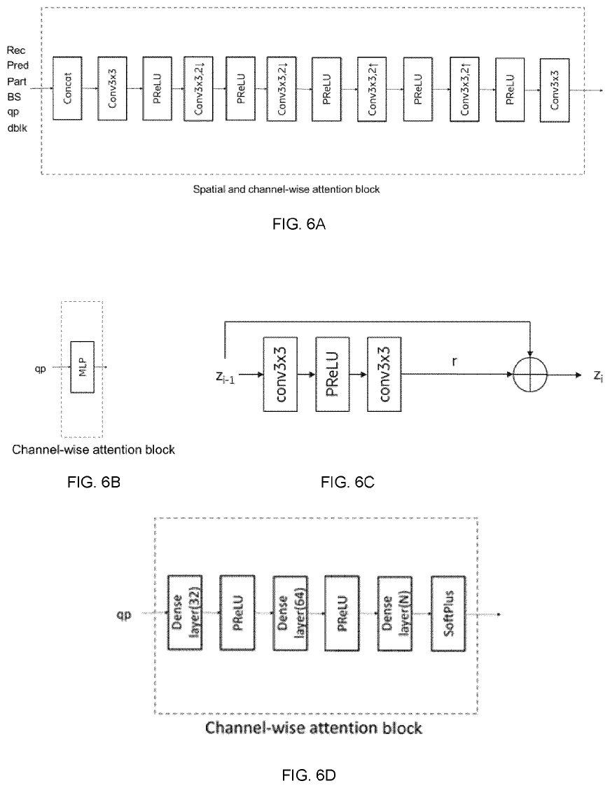

In the above discussed embodiments, the performance and/or efficiency of the NN filter 230/330 is improved by adjusting the inputs provided to the NN filter 230/330. However, in some embodiments, the performance and/or efficiency of the NN filter 230/330 is improved by changing the structure of the AR block 402. More specifically, in some embodiments, the spatial attention block 412 may be removed from first M AR blocks 402, as shown in FIG. 6C (compare with the spatial attention block 412 shown in FIG. 4). For example, in case 8 (or 16) AR blocks 402 are included in the NN filter 230/330, the first 7 (or 15) AR blocks 402 may not include the spatial attention block 412 and only the last AR block 402 may include the spatial attention block 412. In another example, none of the AR blocks 402 included in the NN filter 230/330 includes the spatial attention block 412.

In some embodiments, instead of or in addition to adjusting the inputs of the NN filter 230/330 and/or removing the spatial attention block 412 from the AR block 402, the performance and/or efficiency of the NN filter 230/330 may be improved by adjusting the capacity of the spatial attention block 412. For example, in some embodiments, the number of layers in the spatial attention block 412 may be increased (with respect to the number of layers in the JVET-X0066) and configure the layers to perform down-sampling and up-sample in order to improve the performance of capturing the correlation of the latent. An example of the spatial attention block 412 according to these embodiments is shown in FIG. 6A.

In some embodiments, instead of or in addition to increasing the capacity of the spatial attention block 412, the output of the spatial attention block 412 may be increased from one channel to a plurality of channels in order to provide the spatial and channel-wise attention. For example, generally, in the CNN layer(s) included in the spatial attention block 412, a single kernel (e.g., having the size of 3×3) is used for performing the convolution operations. However, in these embodiments, a plurality of kernels (e.g., 96) may be used for performing the convolution operations. As a result of using multiple kernels (each of which is associated with a particular channel), multiple channel outputs may be generated.

In some embodiments, in generating produce the channel-wise attention, only the “qp” may be used. For example, as shown in FIG. 6B, a multilayer perceptron (MLP) may be used to generate multiple channel outputs using the “QP” as the input. MLP is a class of feedforward artificial neural network (ANN, usually simply called neural networks). The term MLP is used ambiguously, sometimes loosely to mean any feedforward ANN, sometimes strictly to refer to networks composed of multiple layers of perceptrons (with threshold activation). Multilayer perceptrons are sometimes colloquially referred to as ‘vanilla’ neural networks, especially when they have a single hidden layer. An MLP consists of at least three layers of nodes: an input layer, a hidden layer and an output layer. An exemplary implementation of these embodiments is shown in FIG. 6D. As shown in FIG. 6D, the spatial attention block 412 may include PRELU layers, dense layers, and SoftPlus layer(s), and these layers may be used together to generate the multiple channel outputs using the “QP” as the input. In some embodiments, the Softplus layer (a.k.a., Softplus activation function) may be defined as follows: softplus (x)=log (1+e^{x}). A dense layer is a layer that is deeply connected with its preceding layer which means the neurons of the layer are connected to every neuron of its preceding layer. In some embodiments, instead of performing the attention operation, e.g., multiplication, from the output of the MLP with the residue data “r,” the operation can be performed with the output data “zᵢ” shown in FIG. 6C.

The embodiments of this disclosure provide any least one of the following advantages.

By retraining the luma intra model from JVET-Y0143, the model gives a luma gain of 7.57% for all-intra configuration. The difference between the previous gain of 7.39% reported in JVET-X0066 and that of the retrained network of 7.57% is due to a different training procedure. As an example, the training time for the retrained network may have been longer. By removing the partition input “part”, the gain is still 7.57%, and the complexity is reduced from 430 kMAC/pixel to 419 kMAC/pixel. By removing an additional bs input “bs”, the gain is 7.42%, and the complexity is reduced to 408 kMAC/pixel.

By removing the first seven spatial attention masks, the gain is 7.60%, and the complexity is reduced from 430 kMAC/pixel to 427 kMAC/pixel.

By using the deblocked information as input and removing the partition input, the gain improves to 7.63%, while the complexity remains the same 430 kMAC/pixel.

By removing all the spatial attention masks, the gain is 7.72% for class D sequences.

By increasing the capacity of the attention branch, the gain is improved from 7.70% to 7.85% for class D sequences. The complexity is increased to around 120%.

By using channel-wise attention with qp as input, a gain of 7.78% is obtained for class D sequences, and the complexity is reduced to 428.7 kMAC/pixel.

As discussed above, the NN filter 230/330 may be used for generating encoded/decoded video data. In order to perform encoding/decoding properly, the NN filter 230/330 needs to be trained. The embodiments provided below provide different ways of training the NN filter 230/330. For the purpose of simple explanation, the embodiments below are explained with respect to either the NN filter 230 (the NN filter used for encoding) or the NN filter 330 (the NN filter used for decoding). However, the embodiments described below are equally applicable to any of the NN filter 230 and the NN filter 330.

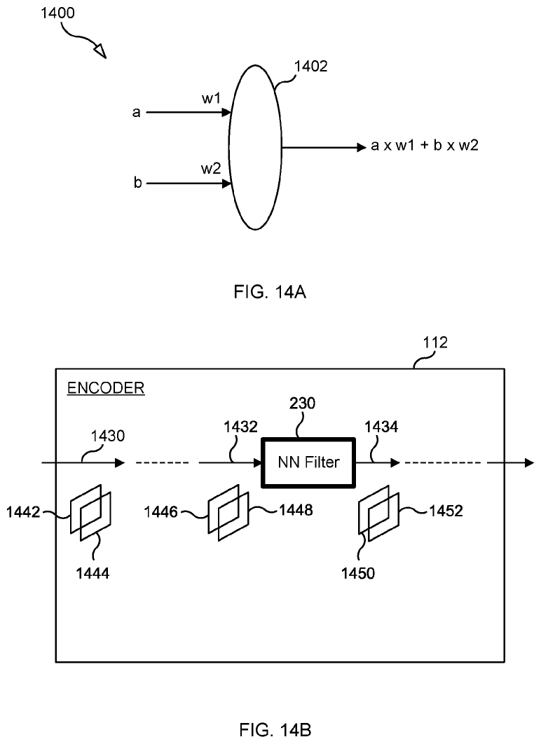

FIG. 14A shows a simplified conceptual diagram of an NN model 1400. As shown in FIG. 14, two input data values “a” and “b” are provided to an NN layer 1402, and the NN layer 1402 generates an output value “a× w1+b× w2” based on the two input data values “a” and “b,” and weights w1 and w2, which are assigned to the two input data values. In case the ideal behavior of the NN model 1400 when the two input data values “a” and “b” are provided to the NN model 1400 is generating an output value outa, the goal of training the NN model 1400 is finding the weights w1 and w2 that minimize the difference between the output value “a×w1+b×w2” and the target output value outd. In this disclosure, the difference between a target output of a NN model and an actual output of the NN model is referred as a loss value. As mentioned above, FIG. 14 shows a simplified conceptual diagram of the NN model 1400. In real-world implementations, the NN model 1400 includes additional inputs and/or additional layers. Also, the NN model 1400 may also include a nonlinearity, such as a Rectified Linear Unit (ReLU) y=max (0,x) of the output.

Referring back to the NN filter 230, the NN filter 230 may be trained to reduce the loss value—the difference between target output of the NN filter 230 and the actual output of the NN filter 230. The target output of the NN filter 230 may contain a plurality of values and the actual output of the NN filter 230 may also contain a plurality of values. In such case, the difference between the target output of the NN filter 230 and the actual output of the NN filter 230 may be calculated by summing up the differences each of which is between one of the plurality of values included in the target output of the NN filter 230 and one of the plurality of values included in the actual output of the NN filter 230. Alternatively, the difference between the target output of the NN filter 230 and the actual output of the NN filter 230 may be an average value of the differences each of which is between one of the plurality of values included in the target output of the NN filter 230 and one of the plurality of values included in the actual output of the NN filter 230.

In FIG. 2, one of the values included in the target output of the NN filter 230 corresponds to a pixel value of original video data 202, and one of the values included in the actual output of the NN filter 230 corresponds to a pixel value of NN filtered data 290. In this scenario, the loss value may be determined by summing up the differences each of which is between a pixel value of original video data 202 and a pixel value of the NN filtered data 290. Alternatively, the loss value may be determined by calculating an average of the differences.

Depending on a choice of a loss function, the difference between a pixel value of original video data 202 and a pixel value of the NN filtered data 290 may be an absolute difference or a squared difference.

For example, in case L2 is used, the difference is a squared difference between one of the plurality values included in the target output and one of the plurality of values included in the actual output (i.e., (target output value-actual output value)\hat{ }2). On the other hand, in case L1 is used, the difference is an absolute difference between one of the plurality values included in the target output and one of the plurality of values included in the actual output (i.e., |target output data−actual output data|). The table below summarizes a method for training the NN filter 230 using L1 or L2 in Pytorch.

| L1 | L2 |
|---|---|
| filteredY = model(recY, predY, bsY, IPB, | filteredY = model(recY, predY, bsY, IPB, |
| skip, QP) | skip, QP) |
| loss = torch.mean((origY-filteredY).abs( )) | loss = torch.mean((origY- |
| loss.backward( ) | filteredY).square( )) |
| | loss.backward( ) |

where filteredY is one of the plurality of values included in the actual output of the NN filter 230, origY is one of the plurality of values included in the target output. In the embodiments shown in the table above, the loss value is calculated based on an average or a sum of the differences. The loss value obtained using L1 or L2 may be used for backpropagation to train the NN filter 230.

There is a problem, however, of using L1 or L2 for training the NN filter 230. For example, if the NN filter 230 is trained using the aforementioned loss functions L1 or L2, the training may put an overemphasis on certain training input data.

For example, let's assume that, as shown in FIG. 14B (which is a simplified diagram of the encoder 112 shown in FIG. 2), the NN filter 230 is trained using training input data 1432 that has a minibatch of size two (meaning that the NN filter 230 is trained using two 128×128 patches). Note that the size of the patches is not limited to 128×128 but can be any number. For example, in one embodiment, the size of the patches may be 256×256. One aspect of the embodiments is to train with a bigger patch size than is used in the encoder/decoder. Since the encoder/decoder in this case uses 144×144 as input, it is in this case preferable to use 256×256 during training rather than 128×128, but for the sake of simplicity we will continue the discussion using 128×128 patches as an example. The first 128×128 patch 1446 may be generated from first picture data 1442 compressed with QP=17, and thus the error that is the (e.g., squared or absolute) summed difference between output data 1450 of the NN filter 230 and the first patch 1446, is very small (e.g., 0.1). On the other hand, the second 128×128 patch 1448 may be generated from second picture data 1444 compressed with QP=47, and thus the error between the output data 1452 of the NN filter 230 and the patch 1448 is large (e.g., typically the error doubles every 6 QP steps, so the error in this example is likely 2\hat{ }((47−17)/6)=32 times bigger, thus 3.2). Then, the total error is equal to 0.1+3.2=3.3.

Here, during the training of the NN filter 230, the very small error (e.g., 0.1) corresponding to the first 128×128 patch will likely be ignored and only the large error (3.2) corresponding to the second 128×128 patch will affect the training. This means that the first 128×128 patch (that was generated using QP=17) will practically be ignored by the NN filter 230 during the training.

Therefore, the training will not result in making the NN filter 230 to be good at improving quality of picture blocks that come from pictures processed with QP=17. It should be noted that it is very important for the resulting trained NN to be good not only at QP=47 but also at QP=17, since the same codec will be used for many different quality levels. Furthermore, here, even though the pictures processed with QP=17 does not help much in improving the NN filter 230, because the training is still performed based on the pictures processed with QP=17, the training will be slower than if just the QP=17 examples were removed from the training set.

One way to resolve the above problems is to normalize the error using a function that is based on a QP value. More specifically, the error may be normalized by dividing the error by 2\hat{ }((QP/6). Thus, in the above, example, normalizing the first error of 0.1 by 2\hat{ }(17/6) would result in 0.014 and normalizing the second error of 3.2 by 2\hat{ }(47/6) would result in 0.014. By normalizing the error in this way, the gradient descent would put equal emphasis on both training examples (i.e., the first patch 1446 and the second patch 1448) (meaning that during the training the first patch 1446 and the second patch 1448 will be given similar weights).

However, the above method may not work for all training examples. For instance, if we have a 128×128 patch where the original picture used for generating the 128×128 patch is almost flat, the patch has more or less the same error everywhere. This is a particularly easy block to compress, which means that the reconstruction will be almost perfect even at high QPs. It will thus get a very small error and further dividing that by a factor of, say, 228.1 will mean that it will be almost completely ignored by the gradient descent algorithm. This may mean that the resulting network may underperform for flat blocks from images compressed with a high QP.

Thus, according to some embodiments of this disclosure, the error (i.e., the loss value) of the NN filter 230 may be normalized using reconstructed samples. These embodiments are based on the assumption that if the error between the reconstructed samples (e.g., 1432) and the original samples (e.g., 1430) is large, then the error between the NN filtered output (e.g., 1434) and the original samples (e.g., 1430) would also tend to be large.

More specifically, in these embodiments, the loss value (i.e., the difference between the original input data 1430 and the actual NN filtered output data 1434) may be normalized by dividing the loss value by the difference between the original input data 1430 and the reconstrued input data 1432. By using this normalized loss value for the backpropagation for training the NN filter 230, input data processed with different QP values will be treated equally when they are used for training the NN filter 230.

The table below summarizes a method for training the NN filter 230 using normalized L2 in Pytorch.

# origY is a tensor of [64, 1, 128, 128], where 64 is the size of a mini-batch, 1 signifies a
single channel (only luma), 128 is the height of the patch and 128 is the width of the patch
# the other inputs recY, predY, bsY, IPB and skip have the same shape.
filteredY = model(recY, predY, bsY, IPB, skip, QP)
# this calculates the output of the NN filter 230 based on inputs (recY, predY, bsY, IPB,
skip, QP).
# here, filteredY corresponds to NN filtered output data 1434.
oloss = origY.detach( ) − recY.detach( )
# this creates a tensor of [64, 1, 128, 128] containing the difference between origY and recY
# here, origY corresponds to original input data 1430 and recY corresponds to reconstructed
input data 1432. oloss corresponds to the difference between the original input data 1430 and
the reconstructed input data 1432.
oloss = oloss.square( ).mean([2,3], true)+0.002
# we square and then calculate the average over the width and height of the difference image
# this creates a tensor of [64, 1, 1, 1], where 64 is # of training samples, 1 is a number of
channel 1, 1 is the height, and 1 is the width.
# Effectively, this step calculates a value for every one of the 64 examples in the minibatch,
and # this value is used to scale the loss
loss = torch.mean((((origY.detach( )-filteredY).square( )+0.002)/oloss), (1, 2, 3))
# here each example in the minibatch is divided by its respective oloss value
# alt: loss = torch.mean((((origY.detach( )-filteredY).square( ))/oloss), (1, 2, 3))
loss = torch.mean(loss)
# an average over all the weighted examples is obtained to get one scalar value.
optimizer.zero_grad( )
loss.backward( )
#The value 0.002 is used to avoid dividing by zero. It is added both to the numerator and the
denominator according to (a + 0.002) / (b + 0.002) − Equation (3)
The equation means that if both a (the loss between the filtered output and the original) and
b (the error between the reconstruction and the original) tend to be zero, then the result will
tend to be 1 rather than being undefined. In an alternate embodiment, a / (b + 0.002) can be
used instead.

The table below summarizes a method for training the NN filter 230 using normalized L1 in Pytorch.

filteredY = model(recY, predY, bsY, IPB, skip, QP)
oloss = origY.detach( ) − recY.detach( )
oloss = oloss.abs( ).mean([2, 3],True)+0.002
loss = torch.mean((((origY.detach( )-filteredY).abs( )+0.002)/oloss), (1, 2, 3))
# alternatively: loss = torch.mean((((origY.detach( )-filteredY).abs( ))/oloss), (1, 2, 3))
loss = torch.mean(loss)
optimizer.zero_grad( )
loss.backward( )
# Instead of using oloss = origY.detach( ) − recY.detach( ), it is also possible to use oloss =
origY.detach( ) − filteredY.detach( )
# This means that the error will always be equal to 1. However, the gradient of the error will
not be zero, since we have detached filtered before taking the difference. This is therefore an
alternative embodiment.

In some scenarios, the encoder 112 may change the QP value(s) the encoder 112 use to generate encoded video data. For example, in case the encoder 112 used QPᵥₐₗᵤₑ₁ to generate encoded video data, there may be a scenario where the encoder 112 may later subtract 5 from the QPᵥₐₗᵤₑ₁, thereby generating the QPᵥₐₗᵤₑ₂, and use the QPᵥₐₗᵤₑ₂ to generate encoded video data. Since the output of the NN filter 230 varies depending on a value of QP, depending on whether the QPᵥₐₗᵤₑ₁ or the QPᵥₐₗᵤₑ₂ is used as an input for the NN filter 230, the NN filter 230 would generate different output data. In practice therefore, the encoder can try both QPᵥₐₗᵤₑ₁ and QPᵥₐₗᵤₑ₂, choose the one that generates the smallest error and signal to the decoder what it chose. Therefore, it is desirable to train the NN filter 230 in a similar fashion; to run the forward pass of the NN for two QP values and backpropagate the error only for the QP value that generates the smallest error.

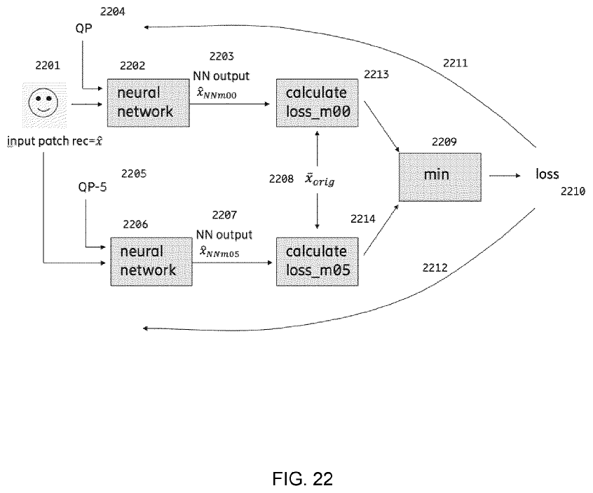

Accordingly, as shown in FIG. 22, according to some embodiments, a first loss value loss_m00 2213 is calculated using first input training data 2201 (e.g., reconstructed sample values (shown) provided to the NN filter 230 as well as other non-QP inputs such as pred, bs, IPB and skip (not shown)) associated with a first QP value 2204 and a second loss value is calculated using the same input training data 2201 (e.g., reconstructed sample values, pred, bs, IPB and skip provided to the NN filter 230) associated with a second QP value 2205. Note that the two instances 2202 and 2206 of the neural network obtains the same input training data 2201 generated based on the same original input training data 2208 (e.g., original sample values) for all inputs such as rec (shown), pred, bs, IPB and skip (not shown) except for the QP values 2204, 2205 which are different.

A comparison may be made between the first loss value 2213 and the second loss value 2214, and then the smaller one among the first loss value and the second loss value is used for backpropagation for training the NN filter 230. As an example, if the first loss value 2213 is smaller (better), the loss will be backpropagated via the upper path 2211, thereby only training the NN instance 2202. However, if the second loss value 2214 is instead smaller (better), then the loss will be backpropagated via the lower path 2212, thereby only training the NN instance 2206. By training the NN filter 230 using the smaller (better) loss value, the training of the NN filter 230 is more similar to how it is used in the encoder/decoder, where QP is sometimes subtracted by 5. It should be noted that more than two QP values can be used, for instance the three QP values QP, QP-5 and QP-10.

The above embodiments of training NN filter 230 using different QP values may be implemented in Pytorch as shown in the table below.

filteredY1 = model(QP1, recY, predY, bsY, IPB, skip)
QP2=QP1-5/63
# Note that since QP1=63 is represented by the value 1.0 in the neural network, it is needed
to subtract 5/63 from QP1 to go down 5QP steps.
filteredY2 = model(QP2, recY, predY, bsY, IPB, skip)
oloss = origY.detach( )-recY.detach( )
oloss = oloss.square( ).mean([2, 3],True)+0.002
loss_m00 = torch.mean((((origY.detach( )-filteredY).square( )+0.002)/oloss), (1, 2, 3))
loss_m05 = torch.mean((((origY.detach( )-filtered2).square( )+0.002)/oloss), (1, 2, 3))
# take the mean of all dimensions except the batch dimension
# Put each 64-long loss vector from each model into a 64x2 matrix
loss_m00_us = torch.unsqueeze(loss_m00, 1)
loss_m05_us = torch.unsqueeze(loss_m05, 1)
loss_matrix = torch.cat((loss_m00_us, loss_m05_us), 1)
# Calculate the smallest error for each sample in the minibatch
min_loss_values, min_loss_indices = torch.min(loss_matrix, 1)
# Calculate the average error over the minibatch
loss = torch.mean(min_loss_values)
optimizer.zero_grad( )
loss.backward( )

A minibatch (e.g., the first input training data 2201) should ideally include the same number of images from each resolution on average. This is due to the fact that it is desirable to train the resulting NN to be equally adept at compressing high resolution videos as low resolution videos. However, there may be a scenario where a training data set does not include the same number of images for each resolution. For example, the training data set may include 10000 pictures of resolution 1920×1080, 10000 pictures of resolution 960×540 and 10000 pictures of resolution 480×270, but may only include 5000 pictures of resolution 3840×2160.

In such scenario, according to some embodiments of this disclosure, in generating the minibatch, the 5000 pictures of resolution 3860×2160 are duplicated (used twice). Then when creating a minibatch of size 64, the following steps may be performed 64 times: (1) select a random picture among the 40000 pictures (herein after, “the first stage of random sampling”) and (2) then select a random 128×128 crop from the selected random picture (herein after, “the second stage of random sampling”). It should be noted that this first stage of random sampling can be achieved by listing all the pictures in a list and randomly shuffling that list before training every epoch.

This process will result in a minibatch consisting of a portion of pictures that have an equal probability to come from a group of pictures having any resolution. The goal here is training the NN filter 230 such that it is good at filtering data corresponding any resolution.

In some embodiments, it may be possible to improve the quality of the NN training by restricting the second stage of random sampling. As an example, assume that the first stage of random sampling resulted in a selection of an image of size 1920×1080, with width=1920 and height=1080. Then, in the second stage of random sampling, a 128×128 patch is selected completely randomly from this image. More specifically, the top left coordinate (xrand,yrand) of each 128×128 patch may be selected as follows:

$$yrand = int ( np . random . rand ( 1 ) * ( height - 127 ) )$$

$$xrand = int ( np . random . rand ( 1 ) * ( width - 127 ) )$$

where np.random.rand (1) is a python function that creates a random number between 0 and 1 (not including 1) and int (x) is a built-in python3 function that rounds down, i.e., int (0.9)=0 but int (1.0)=1.

This ensures that each 128×128 patch is located at a completely random position in a way such that no part of the 128×128 patch is outside the picture obtained in the first stage of random sampling. However, a video codec does not treat a picture the same in every picture position. As an example, the smallest block size in Versatile Video Coding (VVC) is 4×4, and thus the blocks of the smallest block size (or indeed the blocks of any block size) always start at positions with coordinates divisible by 4, such as (0, 4), (12,12) and (16,128), etc., but never at a position such as (3,7) (meaning that the x-coordinate of the top-left corner of each block always starts at 4×P0, where P0 is any integer, and the same goes for the y-coordinate). This in turn means that there can never be a block boundary between samples (1,3) and (2,3), whereas there can be a block boundary between samples (3,3) and (4,3).

In other words, the image statistics of different patch images located at different positions may differ based on their positions relative to a 4×4 grid because the encoder does not treat all sample positions in the same way. For example, a first 128×128 patch extracted from picture position x=256 to 384, y=256 to 384 (meaning that the top left corner of the patch is located at x=256, y=256) is different from a second 128×128 patch extracted from picture position x=257 to 385, y=256 to 384. More specifically, in the first patch, the most deblocked samples will be located at x-positions 0, 4, 8, 12, etc. while in the second patch, the most deblocked samples will be located at x-positions 1, 5, 9, 13, etc.

Furthermore, when an NN (e.g., NN filter 230) is later used to process the images, it will always be used in a fixed position relative to the 4×4 grid. For example, each Coding Tree Unit (CTU) can only be placed at a position with a coordinate that is divisible by 128 (e.g., such as (128,256) but never (73,14)). This means that in order for the NN to learn how to best treat such images, performing a complete random sampling in the second stage of random sampling may not necessarily be the best strategy. As an example, if the network is always used on data where samples at x-positions 0, 4, 8, 12, 16, . . . are the most deblocked (smoothed), it makes sense to train the network only on such data and not on data where the most deblocked samples sometimes reside at x-positions 1, 5, 9, 13, 17.

In a summary, because the input of the NN (e.g., NN filter 230) will likely be a patch of which the top-left corner is located at (4×a, 4×b), where a and b are integers, training the NN with a patch of which the top-left corner is not located at (4×a, 4×b) will not be optimal. Note that, in this disclosure, the unit of the location of each patch is in pixel, or sample position. Thus, if the top-left corner of a patch is expressed as being located at (8, 4), it means that the top-left corner of the patch is located at 8 pixels from the top side of the picture and 4 pixels from the left side of the picture.

Thus, according to some embodiments, the position of each patch (e.g., the top-left position) is set to be always divisible by four in both the x- and y-coordinate. This can be done by processing/updating the coordinates (xrand, yrand) obtained above as follows:

$$yrand = yrand / / 4$$

$$xrand = xrand / / 4$$

$$yrand = yrand * 4$$

$$xrand = xrand * 4$$

where//performs an integer division and * performs a multiplication.

As an example, if the sample position before is (17,131), after the integer division, it will be (4,32) and after multiplication by 4 again it will be (16,128). This ensures that there can never be a block boundary between, for instance, sample (0,0) in a patch and the neighboring (1,0). By “snapping” the cropping position to a grid of size 4×4 in this manner it is possible to get better training results, i.e., the compression efficiency of the trained filter will be higher, providing lower bit rate for the same quality.

It is also possible to snap not only to a grid of 4×4, but to a grid of 8×8 or some other constant. In general, one can use

$$yrand = yrand / / s$$

$$xrand = xrand / / s$$

$$yrand = yrand * s$$

$$xrand = xrand * s$$

where s is an integer, preferably a power of 2 such as s=2^{p} where p is an integer.

As an example, it is possible to restrict the sample position using s=128 so that the patch will always be taken from a fixed position in relation to the CTU grid (which in this case is 128×128). A downside, however, is that this severely restricts the number of training samples it is possible to get out of a training picture. As an example, with s=4, ((1920-128)/s)*(1080−128)/s)=106624 different 128×128 training patches can be obtained from a 1920×1080 picture. In contrast, with s=128, approximately only 100 training patches can be obtained from the same image. Severely restricting the number of training patches that can be extracted from the training set in this way may lead to overtraining and poor results. Thus, in some embodiments s is set to be 4, which gives a good result in terms of compression efficiency of the NN model after the NN model training.

In some embodiments, the quality of the NN training may further be improved by further restricting the second stage of random sampling using a different set of one or more restrictions. As an example, if the training set includes intra-coded pictures and/or the prediction of these intra-coded pictures, some parts of the images may have less ability to predict than other part.

As an example, for a Coding Unit (CU) that is located somewhere in the middle of the picture in both the x- and y-direction, the CU can be predicted both from the samples located above and from the samples located on the left side since these areas are previously encoded by the encoder. (No CU can typically be predicted from samples on the right side of the CU and/or the samples below the CU since these samples have not yet been coded.)

However, if the CU is at the very top of the picture, it is not possible to predict the CU from samples above the CU because there is no sample above the CU. Likewise, if the CU is located directly adjacent the left border of the picture, it is not possible to predict the CU from samples on the left side because there is no sample on the left side of the CU. Such blocks are non-typical and if such blocks are included in the training, they may disturb the training.

A particularly problematic case is the very top left CU. This CU, which starts at coordinate (0,0) in the image, cannot be predicted either from the top or from the left since those samples are outside the image. It can also not be predicted from the right or from below, since those samples belong to blocks that are not yet coded. Finally, it can also not be predicted from a previously coded picture in case no inter-prediction was used.

In many cases, this top left CU is predicted to have a predetermined value (e.g., 512 for 10-bit data (right in the middle of the representable interval of [0,1023])). But this means that some training patches will have a prediction component that is completely flat with a value of 512. Such “flat” training examples may harm the training process. Therefore, it may be desirable to reject such blocks during the training process. Thus, according to some embodiments, such blocks are rejected (i.e., not being used for the training process).

In VVC, the largest possible CU is 64×64 samples, and therefore there is a risk that the top left 64×64 samples of the prediction picture have the value 512. These top left samples can be rejected by performing the following process:

$$yrand = int ( np . random . rand ( 1 ) * ( height - 127 ) )$$

$$xrand = int ( np . random . rand ( 1 ) * ( width - 127 ) )$$

and then by repeatedly performing this process if any of the coordinates yrand or xrand are smaller than 64 as follows:

$$while ( ( yrand < 64 ) and ( xrand < 64 ) ) :$$

$$yrand = int ( np . random . rand ( 1 ) * ( height - 127 ) )$$

$$xrand = int ( np . random . rand ( 1 ) * ( width - 127 ) ) .$$

This type of sampling, which is called rejection sampling by rejecting non-allowed samples, will generate an even distribution over the allowed area.

In some embodiments, the following alternative process may be used:

$$yrand = int ( np . random . rand ( 1 ) * ( ( height - 64 ) - 127 ) ) + 64$$

$$xrand = int ( np . random . rand ( 1 ) * ( ( width - 64 ) - 127 ) ) + 64$$

The above process will result in rejecting all samples that are at the top or at the left edge of the picture.

In other embodiments, the following alternative process may be used:

$$yrand = int ( np . random . rand ( 1 ) * ( height - 127 ) )$$

$$if ( ( yrand < 64 ) ) :$$

$$xrand = int ( np . random . rand ( 1 ) * ( ( width - 64 ) - 127 ) ) + 64$$

$$else :$$

$$xrand = int ( np . random . rand ( 1 ) * ( width - 127 ) )$$

This will sample the same area as the first approach but will not generate an even distribution (i.e., an evenly spread random sampling) of the allowed area, since the x- and y-coordinates will be dependent of each other. In detail, positions in the area to the right of the top left 64×64 area, i.e., in the region where x and y obey 64≤x<1090 and 0≤y<64, will be selected more often than other positions in the rest of the allowed area, i.e., the region where 0≤x<1920 and 64≤y<1080.

In general, it is possible to reject the top left m by m area, where m is an integer. As described above, 64×64 is the largest area which can be completely flat. Completely rejecting the whole 64×64 area is the safest option but it may also be possible to choose the top left n×n area where n<64. This allows more positions to be sampled for the training patches. On the other hand, in some embodiments, m may be set to be larger than 64, as there might be processes that impact a larger area than 64×64. However, choosing a larger m means that the positions that can be sampled for the training patches are fewer.

In some embodiments, the two approaches, i.e., snapping to the 4×4 grid and rejecting the top left 64×64 area, can be combined. For example, the following process may be performed:

$$yrand = int ( np . random . rand ( 1 ) * ( height - 127 ) )$$

$$xrand = int ( np . random . rand ( 1 ) * ( width - 127 ) )$$

$$while ( ( yrand < 64 ) and ( xrand < 64 ) ) :$$

$$yrand = int ( np . random . rand ( 1 ) * ( height - 127 ) )$$

$$xrand = int ( np . random . rand ( 1 ) * ( width - 127 ) ) ,$$

as followed by the following process for snapping to a 4×4 grid:

$$yrand = yrand / / 4$$

$$xrand = xrand / / 4$$

$$yrand = yrand * 4$$

$$xrand = xrand * 4$$

Training a neural network consists of fetching a minibatch of training samples, running a forward pass of the network and then a backward pass of the network to calculate gradients. The weights of the network can then be updated using the gradient. In some cases, this training is executed by a unit that is not a central processing unit (CPU) (e.g., a graphic processing unit (GPU)). A common setup is to have the CPU create the minibatch, which is then passed to the GPU for training. In other cases, the GPU can do this kind of preprocessing. In both cases, however, data may need to be read from disk. One exception is if the entire data set can be fitted into Random Access Memory (RAM), either to the RAM of the CPU or the RAM of the GPU. However, often the datasets tend to be substantially bigger than the amount of data that can be saved in the RAM of even a high-performance server. This means that data loading from disk can become a bottleneck of the system. More specifically, it can take longer to load the data needed for a minibatch than it takes to train the minibatch, resulting in low utilization of the GPU and hence slow training.

Many software packages such as Pytorch have ways to ameliorate this problem. For instance, one CPU process can be used to load data from disk and create a minibatch while another CPU process can be used to transfer a previously created minibatch to the GPU and train it. If the neural network is of sufficiently high complexity, i.e., sufficiently many weights and layers, this may be sufficient to keep the GPU busy while the CPU is loading and preprocessing the data.

However, in video coding, the resulting neural network is going to be run in a decoder, often being invoked for every pixel of every picture, 60 pictures per seconds and more. This means that there is a push for such neural networks to be as low-complex as possible, to avoid consuming too much power in the end device which would make it hot and would deplete its battery. Therefore, when training neural networks that are to be used for video compression purposes, it is not always the case that the neural network is complex enough so that the training time of one minibatch is slower than the loading and preprocessing of the next minibatch.

How the data is stored on disk can also greatly affect the performance of the data loading. As described above, the first step of obtaining training samples is to select a random picture, and then select a random position within that picture, potentially with constraints such as avoiding the top left area or forcing position coordinates to be divisible by 4.

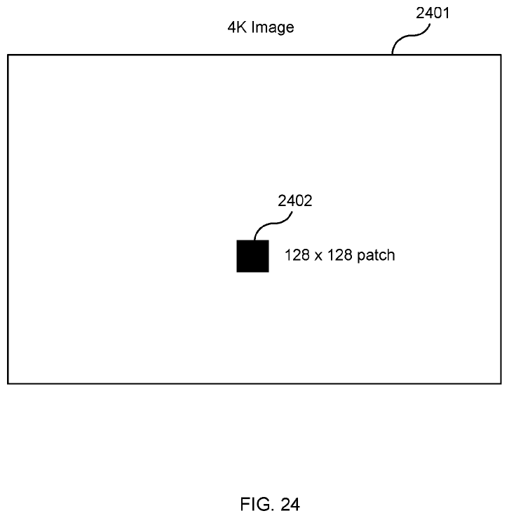

FIG. 24 illustrates the case where, in the first stage of random sampling, a picture 2401 of 4K resolution (3840×2160) is selected, and, in the second stage of random sampling, a 128×128 patch in the 4k picture is selected and placed into the minibatch. As can be seen in FIG. 24, the 128×128 patch 2402 makes up only a very small part of the full picture 2401. This means that if the picture 2401 is stored on disk in a compressed format such as in JPEG or PNG file, the preprocessing step needs to load the entire picture, decompress it, extract the 128×128 area 2402 from the whole picture and, then the rest of the picture will be thrown away. This means that only a small fraction, namely 128*128/(3840*2160)=0.00198=0.198% of the samples of the loaded picture is used for training. Using even higher resolution pictures makes the situation worse. This low yield makes it harder for the CPU to obtain the next minibatch within the time period it takes for the GPU to train the neural network.

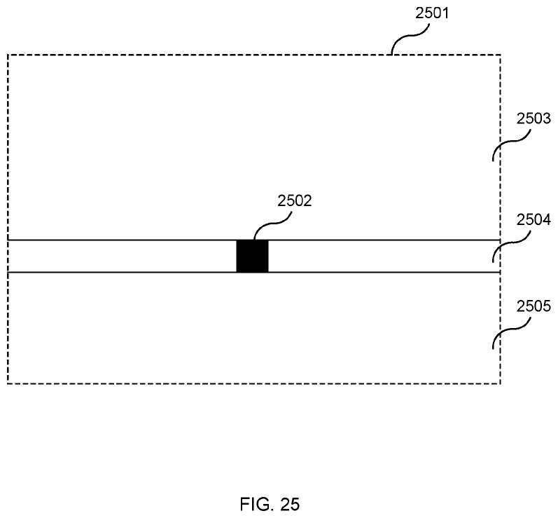

A different strategy that has been used in prior art is to store the pictures without compression on disk. As an example, the luminance values of a picture can be stored directly using 16-bit values rather than using an image format such as JPEG or PNG. This makes it possible to avoid reading a lot of data by calculating how many bytes into the file the reading should start. In C++ this may be done with the fseek( ) command. For instance, fseek (f1, 100, SEEK_SET) jumps over the 100 first bytes of the file f1 and thus starts the reading at byte with index 100, and fseek (f1, 100, SEEK_CUR) jumps over the next 100 bytes from the current file position. FIG. 25 illustrates a situation where bytes of a file are jumped over (or skipped) instead of reading the entire file. The picture 2501 of resolution 3840×2160 has been selected, and a patch 2502 of size 128×128 has been randomly selected at position x=2127, y=1196.

This means that if the picture is stored as 16-bit luminance values in a row-by-row fashion, the CPU can jump over the first 1196*3840*2 bytes corresponding to the region 2503 marked with a dashed outline. Furthermore, it can also jump over the next 2127*2 bytes corresponding to the samples before patch 2502 on the first line of region 2504. Hence it can jump over the first 1196*3840*2+2127*2 bytes. It can then read the first 128 samples of the patch by reading 128*2 bytes, jump over (3840-128)*2 bytes to get to the second line of the patch, read another 128*2 bytes for the second row and continue so until it has read all of the samples.

It may never need to read (or even jump over) samples belonging to the area 2505 since they are below the patch 2502. (In some circumstances, many pictures from a training sequence may be merged together. If so, the loading script may have to first jump over 3840*2160*2*(k−1) bytes in order to jump over the k−1 pictures before the one of interest (picture k), and then proceed as described above.)

At a glance, storing the data in uncompressed form and jumping over the stored data appears to solve the problem because it allows reading only the bytes actually belonging to the patch, and therefore the yield is 100%. Unfortunately, there are two problems with this approach. First, because the data is uncompressed, is the stored data will be between 2 times and 10 times larger than data compressed using PNG or JPEG. Second, disk systems are often very fast at moving lots of data if the number of reads is small and the amount of data read between jumps is large. However, if the situation is as is provided here (e.g., reading many small loads of 128*2 bytes between jumps), data transfer speeds may be rather slow. This means that this process may be much slower than the high yield of 100%. Indeed, this process may be slow enough that the CPU does not have time to prepare the next minibatch before the GPU finishes training the current one.

Furthermore, storing data uncompressed on disk can take up a lot of disk space. Given that neural network training data sets often need to be very large for good training outcomes, this can be a practical problem. Another problem is that the neural network may take more than one input. For example, in one application, the neural network input is the reconstructed image (recY), the predicted image (predY), and the boundary strength input (bsY). Additionally, for training, the original image (origY) may also be needed. If these data is stored as different pictures on the disk, then four different files would need to be opened in order to retrieve the data. Opening many different files can further slow down the data loading process.

This can be ameliorated by having everything in one file, starting with all the recY data (3840*2160*2 bytes) for the picture, followed by all the predY data (another 3840*2160*2 bytes), followed by bsY and origY. Such a structure is usually referred to as “planar.” Using a planar file means that only one file needs to be opened. However, that may not help much, since, for some file systems, reading a small part of a large file, skipping a lot of data to read another small part of the same file, etc. may not be a lot faster than if the data of the different datatypes was stored in different files.

Another way to store the data is to use “interleaved” data storage. In this type of data storage, the first sample of recY data (e.g., 2 bytes for position (0,0)) is followed immediately by the predY data for the same position (also 2 bytes), followed by the bsY data and then the origY data for that position. After that, the recY data for the next position (1,0) is stored followed by predY, bsY data, and the origY data. Thus, the data will be stored in the following sequence: recY data, predY data, bsY data, origY data for position (0,0), then recY data, predY data, bsY data, origY data for position (1,0), then recY data, predY data, bsY data, origY data for position (2,0), etc.

Referring back to FIG. 25, if data is stored in this “interleaved” manner, assuming that the patch is at position x=2127, y=1196, one can skip the first 1196*3840*4*2 bytes (corresponding to the area 2503), skip another 2127*2*4 to get to the first sample of the patch and read 128*2*4 to get the recY, predY, bsY and origY samples for the first line of the patch. This can be followed by skipping (3840−128)*2*4 to get to the starting position of the second line of the patch, and this process can be repeated for all lines of the patch. This way, only one picture file needs to be opened while getting all the necessary data. Also, each data loading action is now four times larger, and since reading fewer larger chunks is more efficient than reading a higher number of smaller chunks for the same amount of data, data throughput goes up. Under some circumstances it can be even advantageous to read the entire area 2504 containing the patch in one go and throw away data later, resulting in just one big read.

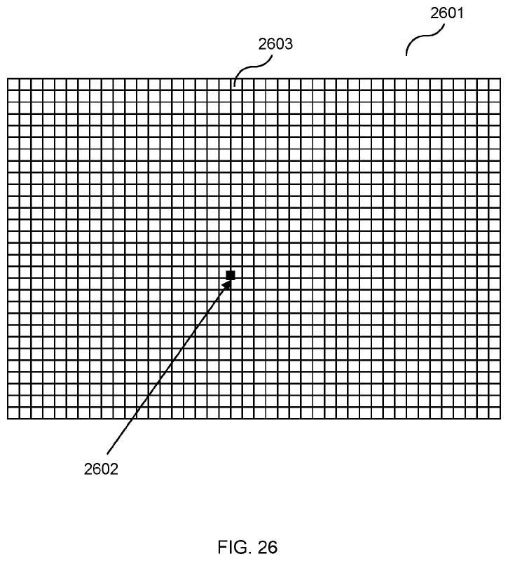

Another way to solve the aforementioned problem is to divide up the picture in patches from the start. This is illustrated in FIG. 26, where the picture 2601 has been divided into 128×128 patches 2603, wherein each patch is stored as a single file. Each file can now be compressed using, for instance, PNG. However, this creates another problem. As can be seen in the figure, a random position 2602 may not line up with the grid of available patches. This severely limits the number of training samples that can be used. As an example, with a completely random selection, there are (3840-128)*(2160-128)=7542784 possible training patches of size 128×128. However, if patches have to be one of the ones shown in FIG. 26, there are only ((3840−128)/128)*((2160−128)/128)=460 such patches. This is a substantial reduction in the available training data by 16384 times. This may mean that the training will experience overfitting to these patches before a good training result can be obtained.

Accordingly, in some embodiments of this disclosure, the process explained below is provided.

In order to allow samples located at a random position (e.g., such as 2602) to be used for training, in some embodiments, all of the four files that contain the samples from that patch are read. This allows obtaining samples at all 7 million positions, but at the cost of having to read four different files for every patch in the minibatch.

However, as explained above, disks are not very fast when accessing very many small files. Thus, reading four different files for every patch may prevent the CPU from preparing a minibatch in less time than it takes for the GPU to train one. Also, having a large number of files in a directory can give rise to performance problems of its own. As an example, on some Linux systems, the time it takes to perform a simple directory read such as ‘ls’ is orders of magnitude slower if the number of files in a directory goes above a certain limit. This too can prevent the CPU processing to be fast enough to serve the GPU with minibatch data.

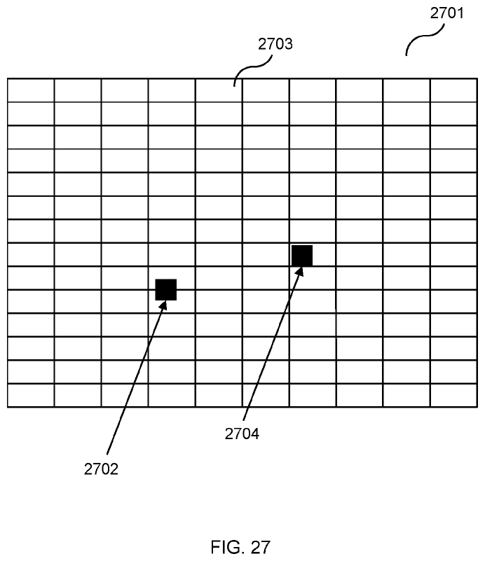

Accordingly, in other embodiments, as shown in FIG. 27, the picture 2701 is divided into datatiles 2703 that are bigger than the patch 2702 used for training, but still smaller than the entire picture 2701. As an example, in case a datatile has the size of 512×256, approximately (3840/512)*(2160/256)=63 datatiles would be included in the picture 2701, which is a lot fewer than the 460 files in the previous solution.

However, even if the picture 2701 is divided into datatiles 2703, there may be an issue if a patch (e.g., patch 2702) falls between the two adjacent datatiles. To prevent this issue, one strategy is to only allow patch positions that are entirely within one datatile (e.g., such as the patch 2704 which is within a datatile), but not allow patch positions that straddle one or more datatiles (e.g., such as the patch 2702). But this unfortunately lowers the number of allowed patches from U.S. Pat. No. 7,542,784 to around 63*(256-128)*(512-128)=3096576. Such a drop may lead to overtraining the neural network due to lack of data.

Another strategy to resolve the issue is to also allow straddling positions such as the position of the patch 2702, and load up to four datatiles to get all the samples corresponding to the patch 2702. This, however, may require too much data to load in order to keep the GPU busy. Therefore, according to some embodiments of this disclosure, the concept of overlapping datatiles is used.

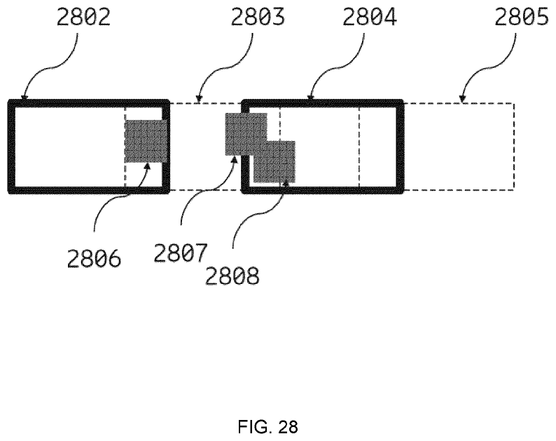

FIG. 28 shows an example where the datatiles are overlapping in the x-direction. The first datatile 2802, drawn with thick lines, has its top left coordinate at the picture coordinates (0,0) (not shown). The second datatile 2803, drawn with thin dashed lines, has its top left coordinate at the picture coordinate (384,0) (not shown) so that the overlapping area of the first datatile 2802 and the second datatile 2803 has the same width as the 128×128 patch 2806. The third datatile 2804, drawn again with thick lines, is situated at the picture coordinate (768,0), and the fourth datatile 2805 at the picture coordinate (1152), and so forth. This means that for every x-position, the overlapping area of the two adjacent datatiles will fully cover a width of one patch.

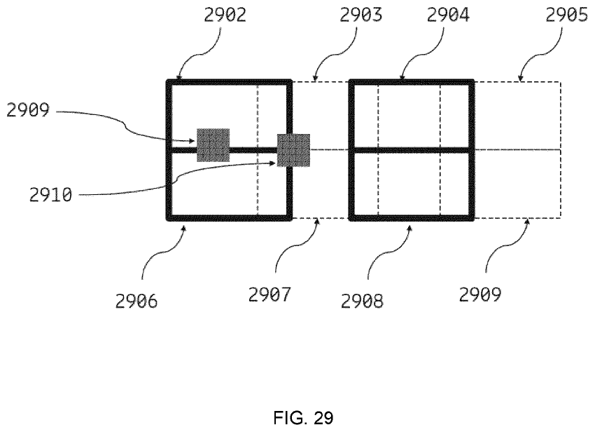

FIG. 29 shows the embodiment where the above-described concept of overlapping datatiles is applied only to the x-dimension (not to the y-dimension). As shown in FIG. 29, the datatiles 2906, 2907, 2908, and 2909, which are all of size 512×256 and start at (0, 256), (384, 256), (768, 256) and (1152,256) never overlap with the datatiles 2902, 2903, 2904 or 2905, which start at (0, 0), (384, 0), (768, 0) and (1152,0). This means that at most two datatiles need to be read in order to obtain a path at any position. As an example, patch 2909 can be obtained by fetching datatile 2902 and 2906, and patch 2910 can be obtained by fetching datatiles 2903 and 2907. This halves the number of patches that are needed to be fetched, which can be sufficient to make the data loading fast enough to keep up with the GPU.

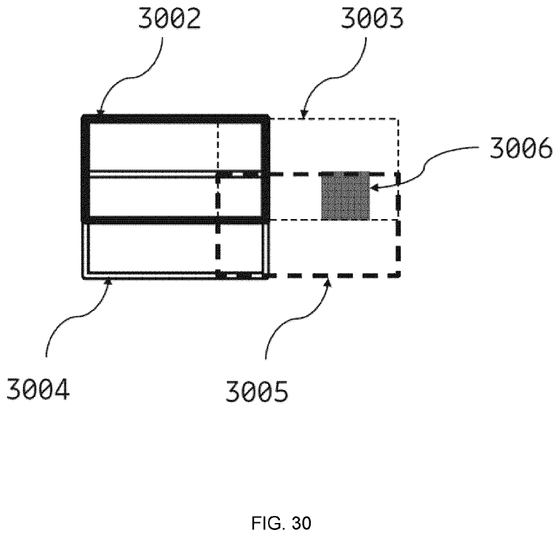

However, in some circumstances, even this may not be sufficient. Therefore, in other embodiments, datatiles overlap in both the x and y dimensions. This is illustrated in FIG. 30. In FIG. 3, the picture (not shown) is as previously divided into overlapping datatiles 3002, 3003, . . . in the x-direction that start at x-positions 0, 384, 2*384, . . . . However, the picture is also divided into datatiles that overlap in the y-dimension. As an example, datatile 3002, marked with thick solid lines, at position (0,0) overlaps with datatile 3004 starting at position (0, 128), marked with double lines. The overlapping area comprises 128 samples, which means that a patch 3006 will always be fully inside one of the two adjacent vertical patches. This means that wherever a patch 3006 is selected, there will always be one datatile that covers the entire patch.

FIGS. 27 through 30 show overlapping datatiles of size 512×256. But, it is possible to use datatiles of other sizes. As long as the overlapping area is as large as a patch, it is guaranteed that only one datatile needs to be read in order to obtain any patch at any position. In some scenarios, datatiles of size 512×512 can be preferrable to those of size 512×256. This is because the overlapping area in the y-dimension (128 samples) is smaller in relation to its height (512 samples), meaning that the overlapping area will not give rise to as many patches. This can save storage space on disk.

In the example of 512×512 datatiles overlapping 128 samples in both the x and the y dimensions, the following equation can be used to calculate the datatile number:

$$xTile = max ( 0 , ( patchXpos - 1 ) / / 384 )$$

$$yTile = max ( 0 , ( patchYpos - 1 ) / / 384 ) ,$$

where xTile is the position of the datatile in the x-direction and y Tile is the position of the datatile in the y-direction. The operator//is an integer division and max (a,b) returns the largest number of a and b. If tileSizeX×tileSizeY patches are used, the datatiles can be calculated using the general formula:

$$xTile = max ( 0 , ( patchXpos - 1 ) / / ( tileSizeX - patchSizeX )$$

$$yTile = max ( 0 , ( patchYpos - 1 ) / / ( tileSizeY - patchSizeY ) .$$

For example, if a datatile has a size of 512×256, tileSizeX=512, patchSizeX=128, tileSizeY=256, patchSizeY=128 may be used.

Given that the size of a datatile (as compared to the size of a picture) is relatively similar to the size of a patch, it is no longer crucial to jump over the samples that are not used. This means that it is now okay to compress the datatiles using image compression methods such as PNG or JPEG, or general compression methods such as ZIP.

However, when training neural networks for video compression, it is often not advisable to use training data that has been lossily compressed, i.e., data of which the decompressed version is not exactly the same as the original. The reason is that this can interfere with the video compression that the neural network should carry out. Thus, in some scenarios, lossy compression methods such as JPEG may not be a preferred option.

On the other hand, since PNG is lossless and can be used for 16-bit data, it is a good compression method to use for compressing data corresponding to the datatiles. PNG often manages to compress data by a factor of 2-3, meaning that the compressed file is ½ to ⅓ of the size of the uncompressed data. This greatly helps the data loading performance. For example, in case a datatile has a size of 512×512 and a patch size is 128×128, only 6.25% of the data that is loaded is actually used. However, if this data is compressed by a factor of three, the utilization factor goes up to 18.75% as compared to the situation where uncompressed data is used. If only one type of data is stored (such as recY), it is possible to use luminance-only PNG images to store the datatiles.

When more than one type of data (e.g., recY, predY, bsY and origY) is needed for training the neural network (e.g., NN filter 230), it needs to be decided how they are stored inside the datatile. One way is to just use interleaved data (e.g., recY, predY, bsY and origY for the first sample position, followed by recY, predY, bsY and origY for the second position, etc.). This can be done by compressing the luminance PNG image 4 times wider and storing four samples (e.g., recY, predY, bsY and origY) for every regular sample. However, codecs such as PNG are not well suited to compress such data. This is due to the fact that PNG assumes that the sample next to the current sample is often very similar to the current sample. But this is true if only the same type of samples (e.g., predY samples) are stored. However, if the sample next to the current sample (e.g., predY samples) is a bsY sample, the prediction carried out by PNG fails and the compression performance may become so bad that no gain will be obtained (as compared to just storing the data uncompressed).

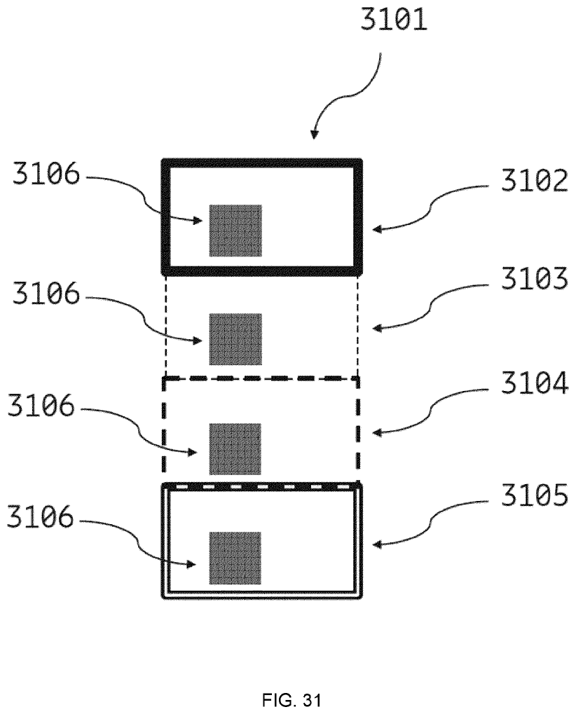

Accordingly, in some embodiments, the information corresponding to the datatiles can be stored in planar mode. As an example, it is possible to use an image that is four times as high as the original datatile, as shown in FIG. 31. More specifically, in case a datatile has the size of 512×256, is the image can be represented by a PNG picture of size 512×1024 (3101). The top 512×256 samples 3102 are occupied by the recY samples, the 512×256 samples 3103 immediately below the samples 3102 are occupied by predY samples, the next 512×256 samples are occupied by bsY samples (3104), and the bottom 512×256 samples are occupied by origY samples (3105). After loading the PNG file 3101 and decompressing it, the patch 3106 is extracted from all four parts.

Stacking training data of different kinds (such as recY, predY, bsY and origY) in the same image may deteriorate compression performance of PNG compared to the situation when only one type of data (e.g., bsY) is present in a given datatile. However, given that the switching between data (e.g., between recY 3102 and predY 3103) happens relatively few times and not every sample, the PNG compression performance is still good enough to provide a good amount of lossless compression.

However, in some cases, not all of the data comes in full resolution. For example, chrominance data (Cb and Cr for instance, or U and V) are often processed by the neural network alongside luminance data (Y), and in this case, the chrominance data is often at a different resolution than the luminance data. As an example, a common case is that the luminance data Y is at a full resolution (128×128 samples) while the chrominance data U and V are at a half resolution in both the x and y direction (64×64 samples).

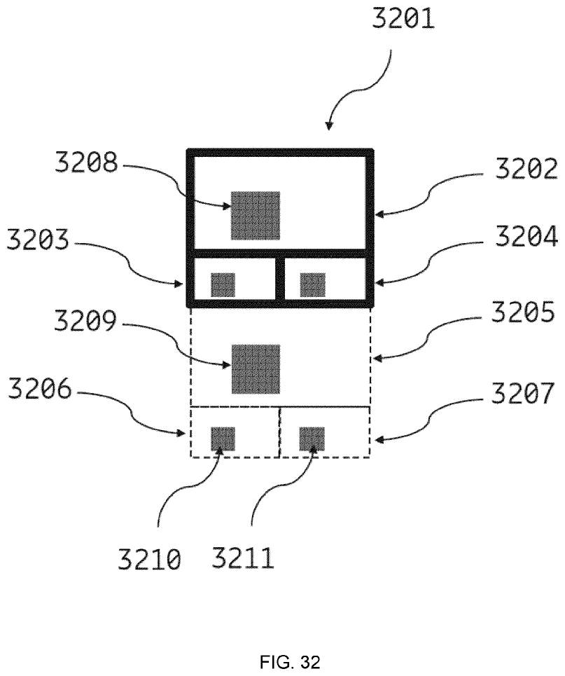

In this case, it is not desirable to stack the data on top of each other as shown in FIG. 31, since this will not form a rectangle that can be compressed by PNG. In these cases, it is possible to compose the data according to FIG. 32. In the embodiment shown in FIG. 32, only two data types are used for simplicity; rec and orig. However, all three color components Y, U and V are stored in the datatile—Y with at a full resolution, and U and V each at a half of the resolution in both x and y dimensions.

This means that the recY part 3202 of the datatile will be of resolution 512×256, which may be placed at the top of the PNG image 3201 representing the datatile. The recU part 3203 will be of resolution 256×128 and may be placed directly under the recY part. Immediately to its right, it is possible to place the recV part 3204. This means that recY, recU and recV forms a 512×384 rectangular block. The same can be repeated for origY (3205), origU (3206) and origV (3207), and this rectangular block can be placed immediately under the previous one (shown) or, alternatively, to the right of it (not shown).

After having loaded and decompressed the PNG image 3201, the training script may extract recY (3208), recU, recV, origY (3209), origU (3210) and origV (3211). It should be noted that PNG is just an example and other compression methods may also be used. If more inputs, such as bsY, bsU, and bsV are needed, they may be stored in a similar fashion. For example, they may be stored underneath the origY block shown in FIG. 32.

If the number of inputs is not prime, it is possible to store them in two dimensions. As an example, if six datatypes are stored, it is possible to store the corresponding blocks in 2 rows of 3 blocks, since 6=3*2. In some circumstances, it may not be possible to combine the inputs into a rectangular image. As an example, it is not straightforward to add the input QP to the data shown in FIG. 32 since the QP is just a scalar value and thus only requires one sample. In other words, it is not possible to add a single sample to the image 3201 in FIG. 32, and get another rectangular shape.

Thus, in some embodiments, padding may be used to add a single sample. More specifically, in one example, a last line of (512×1) values may be added directly underneath 3210 and 3211, and within the added values, the first value among the added values corresponds to the QP, and the rest of the values (e.g., 511 values among the 512 values added) will be filled with zero or some value that will make the PNG compress well (e.g., the value above in 3210 and 3211). The resulting image will be of size 512×769, which is square and thus compressible using PNG.

By storing the data in overlapping datatiles, and by storing more than one datatype (recY, predY, etc.) in each datatile, it is possible to do a single file load per entry in the minibatch.

Selecting the size of the datatile is a trade-off. If the datatile is too small, such as 256×256 for a patch size of 128×128, then many datatiles need to be stored on disk and the total disk space used becomes very big-four times as big as compared to when no overlapping is used. On the other hand, if the datatile is too big, such as 2048×2048, then the disk space can be saved, but loading an individual datatile may be too slow that enough data cannot be loaded in time to keep the GPU busy. The ideal size (e.g., 512×512) of the datatile may vary depending on different disk read speeds, model complexities, GPU speeds, etc.

In order to make sure not to have to read more than one datatile, it is important that the overlapping area between the datatiles in each dimension is not smaller than the dimension of the patch. For example, in case a datatile size is 512×512 and a patch size is 128×128, the size of the overlapping area has to be 128 samples in both directions, and there should be a new patch at every (512−128)=384 samples.

However, sometimes it is desirable to increase the patch size without changing the datatiles stored on disk. This can be due to the fact that more than one training is using the same dataset and there may not be sufficient disk space to have two different tilings of the same data set fit on the disk. Another is that it takes time to extract these tilings, and it may be desirable to start the training without having to wait for this tiling to take place. In those circumstances it may be desirable to use the tiling that already exists on disk, even though the overlap is not sufficient.

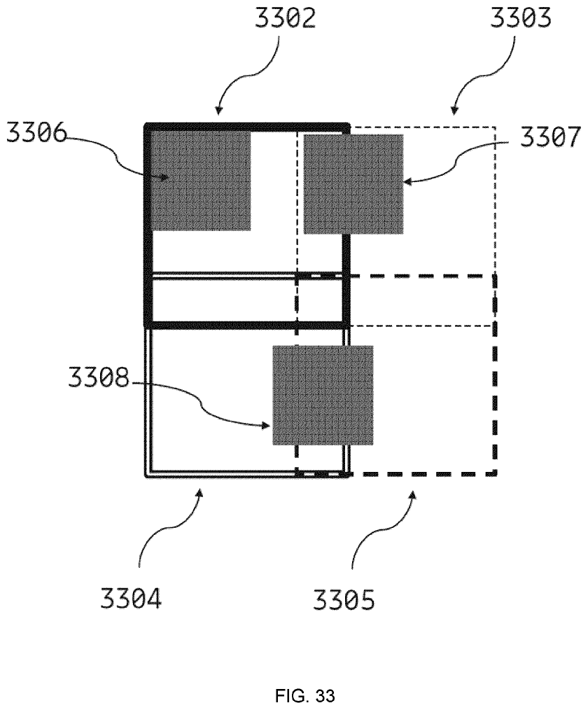

As an example, in case a tiling is created using 512×512 datatiles with an overlap of 128×128, just one datatile needs to be read for every entry of the minibatch if the patch size is 128×128. However, now assume that there is a need to test train the neural network with patches of size 256×256. As can be seen in FIG. 33, it is still possible in many cases to obtain the entire 256×256 patch by just reading one datatile. More specifically, if the patch 3306 is positioned as shown in FIG. 33, all of it lies within the 512×512 datatile 3302. Also, if the patch 3307 is positioned as shown in FIG. 33, it is again possible to obtain all of the data by reading datatile 3303. However, if the patch 3308 is positioned as shown in FIG. 33, it is not possible to get the all the data of the patch 3308 with just one datatile read. More specifically, if the datatile 3304 is selected, the right most part of the patch 3308 is not obtained, whereas if datatile 3305 is instead loaded, the left most part of the patch 3308 is not obtained.

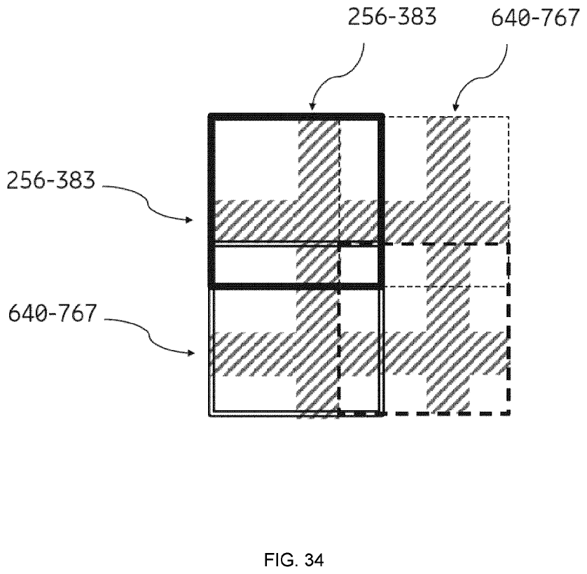

One way to get around this problem is to simply avoid loading data from positions where it is not possible to read all the data from just one datatile. That can be done by avoiding reading from the areas marked with a hatch-pattern shown in FIG. 34.

This means sticking to the top 256×256 region of every datatile. As can be seen in the figure, this forbids patches with x-positions from 256 to 383, 640 through 767, etc. In general, x and y-positions 256+k*384 through 383+k*384 must be avoided. This means that only (256×256)/384×384=44.44% of the training data can be utilized. However, this may be sufficient in some circumstances.

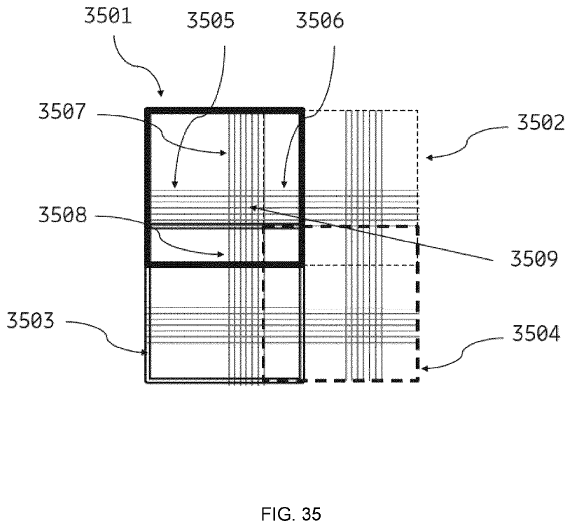

If it is desirable to exploit a bigger proportion of the training data, more than one datatile may be loaded. With reference to FIG. 35, if a patch starts in the area 3507 marked with vertical stripes, it is possible to load datatile 3501 and datatile 3502, and get all the data needed. Likewise, if the patch starts in the area 3508, also marked with vertical stripes, the two datatiles 3503 and 3504 are sufficient to obtain the patch 3508.

Similarly, the area 3505, marked with horizontal stripes, needs the two datatiles 3501 and 3503, and the area 3506, also marked with horizontal stripes, needs the two datatiles 3502 and 3504. Only the area 3059, marked with both horizontal and vertical stripes, would need four datatiles, namely 3501, 3502, 3503 and 3504. Thus, in one embodiment, it is possible to exclude patches with top left coordinates in the 3509 area, and be guaranteed that no more than two datatiles need to be loaded.

In other embodiments, it is possible to include the area 3509 too, thus utilizing 100% of the training data, while needing to load up to four datatiles. Since random sampling in an area needing four datatile loads only happens (128*128)/(384*384)=11% of the time, it may be possible to still have time to load the entire minibatch before the GPU is finished with the previous one.

In some embodiments, the training of the NN filter 230 may be optimized based on the level of temporal layer to which input training data corresponds. Typically, a video codec uses several temporal layers. The lowest temporal layer, layer 0, typically includes only pictures that are intra-coded, and therefore are not predicted from other pictures. The next layer, layer 1, is only predicted from layer 0. The layer after layer 1, layer 2, is only predicted from layer 0 and layer 1. Finally, the pictures belonging to the highest temporal layer can be predicted from pictures belonging to all other layers, but there is no picture that is predicted from a picture in the highest layer.

Since pictures in the highest layer are never used for prediction, they are typically compressed more, i.e., with a higher QP, since the bits spent there will only benefit a single image. Therefore, the error in these pictures is often higher than the errors in other pictures. Since the neural network in the NN filter 230 tries to minimize the error, it will put a lot of attention on these pictures from the highest layer. But because the pictures in the highest layer are not used for any prediction, less attention should be given to these pictures. Therefore, according to some embodiments of this disclosure, less weights (e.g., 0) are given to the pictures coming from the highest temporal layer.

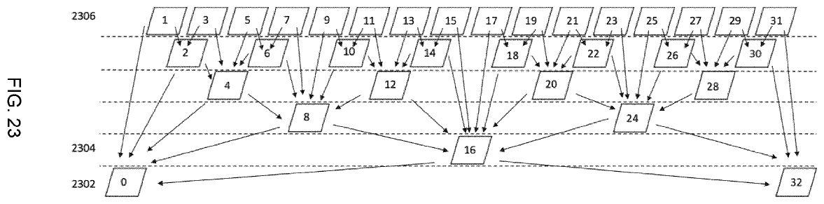

For example, in FIG. 23, there are three temporal layers 2302, 2304, and 2306. The first temporal layer 2302 is the lowest (meaning that the temporal layer 2302 only includes pictures that are intra-predicted), the second temporal layer 2304 includes pictures that are predicted from the pictures in the temporal layer 2302, and the temporal layer 2302 includes pictures that are predicted from the pictures in the temporal layer 2302 and the pictures in the temporal layer 2304. The third temporal layer 2306 is the highest (meaning that the pictures included in the temporal layer 2306 is not used for any prediction).

The pictures included in the first temporal layer 2302 is converted into first input training data and provided to the ML filter 230, thereby generating first output training data. The ML filter 230 may generate a loss value based on a difference between the first output training data and the picture data corresponding to the pictures included in the first temporal layer 2302.

The pictures included in the second temporal layer 2304 is converted into second input training data and provided to the ML filter 230, thereby generating second output training data. The ML filter 230 may generate a loss value based on a difference between the second output training data and the picture data corresponding to the pictures included in the second temporal layer 2304.

The pictures included in the third temporal layer 2306 is converted into third input training data and provided to the ML filter 230, thereby generating third output training data. The ML filter 230 may generate a loss value based on a difference between the third output training data and the picture data corresponding to the pictures included in the third temporal layer 2306.

As discussed above, less weight should be given to the highest temporal layer while more weight should be given to the lowest temporal layer. Thus, according to some embodiments, a first weight (e.g., 0) that is lower than a second weight and a third weight may be applied to the loss value corresponding to difference between the third output training data and the picture data corresponding to the pictures included in the third temporal layer 2306. Similarly, the second weight that is lower than the third weight may be applied to the loss value corresponding to the difference between the second output training data and the picture data corresponding to the pictures included in the second temporal layer 2304. Lastly, the third weight that is higher than any of the first and second weights is applied to the loss value corresponding to the difference between the first output training data and the picture data corresponding to the pictures included in the first temporal layer 2302. Alternatively, only the first weight (e.g., 0) corresponding to the highest temporal layer 2306 has a weight different from the other layers, which may have the same weight (e.g., 1). It should be noted that setting the weight to zero is equivalent to just removing the corresponding training examples from the training set altogether. That means that not computation is spent calculating gradients from such examples, saving time. Therefore, in a special case of the embodiments of this disclosure, we exclude examples from the top temporal layer (i.e., we exclude all odd frames in FIG. 23) from the training set.

In some embodiments, the error (i.e., the loss value) associated with a block may be scaled based on one or more block statistics (e.g., the variance) of reconstructed samples, predicted samples, or residual samples. For example, a block with a high variance may mean that the block contains a full of details, and thus it may be desirable to train the NN filter 230 by putting more emphasis on this block. Therefore, in some embodiments, a weight (that may be based on the block statistic(s) such as the variance) may be added to the error of this block. The downside of this embodiment is that not all blocks with high variances are important since noisy blocks could also have high variances but the details may not be as meaningful.

In some embodiments, explicit QP scaling to the loss function may be performed. For example, desired error scaling weights may be computed through a non-linear function f (.) and the filtering errors may be scaled by using the weight corresponding to the QP used in the training sample. This can create an arbitrary distribution of weights in the importance mask to better handle the priority of filtering with respect to different QPs.

In some embodiments, the output of the NN filter 230 is not used as it is during encoding/decoding of a video sequence. But instead, the output may be blended with reconstructed sample data as illustrated in the equation below.

$$out = rec + λ * ( nn - rec )$$

where “out” is the adjusted output of the NN filter 230, “rec” is the reconstructed sample data, and “nn” is the unadjusted output of the NN filter 230.

For ease of further mathematical description, the variable names may be used in the equation above, thereby resulting in the following equation:

$$\hat{y} = \hat{x} + λ * ( {\hat{x}}_{NN} - \hat{x} )$$

where ANN is the unadjusted output of the NN filter 230, \hat{x} is the reconstructed sample data, λ is a value between 0 and 1 (in some cases, it may be greater than 1), and ŷ is the adjusted output of the NN filter 230.

In some embodiments, the output of the NN filter 230 may be blended with deblocked sample data (instead of reconstructed sample data). In such embodiments, the adjusted output of the NN filter 230 may be obtained by:

$$\hat{y} = {\hat{x}}_{DBL} + λ * ( {\hat{x}}_{NN} - {\hat{x}}_{DBL} )$$

where \hat{x}_{DBL} is the output of the deblocking filter.

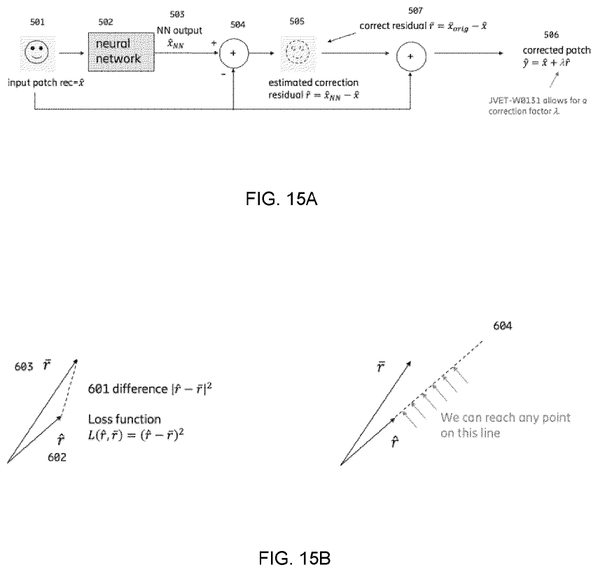

FIG. 15A shows a block diagram for generating the adjusted output of the NN filter 230 according to some embodiments.

In FIG. 15A, reconstructed block input data is denoted by \hat{x} (501). The reconstructed block input data \hat{x} is fed into the neural network (NN) (502) (e.g., the NN filter 230 or one or more layers included in the NN filter 230). Other inputs such as pred and bs may also be fed but they are not shown in the figure for simplicity.

The NN generates an output (503) denoted \hat{x}_{NN}. In the decoder, the reconstructed block input data \hat{x} is then subtracted (504) from the \hat{x}_{NN} output ANN to produce an estimated correction residual r=\hat{x}_{NN}−\hat{x} (505). The decoder can then add all or a fraction of that correction residual to the reconstructed block \hat{x} to create the final output ŷ=\hat{x}+λ*(\hat{x}_{NN}−\hat{x}) (506). The encoder can now signal the use of more or less of the NN correction by adjusting λ.

It is also possible to calculate the correct residual r̅ (507), which is the residual that would bring the reconstructed block input data \hat{x} to be equal to the original (target) image x̅_{orig}. It is calculated as r̅=x̅_{orig}−\hat{x}. It is possible to train the NN by calculating r̅ and using r̅ as the target, for instance using an L2 loss function such as:

$${loss}_{L 2} = {( \hat{r} - \overline{r} )}^{2}$$

But that is equivalent to just training x̅_{NN} with x̅_{orig} as the target, since

$${loss}_{L 2} = {( \hat{r} - \overline{r} )}^{2} = {( ( {\hat{x}}_{NN} - \hat{x} ) - ( {\overline{x}}_{orig} - \hat{x} ) )}^{2} = {( {\hat{x}}_{NN} - {\overline{x}}_{orig} )}^{2}$$

However, using \hat{r} and r̅ instead of \hat{x}_{NN} and x̅_{orig} gives an opportunity to do better than the regular L2 loss function. As seen above, minimizing L2 is the same as minimizing the distance between \hat{r} and r. This loss function can be seen as minimizing the distance |\hat{r}−r̅|² (601) between the two vectors \hat{r} (602) and r̅ (603) in FIG. 15B.

However, due to the fact that the encoder and decoder can scale the residual \hat{r} using λ, any point can be reached on the line (604). As can be seen in FIG. 15B, there is a much shorter distance to r̅ for some points on this line.

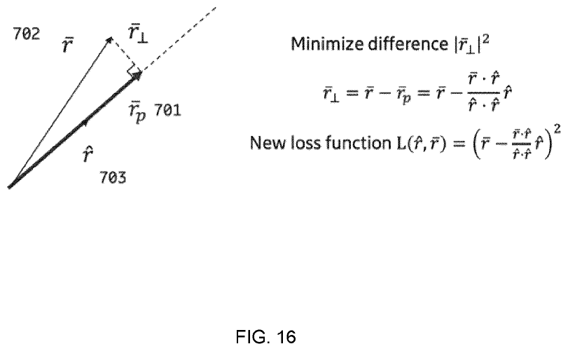

Thus, as shown in FIG. 16, instead of minimizing the distance |\hat{r}−r̅|² (601), the difference |r̅_{⊥}|² may be minimized (which is the smallest distance that can be obtained via moving on the line radiating from \hat{r}). r̅_{⊥} can be calculated as the difference between r̅_{⊥}=r̅−r̅ₚ where r̅ₚ (701) is the vector r̅ (702) projected onto vector \hat{r} (703). This vector r̅ₚ (701) can easily be calculated using the projection formula:

$${\overline{r}}_{p} = \frac{\overline{r} \cdot \hat{r}}{\hat{r} \cdot \hat{r}} \hat{r}$$

Then a new loss function loss_{L2proj} which can be written as:

$${loss}_{L 2 proj} = {( \frac{\overline{r} \cdot \hat{r}}{\hat{r} \cdot \hat{r}} \hat{r} - \overline{r} )}^{2}$$

This new loss function allows the training procedure to take into account the fact that the encoder and the decoder may later change λ in order to get closer to the best possible residual r̅.

Likewise, the projective loss for the L1 norm can be written as:

$${loss}_{L 1 proj} = \vert \frac{\overline{r} \cdot \hat{r}}{\hat{r} \cdot \hat{r}} \hat{r} - \overline{r} \vert$$

The table below summarizes a method using the new loss function:

```
filteredY = model(qp=QP, rec=recY, input=predY, input0=partY, input1=bsY)
loss = loss_fn(filteredY, origY)
loss.backward( )
# where loss_fn is the built-in Pytorch function nn.MSELoss( ) for L2 loss or the Pytorch
function nn.L1Loss( ) for L1 loss. one can use a L2 projective loss function using
filteredY = model(qp=QP, rec=recY, input=predY, input0=partY, input1=bsY)
r_bar = origY-recY
r_hat = filteredY-recY
loss = loss_fn(r_hat, r_bar)
loss.backward( )
# where loss_fun is set equal to only_projection_loss which is defined as
def only_projection_loss(output, target):
  r_bar = target
  r_hat = output
  proj_numerator = torch.sum(torch.mul(r_bar,r_hat), (1, 2, 3))+0.4
  proj_denominator = torch.sum(torch.mul(r_hat, r_hat), (1, 2, 3))+0.4
  my_lambda=torch.unsqueeze(torch.unsqueeze(torch.unsqueeze(torch.div(proj_num
erat, proj_denominator), 1),1),1)
  my_diff = torch.mul(my_lambda, output) − target
  loss = torch.mean((my_diff)**2)
  return loss
# Here, 0.4 is a constant to avoid division by zero.
```

It is also possible to adapt the projective loss function to the case where we blend the output of the neural network with the deblocked block instead of blending with the reconstructed block.

$$\hat{y} = {\hat{x}}_{DBL} + λ ( {\hat{x}}_{NN} - {\hat{x}}_{DBL} )$$

In this case, the estimated correction residual is instead calculated as:

$$\hat{r} = {\hat{x}}_{NN} - {\hat{x}}_{DBL}$$

And the correct residual is calculated as:

$$\overline{r} = {\overline{x}}_{orig} - {\hat{x}}_{DBL}$$

And then the same equation can be used to calculate the loss from \hat{r} and r̅.

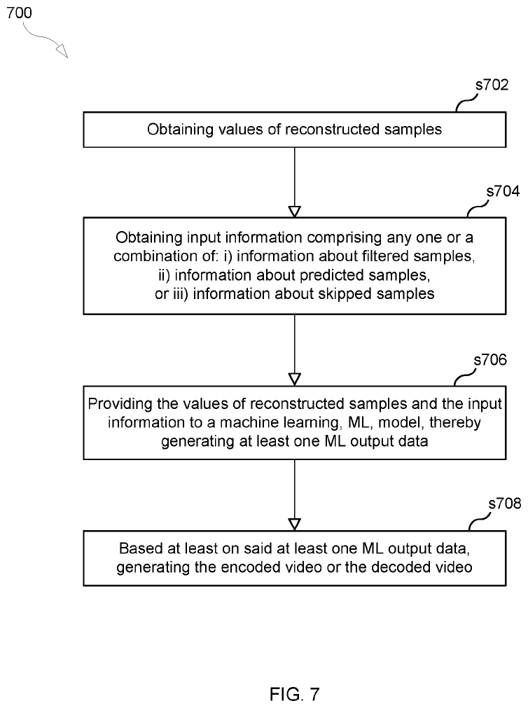

FIG. 7 shows a process 700 for generating an encoded video or a decoded video. The process 700 may begin with step s702. Step s702 comprises obtaining values of reconstructed samples. Step s704 comprises obtaining input information comprising any one or a combination of: i) information about filtered samples, ii) information about predicted samples, or iii) information about skipped samples. Step s706 comprises providing the values of reconstructed samples and the input information to a machine learning, ML, model, thereby generating at least one ML output data. Step s708 comprises, based at least on said at least one ML output data, generating the encoded video or the decoded video.

In some embodiments, the ML model comprises a first pair of models and a second pair of models, the first pair of models comprises a first convolution neural network, CNN, and a first parametric rectified linear unit, PRELU, coupled to the first CNN, the second pair of models comprises a second CNN and a second PRELU coupled to the second CNN, the values of the reconstructed samples are provided to the first CNN, and the input information is provided to the second CNN.

In some embodiments, the method further comprises: obtaining values of predicted samples; obtaining block boundary strength information, BBS, indicating strength of filtering applied to a boundary of samples; obtaining quantization parameters, QPs; providing the values of the predicted samples to the ML model, thereby generating at least first ML output data; providing the BBS information to the ML model, thereby generating at least second ML output data; providing the QPs to the ML model, thereby generating at least third ML output data; and combining said at least one ML output data, said at least ML output data, said at least second ML output data, and said at least third ML output data, thereby generating combined ML output data, and the encoded video or the decoded video is generated based at least on the combined ML output data.

In some embodiments, the information about filtered samples comprises values of deblocked samples.

In some embodiments, the information about prediction indicates a prediction mode, and the prediction mode comprises an intra-prediction, a uni-direction inter-prediction, and a bi-direction inter-prediction.

In some embodiments, the information about prediction indicates a number of motion vectors used for prediction.

In some embodiments, the information about skipped samples indicates whether samples belong to a block that did not go through a process processing residual samples, and the process comprises inverse quantization and inverse transformation.

In some embodiments, the method further comprises concatenating the values of reconstructed samples and the input information, thereby generating concatenated ML input data, wherein the concatenated ML input data are provided to the ML model.

In some embodiments, the ML model comprises a first pair of models and a second pair of models, the first pair of models comprises a first convolution neural network, CNN, and a first parametric rectified linear unit, PRELU, coupled to the first CNN, the second pair of models comprises a second CNN and a second PRELU coupled to the second CNN, the first CNN is configured to perform downsampling, and the second CNN is configured to perform upsampling.

In some embodiments, the ML model comprises a convolution neural network, CNN, the CNN is configured to convert the concatenated ML input data into N ML output data, and N is the number of kernel filters included in the CNN.

In some embodiments, the input information comprises the information about predicted samples. The method further comprises: obtaining partition information indicating how samples are partitioned; and providing the partition information to the ML model, thereby generating fourth ML output data. The combined ML output data is generated based on combining said at least one ML output data, the first ML output data, the second ML output data, the third ML output data, and the fourth ML output data.

In some embodiments, the values of the reconstructed samples include values of luma components of the reconstructed samples and values of chroma components of the reconstructed samples, the values of the predicted samples include values of luma components of the predicted samples and values of chroma components of the predicted samples, and the BBS information indicates strength of filtering applied to a boundary of luma components of samples and strength of filtering applied to a boundary of chroma components of samples.

In some embodiments, the method further comprises obtaining first partition information indicating how luma components of samples are partitioned; obtaining second partition information indicating how chroma components of samples are partitioned; providing the first partition information to the ML model, thereby generating fourth ML output data; and providing the second partition information to the ML model, thereby generating fifth ML output data, wherein the input information comprises the information about predicted samples, and the combined ML output data is generated based on combining said at least one ML output data, the first ML output data, the second ML output data, the third ML output data, the fourth ML output data, and the fifth ML output data.

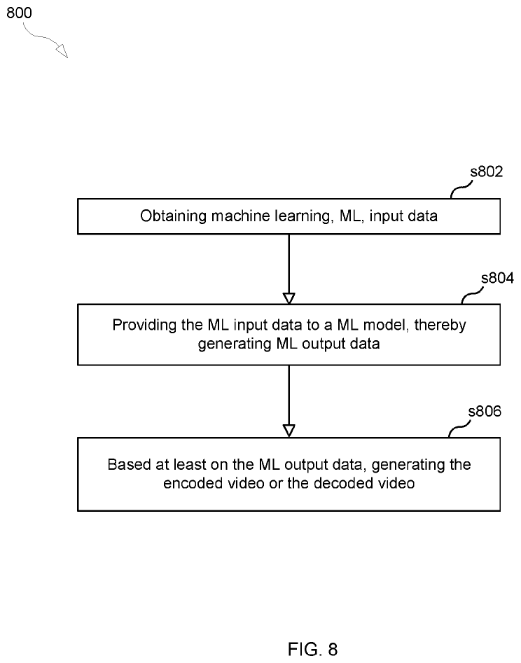

FIG. 8 shows a process 800 for generating an encoded video or a decoded video. The process 800 may begin with step s802. Step s802 comprises obtaining machine learning, ML, input data, wherein the ML input data comprises: i) values of reconstructed samples; ii) values of predicted samples; iii) block boundary strength, BBS, information indicating strength of a filtering applied to a boundary of samples; and iv) quantization parameters, QP. Step s804 comprises providing the ML input data to a ML model, thereby generating ML output data. Step s806 comprises, based at least on the ML output data, generating the encoded video or the decoded video. The ML input data does not include partition information indicating how a luma picture is partitioned into coding tree units, CTUs, and how luma CTUs are partitioned into coding units, CUs.

In some embodiments, the ML model consists of a first pair of models, a second pair of models, a third pair of models, and a fourth pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the values of the reconstructed samples are provided to the first CNN, the values of predicted samples are provided to the second CNN, the BBS information is provided to the third CNN, and the QPs are provided to the fourth CNN.

In some embodiments, the values of reconstructed samples comprise values of luma components of the reconstructed samples and chroma components of the reconstructed samples, the ML model consists of a first pair of models, a second pair of models, a third pair of models, a fourth pair of models, and a fifth pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the fifth pair of models comprises a fifth CNN and a fifth PRELU coupled to the fifth CNN, the values of the luma components of the reconstructed samples are provided to the first CNN, the values of the chroma components of the reconstructed samples are provided to the second CNN, the values of predicted samples are provided to the third CNN, the BBS information is provided to the fourth CNN, and the QPs are provided to the fifth CNN.

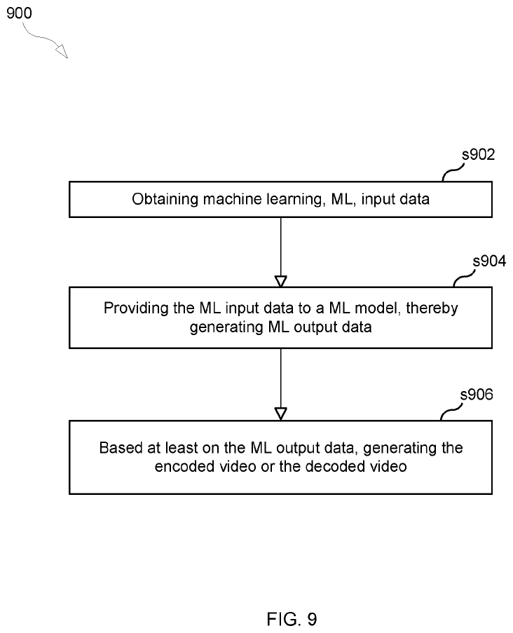

FIG. 9 shows a process 900 for generating an encoded video or a decoded video. The process 900 may begin with step s902. Step s902 comprises obtaining machine learning, ML, input data, wherein the ML input data comprises: i) values of reconstructed samples; ii) values of predicted samples; iii) quantization parameters, QP. Step s904 comprises providing the ML input data to a ML model, thereby generating ML output data. Step s906 comprises, based at least on the ML output data, generating the encoded video or the decoded video. The ML input data does not include block boundary strength, BBS, information indicating strength of a filtering applied to a boundary of samples.

In some embodiments, the ML model consists of a first pair of models, a second pair of models, and a third pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the values of the reconstructed samples are provided to the first CNN, the values of predicted samples are provided to the second CNN, and the QPs are provided to the third CNN.

In some embodiments, the values of reconstructed samples comprise values of luma components of the reconstructed samples and chroma components of the reconstructed samples, the ML model consists of a first pair of models, a second pair of models, a third pair of models, and a fourth pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the values of the luma components of the reconstructed samples are provided to the first CNN, the values of the chroma components of the reconstructed samples are provided to the second CNN, the values of predicted samples are provided to the third CNN, and the QPs are provided to the fourth CNN.

In some embodiments, the values of reconstructed samples comprise values of luma components of the reconstructed samples and chroma components of the reconstructed samples, the ML input data further comprises partition information indicating how samples are partitioned, the ML model consists of a first pair of models, a second pair of models, a third pair of models, a fourth pair of models, and a fifth pair of models, and the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the values of the luma components of the reconstructed samples are provided to the first CNN, the values of the chroma components of the reconstructed samples are provided to the second CNN, the values of predicted samples are provided to the third CNN, the QPs are provided to the fourth CNN, and the partition information is provided to the fifth CNN.

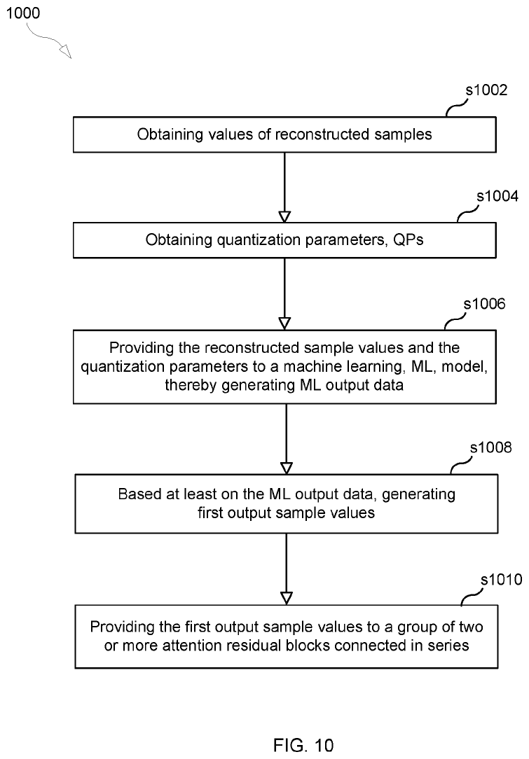

FIG. 10 shows a process 1000 for generating an encoded video or a decoded video. The process 1000 may begin with step s1002. Step s1002 comprises obtaining values of reconstructed samples. Step s1004 comprises obtaining quantization parameters, QPs. Step s1006 comprises providing the reconstructed sample values and the quantization parameters to a machine learning, ML, model, thereby generating ML output data. Step s1008 comprises, based at least on the ML output data, generating (s1008) first output sample values. Step s1010 comprises providing the first output sample values to a group of two or more attention residual blocks connected in series. The group of attention residual blocks comprises a first attention residual block disposed at one end of the series of attention residual blocks, and the first attention residual block is configured to receive first input data consisting of the first output sample values, and generate second output sample values based on the first output sample values.

In some embodiments, the group of attention residual blocks comprises a second attention residual block disposed at an opposite end of the series of attention residual blocks, the second attention residual block is configured to receive second input data comprising the values of the reconstructed samples and/or the QPs, and the second attention residual block is configured to generate third output sample values based on the values of the reconstructed samples and/or the QPs.

In some embodiments, the method further comprises obtaining values of predicted samples; obtaining block boundary strength, BBS, information indicating strength of a filtering applied to a boundary of samples; and providing the values of the predicted samples and the BBS information to a ML model, thereby generating spatial attention mask data, wherein the third output sample values are generated based on the spatial attention mask data.

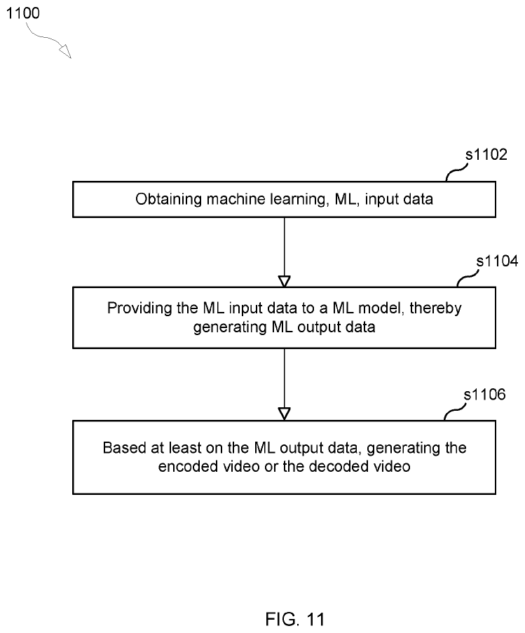

FIG. 11 shows a process 1100 for generating an encoded video or a decoded video. The process 1100 may begin with step s1102. Step s1102 comprises obtaining machine learning, ML, input data, wherein the ML input data comprises: i) values of luma components of reconstructed samples; ii) values of chroma components of reconstructed samples; iii) values of luma components of predicted samples; iv) values of chroma components of predicted samples; v) first block boundary strength, BBS, information indicating strength of a filtering applied to a boundary of luma components of samples; vi) second BBS information indicating strength of a filtering applied to a boundary of chroma components of samples; and iv) quantization parameters, QP. Step s1104 comprises providing the ML input data to a ML model, thereby generating ML output data. Step s1106 comprises based at least on the ML output data, generating the encoded video or the decoded video.

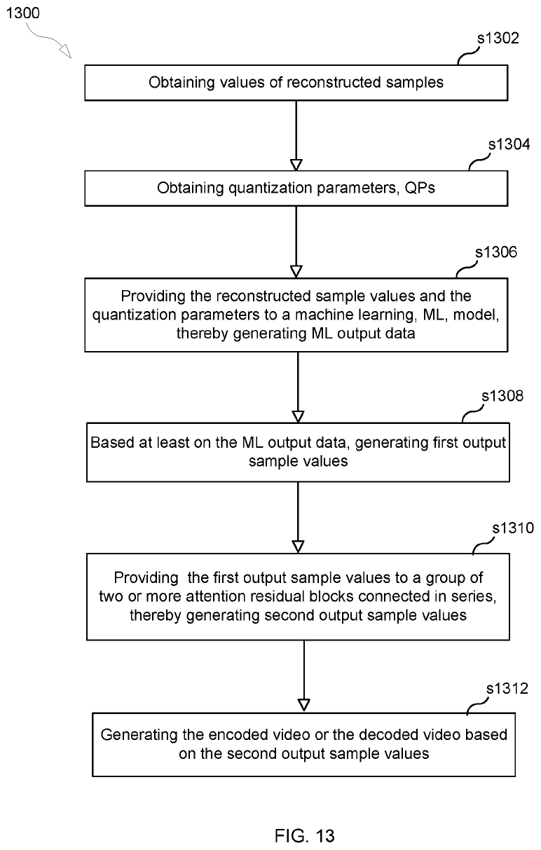

FIG. 13 shows a process 1300 for generating an encoded video or a decoded video. The process 1300 may begin with step s1302. Step s1302 comprises obtaining values of reconstructed samples. Step s1304 comprises obtaining quantization parameters, QPs. Step s1306 comprises providing the reconstructed sample values and the quantization parameters to a machine learning, ML, model, thereby generating ML output data. Step s1308 comprises based at least on the ML output data, generating (s1308) first output sample values. Step s1310 comprises providing the first output sample values to a group of two or more attention residual blocks connected in series, thereby generating second output sample values. Step s1312 comprises generating the encoded video or the decoded video based on the second output sample values. The group of attention residual blocks comprises a first attention residual block disposed at one end of the series of attention residual blocks, and the first attention residual block is configured to receive input data consisting of the first output sample values and the QPs.

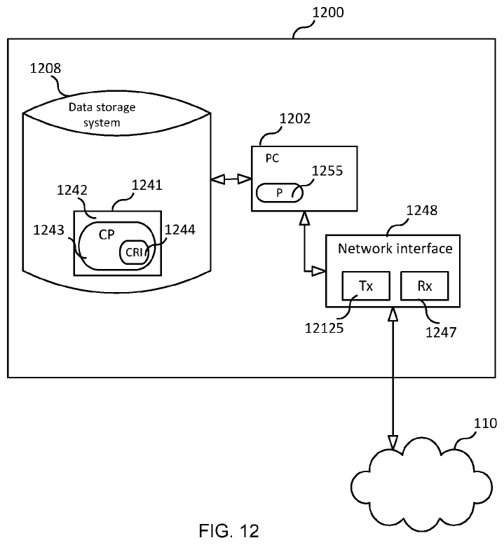

FIG. 12 is a block diagram of an apparatus 1200 for implementing the encoder 112, the decoder 114, or a component included in the encoder 112 or the decoder 114 (e.g., the NN filter 280 or 330), according to some embodiments. When apparatus 1200 implements a decoder, apparatus 1200 may be referred to as a “decoding apparatus 1200,” and when apparatus 1200 implements an encoder, apparatus 1200 may be referred to as an “encoding apparatus 1200.” As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248 comprising a transmitter (Tx) 1245 and a receiver (Rx) 1247 for enabling apparatus 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a storage unit (a.k.a., “data storage system”) 1208, which may include one or more non-voladatatile storage devices and/or one or more voladatatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

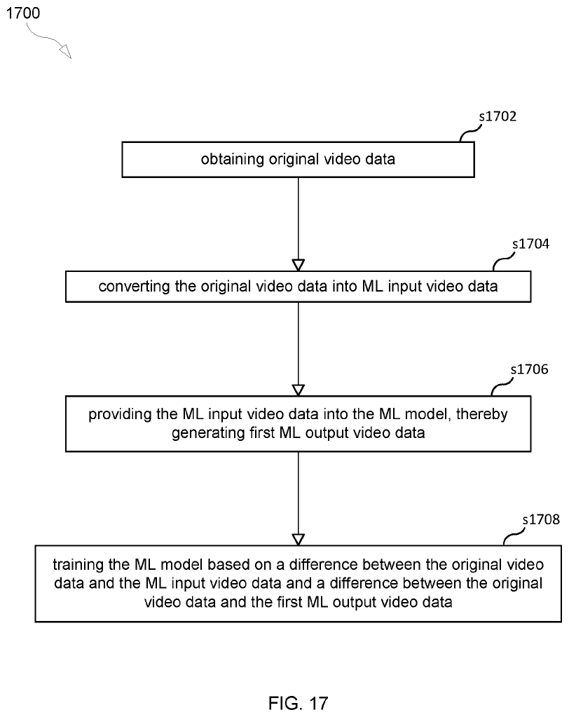

FIG. 17 shows a process 1700 of training a machine learning, ML, model used for generating encoded video data or decoded video data. Process 1700 may begin with step s1702. Step s1702 comprises obtaining original video data. Step s1704 comprises converting the original video data into ML input video data. Step s1706 comprises providing the ML input video data into the ML model, thereby generating first ML output video data. Step s1708 comprises training the ML model based on a difference between the original video data and the ML input video data and a difference between the original video data and the first ML output video data.

In some embodiments, training the ML model comprises: calculating a loss value based on the difference between the original video data and the ML input video data and the difference between the original video data and the first ML output video data, and determining weight values of weights of the ML model based on the calculated loss value.

In some embodiments, the original video data includes original image values, the ML input video data includes ML input image values, and the difference between the original video data and the ML input video data is calculated based on calculating a difference between each of the original image values and each of the ML input image values (e.g., oloss=oloss.square( ).mean ([2,3], true)+0.002) and calculating an average of the differences between the original image values and the ML input image values.

In some embodiments, the first ML output video data includes ML output image values, and the difference between the original video data and the first ML output video data is calculated based on calculating a difference between each of the original image values and each of the ML output image values, and calculating an average of the differences between the original image values and the ML output image values.

In some embodiments, training the ML model comprises training the ML model based on a ratio which is equal to

$$\frac{Avg 2 + a 2}{Avg 1 + a 1} ,$$

wherein Avg1 is the average of the differences between the original image values and the ML input image values, Avg2 is the average of the differences between the original image values and the ML output image values, and each a1 and a2 is any real number.

In some embodiments, the difference between each of the original image values and each of the ML input image values is an absolute difference or a squared difference, and/or the difference between each of the original image values and each of the ML output image values is an absolute difference or a squared difference.

In some embodiments, training the ML model comprises: calculating a first loss value based on the ML input video data and the first ML output video data; calculating a second loss value based on the ML input video data and the second ML output video data; and based on the first loss value and the second loss value, training the ML model.

In some embodiments, training the ML model based on the first loss value and the second loss value comprises: comparing between the first loss value and the second loss value; determining that the first loss value is smaller than the second loss value; and based on the determination, training the ML model based on the first loss value.

In some embodiments, the original video data is obtained from groups of training data, the groups of training data comprise a first group of training data associated with a first resolution and a second group of training data associated with a second resolution, and the method comprises: determining that a size of data included in the first group is less than a size of data included in the second group; and based on the determination, changing size of data included in the first group.

In some embodiments, changing size of data included in the first group comprises duplicating at least a portion of data included in the first group and including the duplicated portion of data in the first group such that the size of data included in the first group is same as the size of data included in the second group.

In some embodiments, the ML input video data corresponds to a first frame, the method comprises: obtaining another ML input video data corresponding to a second frame, wherein the second frame is different from the first frame; and providing the second ML input video data, thereby generating second ML output video data, and the ML model is trained based on the ML input video data, the ML output video data, said another ML output video data, a first weight value associated with the first ML output video data, and a second weight value associated with the second ML output video data.

In some embodiments, the first weight value is greater than the second weight value, and a number of predictions for which image data corresponding to the first frame is used is greater than a number of predictions for which image data corresponding to the second frame is used.

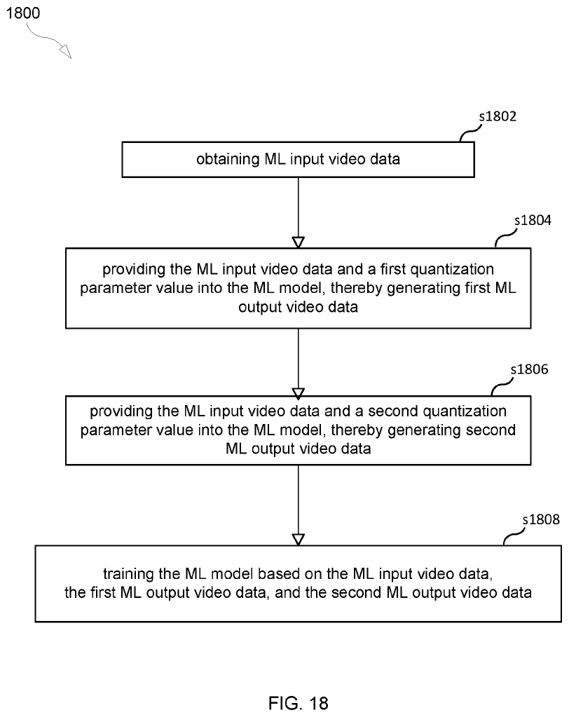

FIG. 18 shows a process 1800 of training a machine learning, ML, model used for generating encoded video data or decoded video data. Process 1800 may begin with step s1802. Step s1802 comprises obtaining ML input video data. Step s1804 comprises providing the ML input video data and a first quantization parameter value into the ML model, thereby generating first ML output video data. Step s1806 comprises providing the ML input video data and a second quantization parameter value into the ML model, thereby generating second ML output video data. Step s1808 comprises training the ML model based on the ML input video data, the first ML output video data, and the second ML output video data.

In some embodiments, training the ML model comprises: calculating a first loss value based on the ML input video data and the first ML output video data; calculating a second loss value based on the ML input video data and the second ML output video data; and based on the first loss value and the second loss value, training the ML model.

In some embodiments, training the ML model based on the first loss value and the second loss value comprises: comparing between the first loss value and the second loss value; determining that the first loss value is smaller than the second loss value; and based on the determination, training the ML model based on the first loss value.

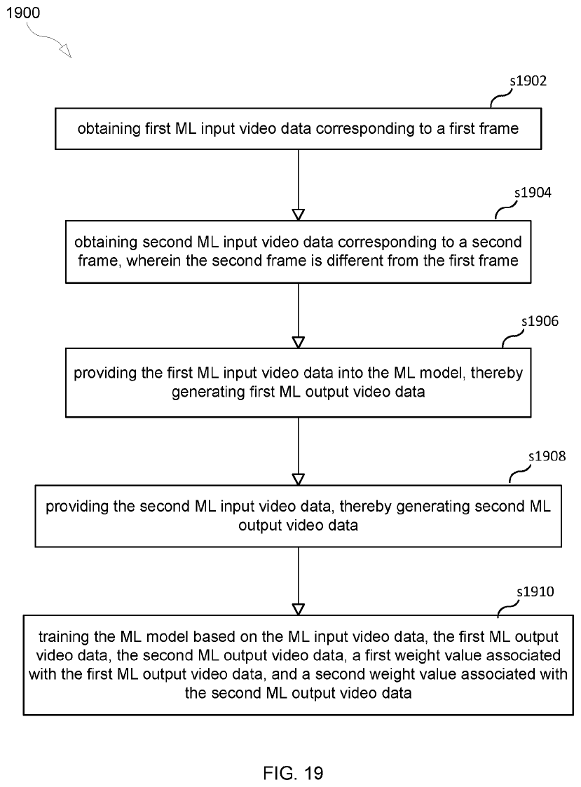

FIG. 19 shows a process 1900 of training a machine learning (ML) model used for generating encoded video data or decoded video data. Process 1900 may begin with step s1902. Step s1902 comprises obtaining first ML input video data corresponding to a first frame. Step s1904 comprises obtaining second ML input video data corresponding to a second frame, wherein the second frame is different from the first frame. Step s1906 comprises providing the first ML input video data into the ML model, thereby generating first ML output video data. Step s1908 comprises providing the second ML input video data, thereby generating second ML output video data. Step s1910 comprises training the ML model based on the ML input video data, the first ML output video data, the second ML output video data, a first weight value associated with the first ML output video data, and a second weight value associated with the second ML output video data.

In some embodiments, the first weight value is greater than the second weight value, and a number of predictions for which image data corresponding to the first frame is used is greater than a number of predictions for which image data corresponding to the second frame is used.

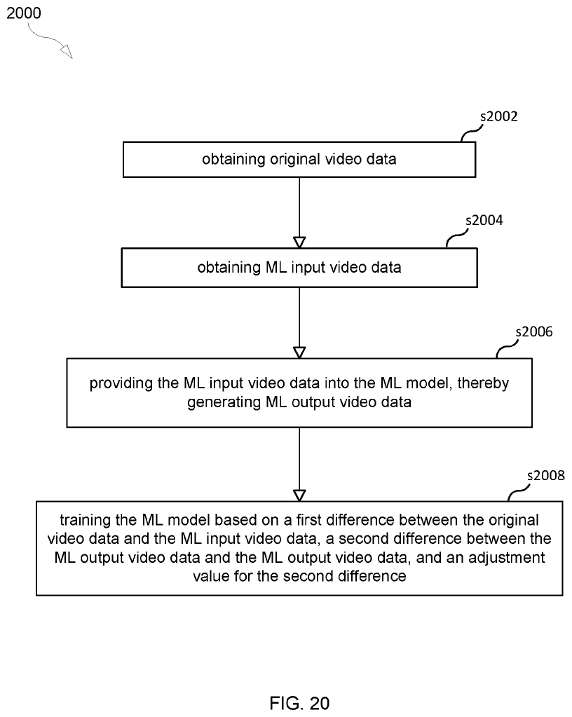

FIG. 20 shows a process 2000 of training a machine learning, ML, model used for generating encoded video data or decoded video data. Process 2000 may begin with step s2002. Step s2002 comprises obtaining original video data. Step s2004 comprises obtaining ML input video data. Step s2006 comprises providing the ML input video data into the ML model, thereby generating ML output video data. Step s2008 comprises training the ML model based on a first difference between the original video data and the ML input video data, a second difference between the ML output video data and the ML output video data, and an adjustment value for the second difference.

In some embodiments, training the ML model comprises: calculating an adjusted second difference using the second difference and the adjustment value; calculating a loss value based on the first difference and the adjusted second difference; and performing a backpropagation using the calculated loss value, thereby training the ML model.

In some embodiments, calculating a loss value comprises calculating a difference between the first difference and the adjusted second difference, and the difference between the first difference and the adjusted second difference is a squared difference or an absolute difference.

In some embodiments, the adjustment value is

$$\frac{r 1 \cdot r 2}{r 2 \cdot r 2}$$

where r1 is the first difference and r2 is the second difference.

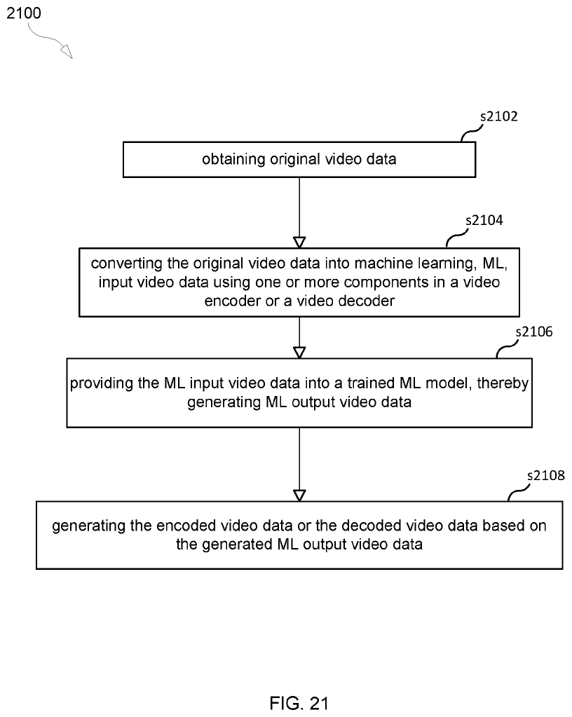

FIG. 21 shows a process 2100 of generating encoded video data or decoded video data. Process 2100 may begin with step s2102. Step s2102 comprises obtaining original video data. Step s2104 comprises converting the original video data into machine learning, ML, input video data using one or more components in a video encoder or a video decoder. Step s2106 comprises providing the ML input video data into a trained ML model, thereby generating ML output video data. Step s2108 comprises generating the encoded video data or the decoded video data based on the generated ML output video data. The trained ML model is trained using original training video data, a difference between the original training video data and ML input training video data, and a difference between the original training video data and ML output training video data. The ML input training video data is obtained by providing the original training video data to said one or more components of the video encoder or the video decoder. The ML output training video data is obtained by providing the ML input training video data to a ML model.

In some embodiments, training the ML model comprises: calculating a loss value based on the difference between the original video data and the ML input video data and the difference between the original video data and the first ML output video data, and determining weight values of weights of the ML model based on the calculated loss value.

In some embodiments, the original video data includes original image values, the ML input video data includes ML input image values, and the difference between the original video data and the ML input video data is calculated based on calculating a difference between each of the original image values and each of the ML input image values (e.g., oloss=oloss.square( ).mean ([2,3], true)+0.002) and calculating an average of the differences between the original image values and the ML input image values.

In some embodiments, the first ML output video data includes ML output image values, and the difference between the original video data and the first ML output video data is calculated based on calculating a difference between each of the original image values and each of the ML output image values, and calculating an average of the differences between the original image values and the ML output image values.

In some embodiments, training the ML model comprises training the ML model based on a ratio which is equal to

$$\frac{Avg 2 + a 2}{Avg 1 + a 1} ,$$

wherein Avg1 is the average of the differences between the original image values and the ML input image values, Avg2 is the average of the differences between the original image values and the ML output image values, and each a1 and a2 is any real number.

In some embodiments, the difference between each of the original image values and each of the ML input image values is an absolute difference or a squared difference, and/or the difference between each of the original image values and each of the ML output image values is an absolute difference or a squared difference.

In some embodiments, training the ML model comprises: calculating a first loss value based on the ML input video data and the first ML output video data; calculating a second loss value based on the ML input video data and the second ML output video data; and based on the first loss value and the second loss value, training the ML model.

In some embodiments, training the ML model based on the first loss value and the second loss value comprises: comparing between the first loss value and the second loss value; determining that the first loss value is smaller than the second loss value; and based on the determination, training the ML model based on the first loss value.

In some embodiments, the original video data is obtained from groups of training data, the groups of training data comprise a first group of training data associated with a first resolution and a second group of training data associated with a second resolution, and the method comprises: determining that a size of data included in the first group is less than a size of data included in the second group; and based on the determination, changing size of data included in the first group.

In some embodiments, changing size of data included in the first group comprises duplicating at least a portion of data included in the first group and including the duplicated portion of data in the first group such that the size of data included in the first group is same as the size of data included in the second group.

In some embodiments, the ML input video data corresponds to a first frame, the method comprises: obtaining another ML input video data corresponding to a second frame, wherein the second frame is different from the first frame; and providing the second ML input video data, thereby generating second ML output video data, and the ML model is trained based on the ML input video data, the ML output video data, said another ML output video data, a first weight value associated with the first ML output video data, and a second weight value associated with the second ML output video data.

In some embodiments, the first weight value is greater than the second weight value, and a number of predictions for which image data corresponding to the first frame is used is greater than a number of predictions for which image data corresponding to the second frame is used.

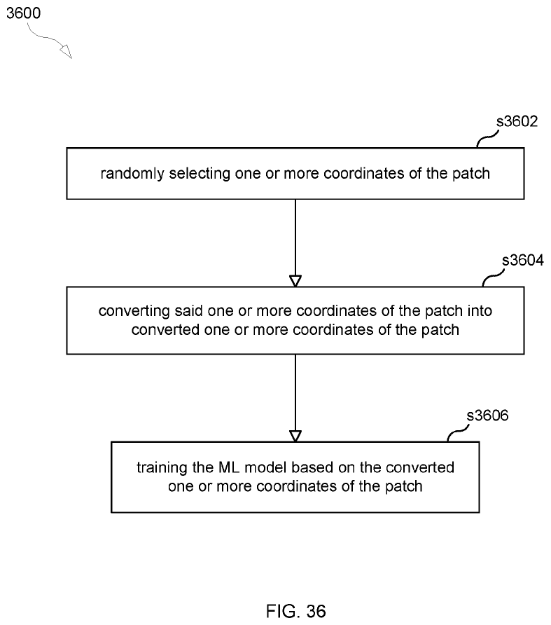

FIG. 36 shows a process 3600 for selecting from a picture a patch for training a machine learning, ML, model used for encoding or decoding video data. Process 3600 may begin with step s3602. Step s3602 comprises randomly selecting one or more coordinates of the patch. Step s3604 comprises converting said one or more coordinates of the patch into converted one or more coordinates of the patch. Step s3608 comprises training the ML model based on the converted one or more coordinates of the patch. Each of said one or more converted coordinates of the patch is an integer multiple of 2^{p}, where p is an integer.

In some embodiments, converting said one or more coordinates of the patch into the converted one or more coordinates of the patch comprises performing an integer division operation.

In some embodiments, said one or more coordinates of the patch comprises a coordinate x, the converted one or more coordinates of the patch comprises a converted coordinate x′, and x′ is determined based on the integer operation and 2^{p}.

In some embodiments, x′=(x//2^{p})×2^{p}, where // is the integer operation.

In some embodiments, the converted one or more coordinates of the patch corresponds to a first position of the patch, and the first position of the patch is outside of a defined area.

In some embodiments, the defined area is located between sample positions 0 and 2^{p}−1, where p is an integer.

In some embodiments, the first position is obtained by: (i) obtaining a randomly selected position (e.g., x-coordinate, y-coordinate); (ii) determining whether the randomly selected position is inside or outside the defined area; and (iii) in case the randomly selected position is outside the defined area, selecting the randomly selected position as the first position or in case the randomly selected position is inside the defined area, repeating steps (i)-(iii).

In some embodiments, obtaining the randomly selected position comprises determining at least one coordinate, and said at least one coordinate is determined based on (i) a random number between 0 and 1, (ii) a height or a width of the picture, and (iii) a height or a width of the patch.

In some embodiments, said at least one coordinate is equal to ƒ(a*(p−(b−1))), where ƒ is a function for rounding down to the nearest integer, a is the random number, p is the height or the width of the picture, and b is the height or the width of the patch.

In some embodiments, the first position is obtained by: obtaining a randomly selected position (e.g., int ( . . . )); shifting the randomly selected position by a width or a height of the defined area, thereby obtaining a shifted position; and selecting the shifted position as the first position.

In some embodiments, obtaining the randomly selected position comprises determining at least one coordinate, and said at least one coordinate is determined based on (i) a random number between 0 and 1, (ii) a height or a width of the picture, (iii) a height or a width of the patch, and (iv) a height or a width of the defined area.

In some embodiments, said at least one coordinate is equal to ƒ(a*((p−c)−(b−1))), where ƒ is a function for rounding down to the nearest integer, a is the random number, p is the height or the width of the picture, c is the height or the width of the defined area, and b is a height or a width of the patch.

In some embodiments, the first position of the patch is obtained by: obtaining a first randomly selected coordinate; determining that the first randomly selected coordinate is within a first area, wherein one of a width or a height of the first area is equal to the width or the height of the defined area, and another of the width or the height of the first area is equal to or less than the width or the height of the picture; and based on the determination, generating a second randomly selected coordinate, wherein the second randomly selected coordinate is generated using (i) a random number between 0 and 1, (ii) a height or a width of the picture, (iii) a height or a width of the patch, and (iv) a height or a width of the defined area.

In some embodiments, the second randomly selected coordinate is equal to ƒ(a*((p−c)−(b−1)))+c, where ƒ is a function for rounding down to the nearest integer, a is the random number, p is the height or the width of the picture, c is the height or the width of the defined area, and b is the size of the patch.

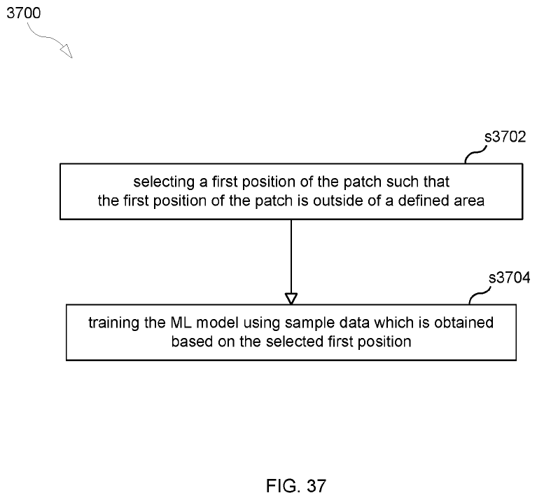

FIG. 37 shows a process 3700 for selecting from a picture a patch for training a machine learning, ML, model used for encoding or decoding video data. Process 3700 may begin with step s3702. Step s3702 comprises selecting a first position of the patch such that the first position of the patch is outside of a defined area. Step s3704 comprises training the ML model using sample data which is obtained based on the selected first position.

In some embodiments, the defined area is located between sample positions 0 and 2^{p}−1, where p is an integer.

In some embodiments, selecting the first position comprises: (i) obtaining a randomly selected position (e.g., x-coordinate, y-coordinate); (ii) determining whether the randomly selected position is inside or outside the defined area; and (iii) in case the randomly selected position is outside the defined area, selecting the randomly selected position as the first position or in case the randomly selected position is inside the defined area, repeating steps (i)-(iii).

In some embodiments, obtaining the randomly selected position comprises determining at least one coordinate, and said at least one coordinate is determined based on (i) a random number between 0 and 1, (ii) a height or a width of the picture, and (iii) a height or a width of the patch.

In some embodiments, said at least one coordinate is equal to ƒ(a*(p−(b−1))), where ƒ is a function for rounding down to the nearest integer, a is the random number, p is the height or the width of the picture, and b is the height or the width of the patch.

In some embodiments, selecting the first position comprises: obtaining a randomly selected position (e.g., int ( . . . )); shifting the randomly selected position by a width or a height of the defined area, thereby obtaining a shifted position; and selecting the shifted position as the first position.

In some embodiments, obtaining the randomly selected position comprises determining at least one coordinate, and said at least one coordinate is determined based on (i) a random number between 0 and 1, (ii) a height or a width of the picture, (iii) a height or a width of the patch, and (iv) a height or a width of the defined area.

In some embodiments, said at least one coordinate is equal to ƒ(a*((p−c)−(b−1))), where ƒ is a function for rounding down to the nearest integer, a is the random number, p is the height or the width of the picture, c is the height or the width of the defined area, and b is a height or a width of the patch.

In some embodiments, selecting the first position of the patch comprises: obtaining a first randomly selected coordinate; determining that the first randomly selected coordinate is within a first area, wherein one of a width or a height of the first area is equal to the width or the height of the defined area, and another of the width or the height of the first area is equal to or less than the width or the height of the picture, based on the determination, generating a second randomly selected coordinate, wherein the second randomly selected coordinate is generated using (i) a random number between 0 and 1, (ii) a height or a width of the picture, (iii) a height or a width of the patch, and (iv) a height or a width of the defined area.

In some embodiments, the second randomly selected coordinate is equal to ƒ(a*((p−c)−(b−1)))+c, where ƒ is a function for rounding down to the nearest integer, a is the random number, p is the height or the width of the picture, c is the height or the width of the defined area, and b is the size of the patch.

In some embodiments, the first position comprises one or more converted coordinates of the patch, and each of said one or more converted coordinates of the patch is an integer multiple of 2^{p}, where p is an integer.

In some embodiments, said one or more converted coordinates of the patch is obtained by converting one or more coordinates of the patch by performing an integer division operation.

In some embodiments, said one or more coordinates of the patch comprises a coordinate x, the converted one or more coordinates of the patch comprises a converted coordinate x′, and x′ is determined based on the integer operation and 2^{p}.

In some embodiments, x′=(x//2^{p})×2^{p}, where // is the integer operation.

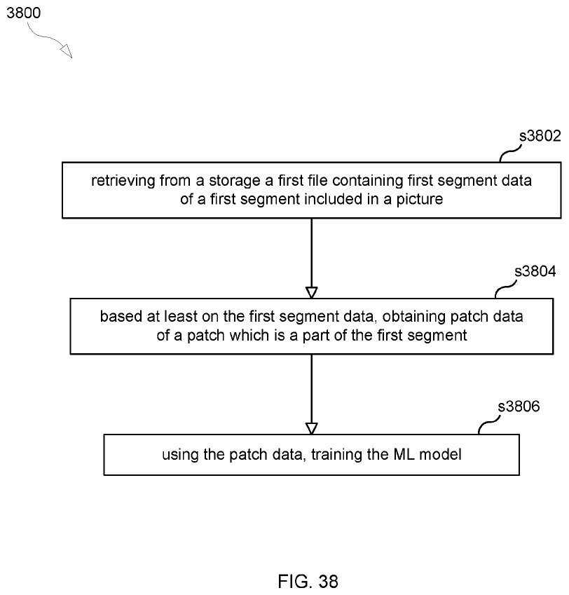

FIG. 38 shows a process 3800 for training a machine learning, ML, model for encoding or decoding video data. Process 3800 may begin with step s3802. Step s3802 comprises retrieving from a storage (e.g., a hard disk, a solid state drive, etc.) a first file containing first segment data of a first segment included in a picture, wherein the first segment is smaller than the picture. Step s3804 comprises based at least on the first segment data, obtaining (s3804) patch data of a patch which is a part of the first segment. Step s3806 comprises using the patch data, training the ML model.

In some embodiments, the storage is configured to store a second file which contains second segment data of a second segment included in the picture, the patch is a part of the second segment, and the patch data is obtained by retrieving the first file without retrieving the second file.

In some embodiments, the process comprises identifying the first segment located at a position within the picture. The first file is retrieved from the storage based on identifying the first segment, and the position of the first segment is determined as:

$$xTile = max ( 0 , ( patchXpos - 1 ) / / ( tileSizeX - patchSizeX )$$

$$yTile = max ( 0 , ( patchYpos - 1 ) / / ( tileSizeY - patchSizeY ) .$$

where xTile is an x-coordinate of the position of the first segment, yTile is an y-coordinate of the position of the first segment, patchXpos is an x-coordinate of a position of the patch, patchYpos is an y-coordinate of the position of the patch, tileSizeX is a size of the first segment in a first dimension, tileSizeY is a size of the first segment in a second dimension, patchSizeX is a size of the patch in the first dimension, and patchSizeY is a size of the patch in the second dimension.

In some embodiments, the patch is also a part of a second segment included in the picture, and the process comprises: retrieving from the storage a second file containing second segment data of the second segment, wherein the second segment is smaller than the picture and has the same size as the first segment; and based at least on the first segment data, and the second segment data, obtaining the patch data of the patch.

In some embodiments, the first segment and the second segment overlaps, thereby creating an overlapped area, and the patch is located at least partially within the overlapped area.

In some embodiments, the patch is also a part of a third segment included in the picture, and the process comprises: retrieving from the storage a third file containing third segment data of the third segment, wherein the third segment is smaller than the picture and has the same size as the first segment and the second segment; and based at least on the first segment data, the second segment data, and the third segment data, obtaining the patch data of the patch.

In some embodiments, the first file is a compressed file stored in the storage, and the process further comprises decompressing the first file to obtain the first segment data.

In some embodiments, the first file comprises a group of segment data comprising the first segment data, and the group of segment data comprises segment data for reconstructed samples, segment data for predicted samples, segment data for original samples, segment data for boundary strength.

In some embodiments, the first file comprises a stack of segment data, the stack of segment data comprises a first layer of segment data and a second layer of segment data, the first layer of segment data comprises data corresponding to a first resolution, the second layer of segment data comprises data corresponding to a second resolution, and the first resolution is higher than the second resolution.

### SUMMARY OF EMBODIMENTS

A1. A method (1700) of training a machine learning, ML, model used for generating encoded video data or decoded video data, the method comprising:
obtaining (s1702) original video data (e.g., the data received at the encoder or the decoder);
converting (s1704) the original video data into ML input video data (e.g., the data provided the ML model);
providing (s1706) the ML input video data into the ML model, thereby generating first ML output video data; and
training (s1708) the ML model based on a difference between the original video data and the ML input video data and a difference between the original video data and the first ML output video data.
A3. The method of embodiment A1, wherein training the ML model comprises:
calculating a loss value based on the difference between the original video data and the ML input video data and the difference between the original video data and the first ML output video data, and
determining weight values of weights of the ML model based on the calculated loss value.
A4. The method of embodiment A1 or A3, wherein
the original video data includes original image values,
the ML input video data includes ML input image values, and
the difference between the original video data and the ML input video data is calculated based on calculating a difference between each of the original image values and each of the ML input image values (e.g., oloss=oloss.square( ).mean([2,3], true)+0.002) and calculating an average of the differences between the original image values and the ML input image values.
A5. The method of embodiment A4, wherein
the first ML output video data includes ML output image values, and
the difference between the original video data and the first ML output video data is calculated based on calculating a difference between each of the original image values and each of the ML output image values, and calculating an average of the differences between the original image values and the ML output image values.
A6. The method of embodiment A5, wherein training the ML model comprises training the ML model based on a ratio which is equal to wherein

$$\frac{Avg 2 + a 2}{Avg 1 + a 1} ,$$

wherein
Avg1 is the average of the differences between the original image values and the ML input image values,
Avg2 is the average of the differences between the original image values and the ML output image values, and
each a1 and a2 is any real number.
A7. The method of any one of embodiments A4-A6, wherein
the difference between each of the original image values and each of the ML input image values is an absolute difference or a squared difference, and/or
the difference between each of the original image values and each of the ML output image values is an absolute difference or a squared difference.
A8. The method of embodiment A7, wherein training the ML model comprises:
calculating a first loss value based on the ML input video data and the first ML output video data;
calculating a second loss value based on the ML input video data and the second ML output video data; and
based on the first loss value and the second loss value, training the ML model.
A9. The method of embodiment A8, wherein training the ML model based on the first loss value and the second loss value comprises:
comparing between the first loss value and the second loss value;
determining that the first loss value is smaller than the second loss value; and
based on the determination, training the ML model based on the first loss value.
A10. The method of any one of embodiments A1-A9, wherein
the original video data is obtained from groups of training data,
the groups of training data comprise a first group of training data associated with a first resolution and a second group of training data associated with a second resolution, and
the method comprises:
   determining that a size of data included in the first group is less than a size of data included in the second group; and
   based on the determination, changing size of data included in the first group.
A11. The method of embodiment A10, wherein changing size of data included in the first group comprises duplicating at least a portion of data included in the first group and including the duplicated portion of data in the first group such that the size of data included in the first group is same as the size of data included in the second group.
A12. The method of any one of embodiments A1-A11, wherein
the ML input video data corresponds to a first frame,
the method comprises:
   obtaining another ML input video data corresponding to a second frame, wherein the second frame is different from the first frame; and
   providing the second ML input video data, thereby generating second ML output video data, and
the ML model is trained based on the ML input video data, the ML output video data, said another ML output video data, a first weight value associated with the first ML output video data, and a second weight value associated with the second ML output video data.
A13. The method of embodiment A12, wherein
the first weight value is greater than the second weight value, and
a number of predictions for which image data corresponding to the first frame is used is greater than a number of predictions for which image data corresponding to the second frame is used.
B1. A method (1800) of training a machine learning, ML, model used for generating encoded video data or decoded video data, the method comprising:
obtaining (s1802) ML input video data (e.g., the data provided the ML model);
providing (s1804) the ML input video data and a first quantization parameter value into the ML model, thereby generating first ML output video data;
providing (s1806) the ML input video data and a second quantization parameter value into the ML model, thereby generating second ML output video data; and
training (s1808) the ML model based on the ML input video data, the first ML output video data, and the second ML output video data.
B2. The method of embodiment B1, wherein training the ML model comprises:
calculating a first loss value based on the ML input video data and the first ML output video data;
calculating a second loss value based on the ML input video data and the second ML output video data; and
based on the first loss value and the second loss value, training the ML model.
B3. The method of embodiment B1, wherein training the ML model based on the first loss value and the second loss value comprises:
comparing between the first loss value and the second loss value;
determining that the first loss value is smaller than the second loss value; and
based on the determination, training the ML model based on the first loss value.
C1. A method (1900) of training a machine learning, ML, model used for generating encoded video data or decoded video data, the method comprising:
obtaining (s1902) first ML input video data corresponding to a first frame;
obtaining (s1904) second ML input video data corresponding to a second frame, wherein the second frame is different from the first frame;
providing (s1906) the first ML input video data into the ML model, thereby generating first ML output video data;
providing (s1908) the second ML input video data, thereby generating second ML output video data; and
training (s1910) the ML model based on the ML input video data, the first ML output video data, the second ML output video data, a first weight value associated with the first ML output video data, and a second weight value associated with the second ML output video data.
C2. The method of embodiment C1, wherein
the first weight value is greater than the second weight value, and
a number of predictions for which image data corresponding to the first frame is used is greater than a number of predictions for which image data corresponding to the second frame is used.
D1. A method (2000) of training a machine learning, ML, model used for generating encoded video data or decoded video data, the method comprising:
obtaining (s2002) original video data;
obtaining (s2004) ML input video data;
providing (s2006) the ML input video data into the ML model, thereby generating ML output video data; and
training (s2008) the ML model based on a first difference between the original video data and the ML input video data, a second difference between the ML output video data and the ML output video data, and an adjustment value (e.g., (r-·r\hat{ })/(r\hat{ }·r\hat{ })) for the second difference.
D2. The method of embodiment D1, wherein training the ML model comprises:
calculating an adjusted second difference using the second difference and the adjustment value;
calculating a loss value based on the first difference and the adjusted second difference; and
performing a backpropagation using the calculated loss value, thereby training the ML model.
D3. The method of embodiment D2, wherein
calculating a loss value comprises calculating a difference between the first difference and the adjusted second difference, and
the difference between the first difference and the adjusted second difference is a squared difference or an absolute difference.
D4. The method of embodiment D3, wherein the adjustment value is

$$\frac{r 1 \cdot r 2}{r 2 \cdot r 2}$$

where r1 is the first difference and r2 is the second difference.
E1. A method (2100) of generating encoded video data or decoded video data, the method comprising:
obtaining (s2102) original video data (e.g., the data received at the encoder or the decoder);
converting (s2104) the original video data into machine learning, ML, input video data (e.g., the data provided the ML model) using one or more components in a video encoder or a video decoder;
providing (s2106) the ML input video data into a trained ML model, thereby generating ML output video data; and
generating (s2108) the encoded video data or the decoded video data based on the generated ML output video data, wherein
the trained ML model is trained using original training video data, a difference between the original training video data and ML input training video data, and a difference between the original training video data and ML output training video data,
the ML input training video data is obtained by providing the original training video data to said one or more components of the video encoder or the video decoder, and
the ML output training video data is obtained by providing the ML input training video data to a ML model.
E3. The method of embodiment E1, wherein training the ML model comprises:
calculating a loss value based on the difference between the original video data and the ML input video data and the difference between the original video data and the first ML output video data, and
determining weight values of weights of the ML model based on the calculated loss value.
E4. The method of embodiment E1 or E3, wherein
the original video data includes original image values,
the ML input video data includes ML input image values, and
the difference between the original video data and the ML input video data is calculated based on calculating a difference between each of the original image values and each of the ML input image values (e.g., oloss=oloss.square( ).mean([2,3], true)+0.002) and calculating an average of the differences between the original image values and the ML input image values.
E5. The method of embodiment E4, wherein
the first ML output video data includes ML output image values, and
the difference between the original video data and the first ML output video data is calculated based on calculating a difference between each of the original image values and each of the ML output image values, and calculating an average of the differences between the original image values and the ML output image values.
E6. The method of embodiment E5, wherein training the ML model comprises training the ML model based on a ratio which is equal to

$$\frac{Avg 2 + a 2}{Avg 1 + a 1} ,$$

wherein
Avg1 is the average of the differences between the original image values and the ML input image values,
Avg2 is the average of the differences between the original image values and the ML output image values, and
each a1 and a2 is any real number.
E7. The method of any one of embodiments E4-E6, wherein
the difference between each of the original image values and each of the ML input image values is an absolute difference or a squared difference, and/or
the difference between each of the original image values and each of the ML output image values is an absolute difference or a squared difference.
E8. The method of embodiment E7, wherein training the ML model comprises:
calculating a first loss value based on the ML input video data and the first ML output video data;
calculating a second loss value based on the ML input video data and the second ML output video data; and
based on the first loss value and the second loss value, training the ML model.
E9. The method of embodiment E8, wherein training the ML model based on the first loss value and the second loss value comprises:
comparing between the first loss value and the second loss value;
determining that the first loss value is smaller than the second loss value; and
based on the determination, training the ML model based on the first loss value.
E10. The method of any one of embodiments E1-E9, wherein
the original video data is obtained from groups of training data,
the groups of training data comprise a first group of training data associated with a first resolution and a second group of training data associated with a second resolution, and
the method comprises:
   determining that a size of data included in the first group is less than a size of data included in the second group; and
   based on the determination, changing size of data included in the first group.
E11. The method of embodiment E10, wherein changing size of data included in the first group comprises duplicating at least a portion of data included in the first group and including the duplicated portion of data in the first group such that the size of data included in the first group is same as the size of data included in the second group.
E12. The method of any one of embodiments E1-E11, wherein
the ML input video data corresponds to a first frame,
the method comprises:
   obtaining another ML input video data corresponding to a second frame, wherein the second frame is different from the first frame; and
   providing the second ML input video data, thereby generating second ML output video data, and
the ML model is trained based on the ML input video data, the ML output video data, said another ML output video data, a first weight value associated with the first ML output video data, and a second weight value associated with the second ML output video data.
E13. The method of embodiment E12, wherein
the first weight value is greater than the second weight value, and
a number of predictions for which image data corresponding to the first frame is used is greater than a number of predictions for which image data corresponding to the second frame is used.
F1. A method (3600) of selecting from a picture a patch for training a machine learning, ML, model used for encoding or decoding video data, the method comprising:
randomly (s3602) selecting one or more coordinates of the patch;
converting (s3604) said one or more coordinates of the patch into converted one or more coordinates of the patch; and
training (s3606) the ML model based on the converted one or more coordinates of the patch, wherein
each of said one or more converted coordinates of the patch is an integer multiple of 2^{p}, where p is an integer.
F2. The method of embodiment F1, wherein converting said one or more coordinates of the patch into the converted one or more coordinates of the patch comprises performing an integer division operation.
F3. The method of embodiment F2, wherein
said one or more coordinates of the patch comprises a coordinate x,
the converted one or more coordinates of the patch comprises a converted coordinate x′,
x′ is determined based on the integer division operation and 2^{p}.
F4. The method of embodiment F3, wherein x′=(x//2^{p})×2^{p}, where // is the integer division operation.
F5. The method of any one of embodiments F1-F4, wherein
the converted one or more coordinates of the patch corresponds to a first position of the patch, and
the first position of the patch is outside of a defined area.
F6. The method of embodiment F5, wherein the defined area is located between sample positions 0 and 2^{p}−1, where p is an integer.
F7. The method of embodiment F5 or F6, wherein the first position is obtained by:
(i) obtaining a randomly selected position (e.g., x-coordinate, y-coordinate);
(ii) determining whether the randomly selected position is inside or outside the defined area; and
(iii) in case the randomly selected position is outside the defined area, selecting the randomly selected position as the first position or in case the randomly selected position is inside the defined area, repeating steps (i)-(iii).
F8. The method of embodiment F7, wherein
obtaining the randomly selected position comprises determining at least one coordinate, and
said at least one coordinate is determined based on (i) a random number between 0 and 1, (ii) a height or a width of the picture, and (iii) a height or a width of the patch.
F9. The method of embodiment F8, wherein said at least one coordinate is equal to ƒ(a*(p−(b−1))), where ƒ is a function for rounding down to the nearest integer, a is the random number, p is the height or the width of the picture, and b is the height or the width of the patch.
F10. The method of embodiment F5 or F6, wherein the first position is obtained by:
obtaining a randomly selected position (e.g., int( . . . ));
shifting the randomly selected position by a width or a height of the defined area, thereby obtaining a shifted position; and
selecting the shifted position as the first position.
F11. The method of embodiment F10, wherein
obtaining the randomly selected position comprises determining at least one coordinate, and
said at least one coordinate is determined based on (i) a random number between 0 and 1, (ii) a height or a width of the picture, (iii) a height or a width of the patch, and (iv) a height or a width of the defined area.
F12. The method of embodiment F11, wherein said at least one coordinate is equal to ƒ(a*((p−c)−(b−1))), where ƒ is a function for rounding down to the nearest integer, a is the random number, p is the height or the width of the picture, c is the height or the width of the defined area, and b is a height or a width of the patch.
F13. The method of embodiment F5 or F6, wherein the first position of the patch is obtained by:
obtaining a first randomly selected coordinate;
determining that the first randomly selected coordinate is within a first area, wherein one of a width or a height of the first area is equal to the width or the height of the defined area, and another of the width or the height of the first area is equal to or less than the width or the height of the picture,
based on the determination, generating a second randomly selected coordinate, wherein the second randomly selected coordinate is generated using (i) a random number between 0 and 1, (ii) a height or a width of the picture, (iii) a height or a width of the patch, and (iv) a height or a width of the defined area.
F14. The method of embodiment F13, wherein the second randomly selected coordinate is equal to ƒ(a*((p−c)−(b−1)))+c, where ƒ is a function for rounding down to the nearest integer, a is the random number, p is the height or the width of the picture, c is the height or the width of the defined area, and b is the size of the patch.
G1. A method (3700) of selecting from a picture a patch for training a machine learning, ML, model used for encoding or decoding video data, the method comprising:
selecting (s3702) a first position of the patch such that the first position of the patch is outside of a defined area; and
training (s3704) the ML model using sample data which is obtained based on the selected first position.
G2. The method of embodiment G1, wherein
the defined area is located between sample positions 0 and 2^{p}−1, where p is an integer.
G3. The method of embodiment G1 or G2, wherein selecting the first position comprises:
(i) obtaining a randomly selected position (e.g., x-coordinate, y-coordinate);
(ii) determining whether the randomly selected position is inside or outside the defined area; and
(iii) in case the randomly selected position is outside the defined area, selecting the randomly selected position as the first position or in case the randomly selected position is inside the defined area, repeating steps (i)-(iii).
G4. The method of embodiment G3, wherein
obtaining the randomly selected position comprises determining at least one coordinate, and
said at least one coordinate is determined based on (i) a random number between 0 and 1, (ii) a height or a width of the picture, and (iii) a height or a width of the patch.
G5. The method of embodiment G4, wherein said at least one coordinate is equal to ƒ(a*(p−(b−1))), where ƒ is a function for rounding down to the nearest integer, a is the random number, p is the height or the width of the picture, and b is the height or the width of the patch.
G6. The method of embodiment G1 or G2, wherein selecting the first position comprises:
obtaining a randomly selected position (e.g., int( . . . ));
shifting the randomly selected position by a width or a height of the defined area, thereby obtaining a shifted position; and
selecting the shifted position as the first position.
G7. The method of embodiment G6, wherein
obtaining the randomly selected position comprises determining at least one coordinate, and
said at least one coordinate is determined based on (i) a random number between 0 and 1, (ii) a height or a width of the picture, (iii) a height or a width of the patch, and (iv) a height or a width of the defined area.
G8. The method of embodiment G7, wherein said at least one coordinate is equal to ƒ(a*((p−c)−(b−1))), where ƒ is a function for rounding down to the nearest integer, a is the random number, p is the height or the width of the picture, c is the height or the width of the defined area, and b is a height or a width of the patch.
G9. The method of embodiment G1 or G2, wherein selecting the first position of the patch comprises:
obtaining a first randomly selected coordinate;
determining that the first randomly selected coordinate is within a first area, wherein one of a width or a height of the first area is equal to the width or the height of the defined area, and another of the width or the height of the first area is equal to or less than the width or the height of the picture,
based on the determination, generating a second randomly selected coordinate, wherein the second randomly selected coordinate is generated using (i) a random number between 0 and 1, (ii) a height or a width of the picture, (iii) a height or a width of the patch, and (iv) a height or a width of the defined area.
G10. The method of embodiment G9, wherein the second randomly selected coordinate is equal to ƒ(a*((p−c)−(b−1)))+c, where ƒ is a function for rounding down to the nearest integer, a is the random number, p is the height or the width of the picture, c is the height or the width of the defined area, and b is the size of the patch.
G11. The method of any one of embodiments G1-G11, wherein
the first position comprises one or more converted coordinates of the patch, and
each of said one or more converted coordinates of the patch is an integer multiple of 2^{p}, where p is an integer.
G12. The method of embodiment G11, wherein said one or more converted coordinates of the patch is obtained by converting one or more coordinates of the patch by performing an integer division operation.
G13. The method of embodiment G12, wherein
said one or more coordinates of the patch comprises a coordinate x,
the converted one or more coordinates of the patch comprises a converted coordinate x′,
x′ is determined based on the integer division operation and 2^{p}.
G14. The method of embodiment G13, wherein x′=(x//2^{P})×2^{P}, where // is the integer division operation.
H1. A method (3800) of training a machine learning, ML, model for encoding or decoding video data, the method comprising:
retrieving (s3802) from a storage (e.g., a hard disk, a solid state drive, etc.) a first file containing first segment data of a first segment included in a picture, wherein the first segment is smaller than the picture,
based at least on the first segment data, obtaining (s3804) patch data of a patch which is a part of the first segment, and
using the patch data, training (s3806) the ML model.
H1a. The method of embodiment H1, wherein
the storage is configured to store a second file which contains second segment data of a second segment included in the picture,
the patch is a part of the second segment, and
the patch data is obtained by retrieving the first file without retrieving the second file.
H1b. The method of embodiment H1 or H1a, the method comprising:
identifying the first segment located at a position within the picture, wherein
the first file is retrieved from the storage based on identifying the first segment, and
the position of the first segment is determined as:

$$xTile = max ( 0 , ( patchXpos - 1 ) / / ( tileSizeX - patchSizeX )$$

$$yTile = max ( 0 , ( patchYpos - 1 ) / / ( tileSizeY - patchSizeY ) .$$

where xTile is an x-coordinate of the position of the first segment, yTile is an y-coordinate of the position of the first segment, patchXpos is an x-coordinate of a position of the patch, patchYpos is an y-coordinate of the position of the patch, tileSizeX is a size of the first segment in a first dimension, tileSizeY is a size of the first segment in a second dimension, patchSizeX is a size of the patch in the first dimension, and patchSizeY is a size of the patch in the second dimension.
H2. The method of embodiment H1, wherein
the patch is also a part of a second segment included in the picture, and
the method comprises:
retrieving from the storage a second file containing second segment data of the second segment, wherein the second segment is smaller than the picture and has the same size as the first segment; and
based at least on the first segment data, and the second segment data, obtaining the patch data of the patch.
H3. The method of embodiment H2, wherein
the first segment and the second segment overlaps, thereby creating an overlapped area, and
the patch is located at least partially within the overlapped area.
H4. The method of embodiment H2 or H3, wherein
the patch is also a part of a third segment included in the picture, and
the method comprises:
retrieving from the storage a third file containing third segment data of the third segment, wherein the third segment is smaller than the picture and has the same size as the first segment and the second segment; and
based at least on the first segment data, the second segment data, and the third segment data, obtaining the patch data of the patch.
H5. The method of any one of embodiments H1-H4, wherein
the first file is a compressed file stored in the storage, and
the method further comprises decompressing the first file to obtain the first segment data.
H6. The method of any one of embodiments H1-H5, wherein
the first file comprises a group of segment data comprising the first segment data, and
the group of segment data comprises segment data for reconstructed samples, segment data for predicted samples, segment data for original samples, segment data for boundary strength.
H7. The method of any one of embodiments H1-H6, wherein
the first file comprises a stack of segment data,
the stack of segment data comprises a first layer of segment data and a second layer of segment data,
the first layer of segment data comprises data corresponding to a first resolution,
the second layer of segment data comprises data corresponding to a second resolution, and
the first resolution is higher than the second resolution.
I1. A computer program (1243) comprising instructions (1244) which when executed by processing circuitry (1202) cause the processing circuitry to perform the method of at least one of embodiments A1-H7.
I2. A carrier containing the computer program of embodiment I1, wherein the carrier is one of an electronic signal, an optical signal, a radio signal, and a computer readable storage medium.
J1. An apparatus (1200) for training a machine learning, ML, model used for generating encoded video data or decoded video data, the apparatus being configured to:
obtain (s1702) original video data (e.g., the data received at the encoder or the decoder);
convert (s1704) the original video data into ML input video data (e.g., the data provided the ML model);
provide (s1706) the ML input video data into the ML model, thereby generating first ML output video data; and
train (s1708) the ML model based on a difference between the original video data and the ML input video data and a difference between the original video data and the first ML output video data.
J2. The apparatus of embodiment J1, wherein the apparatus is configured to perform the method of at least one of embodiments A2-A13.
K1. An apparatus (1200) for training a machine learning, ML, model used for generating encoded video data or decoded video data, the apparatus being configured to:
obtain (s1802) ML input video data (e.g., the data provided the ML model);
provide (s1804) the ML input video data and a first quantization parameter value into the ML model, thereby generating first ML output video data;
provide (s1806) the ML input video data and a second quantization parameter value into the ML model, thereby generating second ML output video data; and
train (s1808) the ML model based on the ML input video data, the first ML output video data, and the second ML output video data.
K2. The apparatus of embodiment K1, wherein the apparatus is configured to perform the method of at least one of embodiments B2-B3.
L1. An apparatus (1200) for training a machine learning, ML, model used for generating encoded video data or decoded video data, the method comprising:
obtain (s1902) first ML input video data corresponding to a first frame;
obtain (s1904) second ML input video data corresponding to a second frame, wherein the second frame is different from the first frame;
provide (s1906) the first ML input video data into the ML model, thereby generating first ML output video data;
provide (s1908) the second ML input video data, thereby generating second ML output video data; and
train (s1910) the ML model based on the ML input video data, the first ML output video data, the second ML output video data, a first weight value associated with the first ML output video data, and a second weight value associated with the second ML output video data.
L2. The apparatus of embodiment L1, wherein the apparatus is configured to perform the method of embodiment C2.
M1. An apparatus (1200) for training a machine learning, ML, model used for generating encoded video data or decoded video data, the apparatus being configured to:
obtain (s2002) original video data;
obtain (s2004) ML input video data;
provide (s2006) the ML input video data into the ML model, thereby generating ML output video data; and
train (s2008) the ML model based on a first difference between the original video data and the ML input video data, a second difference between the ML output video data and the ML output video data, and an adjustment value (e.g., (r-·r\hat{ })/(r\hat{ }·r\hat{ })) for the second difference.
M2. The apparatus of embodiment M1, wherein the apparatus is configured to perform the method of at least one of embodiments D2-D4.
N1. An apparatus (1200) for generating encoded video data or decoded video data, the apparatus being configured to:
obtain (s2102) original video data (e.g., the data received at the encoder or the decoder);
convert (s2104) the original video data into machine learning, ML, input video data (e.g., the data provided the ML model) using one or more components in a video encoder or a video decoder;
provide (s2106) the ML input video data into a trained ML model, thereby generating ML output video data; and
generate (s2108) the encoded video data or the decoded video data based on the generated ML output video data, wherein
the trained ML model is trained using original training video data, a difference between the original training video data and ML input training video data, and a difference between the original training video data and ML output training video data,
the ML input training video data is obtained by providing the original training video data to said one or more components of the video encoder or the video decoder, and
the ML output training video data is obtained by providing the ML input training video data to a ML model.
N2. The apparatus of embodiment N1, wherein the apparatus is configured to perform the method of at least one of embodiments E2-E13.
O1. An apparatus (1200) for selecting from a picture a patch for training a machine learning, ML, model used for encoding or decoding video data, the apparatus being configured to:
randomly (s3602) select one or more coordinates of the patch;
convert (s3604) said one or more coordinates of the patch into converted one or more coordinates of the patch; and
train (s3606) the ML model based on the converted one or more coordinates of the patch, wherein
each of said one or more converted coordinates of the patch is an integer multiple of 2\hat{ }p, where p is an integer.
O2. The apparatus of embodiment O1, wherein the apparatus is configured to perform the method of at least one of embodiments F2-F4.
P1. An apparatus (1200) for selecting from a picture a patch for training a machine learning, ML, model used for encoding or decoding video data, the apparatus being configured to:
select (s3702) a first position of the patch such that the first position of the patch is outside of a defined area; and
train (s3704) the ML model using sample data which is obtained based on the selected first position.
P2. The apparatus of embodiment P1, wherein the apparatus is configured to perform the method of at least one of embodiments G2-G10.
Q1. An apparatus (1200) for training a machine learning, ML, model for encoding or decoding video data, the apparatus being configured to:
retrieve (s3802) from a storage (e.g., a hard disk, a solid state drive, etc.) a first file containing first segment data of a first segment included in a picture, wherein the first segment is smaller than the picture,
based at least on the first segment data, obtain (s3804) patch data of a patch which is a part of the first segment, and
using the patch data, train (s3806) the ML model.
Q2. The apparatus of embodiment Q1, wherein the apparatus is configured to perform the method of at least one of embodiments H1-H7.
R1. An apparatus (1200) comprising:
a processing circuitry (1202); and
a memory (1241), said memory containing instructions executable by said processing circuitry, whereby the apparatus is operative to perform the method of at least one of embodiments A2-H7.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-32. (canceled)

33. A method for training a machine learning (ML) model used for generating encoded video data or decoded video data, wherein the video data represents i) at least one picture having image data used for prediction by one or more other pictures represented in the video data and ii) at least one picture having image data that is not used for prediction by any other picture represented in the video data, the method comprising:
obtaining first ML input video data corresponding to a first picture;
obtaining a first weight value, wherein the first weight value is based upon a number of pictures represented in the video data that use image data of the first picture for prediction;
determining that the first weight value satisfies a condition;
in response to determining that the first weight value satisfies the condition, providing the first ML input video data into the ML model, thereby generating first ML output video data;
generating weighted first ML output video data using the first ML output video data and the first weight value; and
training the ML model using training data based on the first ML input video data and the weighted first ML output video data.

34. The method of claim 33, wherein the method further comprises:
obtaining second ML input video data corresponding to a second picture, wherein the second picture is different from the first picture;
obtaining a second weight value, wherein the second weight value is based upon a number of pictures represented in the video data that use image data of the second picture for prediction;
determining that the second weight value does not satisfy a condition; and
in response to determining that the second weight value does not satisfy the condition, refraining from providing the second ML input video data into the ML model.

35. The method of claim 34, wherein
there are no pictures represented by the video data that use image data of the second picture for prediction,
obtaining the second weight value comprises setting the second weight value to zero as a result of there being no pictures that use image data of the second picture for prediction, and
determining that the second weight value does not satisfy the condition comprises i) determining that the second weight value is equal to zero or ii) determining that the second weight value is not greater than zero.

36. The method of claim 34, wherein
obtaining the second weight value comprises setting the second weight value to zero as a result of determining that the second picture is associated with a highest temporal layer included in an ordered set of two more temporal layers.

37. The method of claim 33, wherein the method further comprises:
obtaining second ML input video data corresponding to a second picture, wherein the second picture is different from the first picture;
obtaining a second weight value, wherein the second weight value is based upon a number of pictures represented in the video data that use image data of the second picture for prediction;
determining that the second weight value satisfies a condition;
in response to determining that the second weight value satisfies the condition, providing the second ML input video data into the ML model, thereby generating second ML output video data;
generating weighted second ML output video data using the second ML output video data and the second weight value, wherein
the training data that is used to train the ML model is further based on the second ML input video data and the weighted second ML output video data.

38. The method of claim 37, wherein:
the first weight value is greater than the second weight value; and
a number of predictions for which image data corresponding to the first picture is used is greater than a number of predictions for which image data corresponding to the second picture is used.

39. The method of claim 37, wherein
the first picture is associated with a first temporal layer having a first layer number, and
the first weight value is based upon the first layer number.

40. The method of claim 39, wherein
the second picture is associated with a second temporal layer having a second layer number, and
the second weight value is based upon the second layer number,
the second layer number is greater than the first layer number, and
the second weight value is lower than the first weight value.

41. The method of claim 39, wherein
the second picture is associated with a second temporal layer having a second layer number, and
the second weight value is based upon the second layer number,
the video data represents a third picture associated with a third temporal layer having a third layer number,
the third layer number is greater than both the first layer number and the second layer number,
obtaining the first weight value comprises setting the first weight value to a certain value as a result of the first layer number being less than the third layer number, and
obtaining the second weight value comprises setting the second weight value to the certain value as a result of the second layer number being less than the third layer number.

42. A non-transitory computer readable storage medium storing a computer program comprising instructions for configuring an apparatus comprising processing circuitry for executing the instructions to perform the method of claim 33.

43. An apparatus comprising:
a processing circuitry; and
a memory, the memory containing instructions executable by said processing circuitry, wherein the apparatus is configured to perform a method for training a machine learning (ML) model used for generating encoded video data or decoded video data, wherein the video data represents i) at least one picture having image data used for prediction by one or more other pictures represented in the video data and ii) at least one picture having image data that is not used for prediction by any other picture represented in the video data, the method comprising:
obtaining first ML input video data corresponding to a first picture;
obtaining a first weight value, wherein the first weight value is based upon a number of pictures represented in the video data that use image data of the first picture for prediction;
determining whether the first weight value satisfies a condition; and
after determining that the first weight value satisfies the condition:
providing the first ML input video data into the ML model, thereby generating first ML output video data;
generating weighted first ML output video data using the first ML output video data and the first weight value; and
training the ML model using training data based on the first ML input video data and the weighted first ML output video data.

44. The apparatus of claim 43, wherein the method further comprises:
obtaining second ML input video data corresponding to a second picture, wherein the second picture is different from the first picture;
obtaining a second weight value, wherein the second weight value is based upon a number of pictures represented in the video data that use image data of the second picture for prediction;
determining that the second weight value does not satisfy a condition; and
in response to determining that the second weight value does not satisfy the condition, refraining from providing the second ML input video data into the ML model.

45. The apparatus of claim 44, wherein
there are no pictures represented by the video data that use image data of the second picture for prediction,
obtaining the second weight value comprises setting the second weight value to zero as a result of there being no pictures that use image data of the second picture for prediction, and
determining that the second weight value does not satisfy the condition comprises i) determining that the second weight value is equal to zero or ii) determining that the second weight value is not greater than zero.

46. The apparatus of claim 44, wherein
obtaining the second weight value comprises setting the second weight value to zero as a result of determining that the second picture is associated with a highest temporal layer included in an ordered set of two more temporal layers.

47. The apparatus of claim 43, wherein the method further comprises:
obtaining second ML input video data corresponding to a second picture, wherein the second picture is different from the first picture;
obtaining a second weight value, wherein the second weight value is based upon a number of pictures represented in the video data that use image data of the second picture for prediction;
determining that the second weight value satisfies a condition;
in response to determining that the second weight value satisfies the condition, providing the second ML input video data into the ML model, thereby generating second ML output video data;
generating weighted second ML output video data using the second ML output video data and the second weight value, wherein
the training data that is used to train the ML model is further based on the second ML input video data and the weighted second ML output video data.

48. The apparatus of claim 47, wherein:
the first weight value is greater than the second weight value; and
a number of predictions for which image data corresponding to the first picture is used is greater than a number of predictions for which image data corresponding to the second picture is used.

49. The apparatus of claim 47, wherein
the first picture is associated with a first temporal layer having a first layer number, and
the first weight value is based upon the first layer number.

50. The apparatus of claim 49, wherein
the second picture is associated with a second temporal layer having a second layer number, and
the second weight value is based upon the second layer number,
the second layer number is greater than the first layer number, and
the second weight value is lower than the first weight value.

51. The apparatus of claim 49, wherein
the second picture is associated with a second temporal layer having a second layer number, and
the second weight value is based upon the second layer number,
the video data represents a third picture associated with a third temporal layer having a third layer number,
the third layer number is greater than both the first layer number and the second layer number,
obtaining the first weight value comprises setting the first weight value to a certain value as a result of the first layer number being less than the third layer number, and
obtaining the second weight value comprises setting the second weight value to the certain value as a result of the second layer number being less than the third layer number.
